(19) United States
(12) Patent Application Publication
(10) Pub. No.: US 2019/0147022 A1
(43) Pub. Date: May 16, 2019

(54) METHOD, PROGRAM, RECORDING MEDIUM, AND DEVICE FOR ASSISTING IN CREATING HOMEPAGE

(71) Applicant: Yasunari OKADA, Osaka-shi, Osaka (JP)

(72) Inventor: Yasunari OKADA, Osaka-shi, Osaka (JP)

(21) Appl. No.: 16/306,312

(22) PCT Filed: Mar. 13, 2017
(86) PCT No.: PCT/JP2017/009981

§ 371 Date: Nov. 30, 2018

(30) Foreign Application Priority Data
Jun. 6, 2016 (JP) 2016-112593

(51) Int. Cl. G06F 17/22; G06F 17/21

(52) U.S. Cl. CPC G06F 17/2247; G06F 17/2241; G06F 17/212

(57) ABSTRACT

The present invention addresses the problem of creating a device for assisting in creating a homepage in such a manner that a general user can create a desired homepage on a homepage editing screen in a simple operation. The device 10 for assisting in creating a homepage according to the present invention is provided with: a means for creating content constituting the homepage on the basis of a user operation; a means for determining the positional relationship between created new content and previously created existing content; and a means for editing source code for the homepage on the basis of a layout rule that is among a plurality of layout rules for content, and that matches said positional relationship.

### TECHNICAL FIELD

The present invention relates to a method, program, recording medium, and device for assisting the creation of a home page, and particularly relates to a method for assisting the creation of a home page so that a general user can create a web page by a simple and intuitive operation on a home page editing screen, a program for performing the method with a computer, a computer readable recording medium with the program recorded thereon, and a device for assisting the creation of such a home page.

### BACKGROUND ART

A system for viewing documents (web pages) hosted on a web server with a web browser on a user terminal is constructed on the Internet. A collection of web pages associated with an individual, a company, or the like is called a web site, which is specified by a URL from a user terminal. In this regard, URL is an acronym for uniform resource locator, which is a formal symbol indicating the location of information (i.e., web site) on the Internet.

A home page originally referred to the top page of such a web site, but a document (web page) that can be viewed on a web site is now generally called a home page. Thus, a home page refers to a web page as used herein.

A home page is described in a language such as HTML (Hypertext Markup Language) or XHTML (Extensible Hypertext Markup Language).

For example, data (HTML file) for a home page described in HTML is data in a form of text called a source code. An HTML file can use additional information called a tag (instruction to a web browser) to organize a character string, instruct a storage location of an image file, or describe a link for a related file.

However, it is challenging for a general user to create an intended home page using HTML because such home page creation requires that the user understand the writing rules unique to HTML and use various tags appropriately.

In this regard, application software that enables a user to readily create a home page on an editing screen on a personal computer (hereinafter, referred to as HP creation assisting software) has been implemented in practice.

For example, the HP creation assisting software disclosed in Patent Literature 1 is configured to present a user with several templates to automatically create an HTML file of a home page with a design intended by the user in accordance with an input on a template by the user on a personal computer to which the HP creation assisting software is installed.

A user with no specialized knowledge can create a home page by an intuitive operation on an editing screen on a personal computer by using such HP creation assisting software.

However, even general users have a desire to create a more sophisticated home page in recent years, so that HP creation assisting software increasingly has a large number of templates to meet the various needs of users, and has various functions for editing individual elements in the templates integrated into the software. As a result, the operation for executing a desired editing function has instead become more difficult to understand. Furthermore, editing functions were not sufficiently coordinated, e.g., the layout collapsing as a result of editing.

### CITATION LIST

### Patent Literature

[PTL 1] Japanese Laid-Open Publication No. 2003-141103

### SUMMARY OF INVENTION

### Technical Problem

As discussed above, home page creation was challenging for general users without specialized knowledge. Home page creation as intended by general users was not simple even with the use of HP creation assisting software.

The objective of the invention is to obtain a method for assisting the creation of a home page so that a general user can create an intended home page by a simple operation on a home page editing screen, a program for performing the method with a computer, a computer readable recording medium with the program recorded thereon, and a device for assisting the creation of a home page by a general user as described above.

### Solution to Problem

A method according to the present invention for assisting the creation of a home page with a computer is provided, where the method comprises: the computer creating a box on an editing screen based on a user operation, the box being a rectangular frame for placing a content of the home page; the computer determining a positional relationship between a target box, which is a target of creation, and an existing box adjacent to the target box; and the computer editing at least a description for the target box between the target box and the existing box in the source code so that the description is in accordance with a layout rule matching the positional relationship among a plurality of layout rules specifying the placement of the box, thereby achieving an objective described above.

A program according to the present invention for executing a method for assisting the creation of a home page with a computer is provided, where the program is configured to make the computer execute: creating a box on an editing screen based on a user operation, the box being a rectangular frame for placing a content of the home page; determining a positional relationship between a target box, which is a target of creation, and an existing box adjacent to the target box; and editing at least a description for the target box between the target box and the existing box in the source code so that the description is in accordance with a layout rule matching the positional relationship among a plurality of layout rules specifying the placement of the box, thereby achieving an objective described above.

A computer readable recording medium according to the present invention with the aforementioned program of the present invention recorded thereon is provided, thereby achieving an objective described above.

A device according to the present invention for assisting the creation of a home page is provided, where the device has: means for creating a box on an editing screen based on a user operation, the box being a rectangular frame for placing a content of the home page; means for determining a positional relationship between a target box, which is a target of creation, and an existing box adjacent to the target box; and means for editing at least a description for the target box between the target box and the existing box in the source code so that the description is in accordance with a layout rule matching the positional relationship among a plurality of layout rules specifying the placement of the box, thereby achieving an objective described above.

A method according to the present invention for assisting the creation of a home page with a computer is provided, where the method comprises: the computer displaying an editing screen for the home page, the editing screen comprising a preview screen, a source screen, and a hierarchical structure screen, one or more contents constituting the home page being displayed in the preview screen, one or more elements constituting a source code of the home page being displayed in the source screen, and a hierarchical structure comprising one or more hierarchical nodes corresponding to each of the one or more contents being displayed in the hierarchical structure screen; and the computer executing at least one of the following display processes: a first display process in which, when one of the one or more contents is selected on the preview screen, an element corresponding to the selected content among the one or more elements is highlighted and displayed on the source screen and a hierarchical node corresponding to the selected content among the one or more hierarchical nodes is highlighted and displayed on the hierarchical structure screen by the computer; a second display process in which, when one of the one or more elements is selected on the source screen, a content corresponding to a selected element among the one or more contents is highlighted and displayed on the preview screen and a hierarchical node corresponding to the selected element among the one or more hierarchical nodes is highlighted and displayed on the hierarchical structure screen by the computer; and a third display process in which, when one of the one or more hierarchical nodes is selected on the hierarchical structure screen, a content corresponding to the selected hierarchical node among the one or more contents is highlighted and displayed on the preview screen and an element corresponding to the selected hierarchical node among the one or more elements is highlighted and displayed on the source screen by the computer, thereby achieving an objective described above.

A program according to the present invention for making a computer perform a process for assisting the creation of a home page is provided, where the program makes the computer: display an editing screen for the home page, the editing screen comprising a preview screen, a source screen, and a hierarchical structure screen, one or more contents constituting the home page being displayed in the preview screen, one or more elements constituting a source code of the home page being displayed in the source screen, and a hierarchical structure comprising one or more hierarchical nodes corresponding to each of the one or more contents being displayed in the hierarchical structure screen; and execute at least one of the following display processes; a first display process in which, when one of the one or more contents is selected on the preview screen, an element corresponding to the selected content among the one or more elements is highlighted and displayed on the source screen and a hierarchical node corresponding to the selected content among the one or more hierarchical nodes is highlighted and displayed on the hierarchical structure screen; a second display process in which, when one of the one or more elements is selected on the source screen, a content corresponding to a selected element among the one or more contents is highlighted and displayed on the preview screen and a hierarchical node corresponding to the selected element among the one or more hierarchical nodes is highlighted and displayed on the hierarchical structure screen; and a third display process in which, when one of the one or more hierarchical nodes is selected on the hierarchical structure screen, a content corresponding to the selected hierarchical node among the one or more contents is highlighted and displayed on the preview screen and an element corresponding to the selected hierarchical node among the one or more elements is highlighted and displayed on the source screen, thereby achieving an objective described above.

A computer readable recording medium according to the present invention with the aforementioned program of the present invention recorded thereon is provided, thereby achieving an objective described above.

A device according to the present invention for assisting the creation of a home page is provided, where the device comprises: displaying means for displaying an editing screen for the home page, the editing screen comprising a preview screen, a source screen, and a hierarchical structure screen, one or more contents constituting the home page being displayed in the preview screen, one or more elements constituting a source code of the home page being displayed in the source screen, and a hierarchical structure comprising hierarchical nodes corresponding to each of the one or more contents being displayed in the hierarchical structure screen; and controlling means for controlling the display means to perform at least one of the following display processes: a first display process in which, when one of the one or more contents is selected on the preview screen, the displaying means highlights and displays an element corresponding to the selected content among the one or more elements on the source screen and highlights and displays a hierarchical node corresponding to the selected content among the one or more hierarchical nodes on the hierarchical structure screen; a second display process in which, when one of the one or more elements is selected on the source screen, the displaying means highlights and displays a content corresponding to a selected element among the one or more contents on the preview screen and highlights and displays a hierarchical node corresponding to the selected element among the one or more hierarchical nodes on the hierarchical structure screen; and a third display process in which, when one of the one or more hierarchical nodes is selected on the hierarchical structure screen, the displaying means highlights and displays a content corresponding to the selected hierarchical node among the one or more contents on the preview screen and highlights and displays an element corresponding to the selected hierarchical node among the one or more elements on the source screen, thereby achieving an objective described above.

A method according to the present invention for assisting the creation of a home page with a computer is provided, wherein the method comprises: the computer displaying a plurality of blocks for placing a content of the home page so that at least one block is contained within at least one other block on an editing screen based on an editing operation of a user; the computer switching an editing mode for a parent block comprising at least one block between a normal editing mode and a batch editing mode based on a user operation; and when the editing mode for the parent block is in the batch editing mode, denying an individual editing operation on a block contained in the parent block and batch editing the block contained in the parent block with the parent block in accordance with an editing operation of a user on the parent block, and when the editing mode for the parent block is in the normal editing mode, the computer executing an editing process of the block contained in the patent block in accordance with an editing operation of a user on the block contained in the parent block, thereby achieving an objective described above.

A program according to the present invention for executing a method for assisting the creation of a home page with a computer is provided, where the program is configured to: switch an editing mode for a parent block comprising at least one block between a normal editing mode and a batch editing mode based on a user editing operation; and when the editing mode for the parent block is in the batch editing mode, deny an individual editing operation on a block contained in the parent block and batch edit the block contained in the parent block with the parent block in accordance with an editing operation on the parent block, and when the editing mode for the parent block is in the normal editing mode, execute an editing process of the block contained in the patent block in accordance with an editing operation on the block contained in the parent block by the computer, thereby achieving an objective described above.

A computer readable recording medium according to the present invention with the aforementioned program of the present invention recorded thereon is provided, thereby achieving an objective described above.

A device according to the present invention for assisting the creation of a home page is provided, wherein the device comprises: means for displaying a plurality of blocks for placing a content of the home page so that at least one block is contained within at least one other block on an editing screen based on an editing operation of a user; means for switching an editing mode of a parent block comprising at least one block between a normal editing mode and a batch editing mode based on a user operation; and means for, when the editing mode for the parent block is in the batch editing mode, denying an individual editing operation on a block contained in the parent block and batch editing the block contained in the parent block with the parent block in accordance with an editing operation of a user on the parent block and, when the editing mode for the parent block is in the normal editing mode, editing the block contained in the patent block in accordance with an editing operation of a user on the block contained in the parent block, thereby achieving an objective described above.

A method according to the present invention for assisting the creation of a home page with a computer is provided, where the method comprises: the computer determining a type of adjacent tags, an attribute contained in a tag, and an attribute value contained in a source code of a created home page; and the computer organizing the source code by replacing the adjacent tags with one tag if a result of the determination meets a predetermined condition, thereby achieving an objective described above.

A program according to the present invention for executing a method for assisting the creation of a home page with a computer is provided, where the program is configured to make the computer execute: determining a type of adjacent tags, an attribute contained in a tag, and an attribute value contained in a source code of a created home page; and organizing the source code by replacing the adjacent tags with one tag if a result of the determination meets a predetermined condition, thereby achieving an objective described above.

A computer readable recording medium according to the present invention with the aforementioned program of the present invention recorded thereon is provided, thereby achieving an objective described above.

A device according to the present invention for assisting the creation of a home page is provided, where the device comprises: means for determining a type of adjacent tags, an attribute contained in a tag, and an attribute value contained in a source code of a created home page; and means for organizing the source code by replacing the adjacent tags with one tag if a result of the determination meets a predetermined condition, thereby achieving an objective described above.

### Advantageous Effects of Invention

The present invention can materialize a method for assisting the creation of a home page so that a general user can create an intended home page by a simple operation on a home page editing screen, a program for performing the method with a computer, a computer readable recording medium with the program recorded thereon, and a device for assisting the creation of a home page by a general user as described above.

### BRIEF DESCRIPTION OF DRAWINGS

FIG. 1 is a diagram showing a device for assisting the creation of a homepage according to embodiment 1 of the present invention.

FIG. 2 is a diagram for explaining a box model. FIG. 2(a) shows an example of a description of HTML element 1. FIG. 2(b) shows the default placement of box B corresponding to the HTML element on a display screen. FIG. 2(c) shows a description Dc which specifies the style of box B. FIG. 2(d) shows the placement of box B with a specified style on the display screen.

FIG. 3 is a diagram for explaining a method of applying CSS to an HTML element. FIG. 3(a) shows a method of applying CSS to each HTML element (first method). FIG. 3(b) shows a method of applying CSS in batch to a plurality of HTML elements (second method). FIG. 3(c) shows a description for specifying an HTML to which CSS is applied.

FIG. 4 is a diagram for explaining the position relationship of a plurality of boxes corresponding to a plurality of HTML elements. FIG. 4(a) shows a source code comprising a plurality of HTML elements. FIG. 4(b) shows the content of each HTML element displayed on a browser. FIG. 4(c) shows a box corresponding to each of the plurality of HTML elements.

FIG. 5 is a diagram for explaining a layout rule for a block box to which a style is not applied. FIG. 5(a) shows a source code of a home page comprising two contents. FIG. 5(b) shows this home page being displayed.

FIG. 6 is a diagram for explaining a regular layout rule for a block box to which a style is applied by the first method. FIG. 6(a) shows a source code of a home page comprising two contents. FIG. 6(b) shows this home page being displayed.

FIG. 7 is a diagram for explaining a regular layout rule for a block box to which a style is applied by the second method. FIG. 7(a) shows a source code of a home page comprising two contents. FIG. 7(b) shows this home page being displayed.

FIG. 8 is a diagram for explaining an irregular layout rule for a block box to which a style is applied by the first method. FIG. 8(a) shows a source code of a home page comprising two contents. FIG. 8(b) shows this home page being displayed.

FIG. 9 is a diagram for explaining an irregular layout rule for a block box to which a style is applied by the second method. FIG. 9(a) shows a source code of a home page comprising two contents. FIG. 9(b) shows this home page being displayed.

FIG. 10 is a diagram for explaining a layout rule for an inline box to which a style is not applied. FIG. 10(a) shows a source code of a home page comprising two contents. FIG. 10(b) shows this home page being displayed.

FIG. 11 is a diagram for explaining a regular layout rule for an inline box to which a style is applied by the first method. FIG. 11(a) shows a source code of a home page comprising two contents. FIG. 11(b) shows this home page being displayed.

FIG. 12 is a diagram for explaining a regular layout rule for an inline box to which a style is applied by the second method. FIG. 12(a) shows a source code of a home page comprising two contents. FIG. 12(b) shows this home page being displayed.

FIG. 13 is a diagram for explaining an irregular layout rule for an inline box to which a style is applied by the first method. FIG. 13(a) shows a source code of a home page comprising two contents. FIG. 13(b) shows this home page being displayed.

FIG. 14 is a diagram for explaining an irregular layout rule for an inline box to which a style is applied by the second method. FIG. 14(a) shows a source code of a home page comprising two contents. FIG. 14(b) shows this home page being displayed.

FIG. 15 is a diagram showing a home page editing screen provided by an HP creation assisting device 10.

FIG. 16 is a diagram showing a state where a block box has been created on the editing screen shown in FIG. 15.

FIG. 17 is diagram showing a state where the width of a block box on the editing screen shown in FIG. 16 has been set.

FIG. 18 is a diagram showing a text editing screen TSe.

FIG. 19 is a diagram showing a state where a content has been input into the block box on the editing screen shown in FIG. 16.

FIG. 20 is a diagram showing a state where the height, left and top inside margins, and left and top outside margins of the block box shown in FIG. 19 have been set.

FIG. 21 is a diagram showing a state where a second block box has been created below the first block box on the editing screen Se shown in FIG. 20.

FIG. 22 is a diagram showing a state where a content has been input into the second block box shown in FIG. 21.

FIG. 23 is a diagram showing a state where the second block box shown in FIG. 21 has been moved to the right side of the first block box.

FIG. 24 is a diagram showing a state where content is input into the second block box shown in FIG. 23.

FIG. 25 is a diagram showing a state where a first block box whose width, height, left and top inside margins, and left and top outside margins have been set has been created on the editing screen.

FIG. 26 is a diagram showing a state where a content has been input into a text editing screen.

FIG. 27 is a diagram showing a state where a content has been input into the block box shown in FIG. 25.

FIG. 28 is a diagram showing a state where two contents within the block box shown in FIG. 27 are placed according to a regular layout rule for inline boxes.

FIG. 29 is a diagram showing a state where two contents within the block box shown in FIG. 27 are placed according to an irregular layout rule for inline boxes.

FIG. 30 is a diagram showing an HTML element generation process according to a layout rule for boxes in a flowchart.

FIG. 31 is a diagram for explaining an HP creation assisting device 20 according to embodiment 2 of the present invention.

FIG. 32 is a diagram showing an editing screen Se2 that is displayed on a display unit 14a of the HP creation assisting device 20 shown in FIG. 31.

FIG. 33 is a diagram for explaining the mechanism for associating the contents displayed on a preview screen Rep, a source screen Rce, and a hierarchical structure screen Rhd within the editing screen Se2 shown in FIG. 32.

FIG. 34 is a diagram showing a source element map Mse.

FIG. 35 is a diagram for explaining a DOM element map Mde. FIG. 35(a) shows a comparison of a source element with a DOM element. FIG. 35(b) shows the structure of the DOM element map Mde.

FIG. 36 is a diagram for explaining hierarchical structure information Dhs. FIG. 36(a) shows a comparison of a source element with a DOM element. FIG. 36(b) specifically shows the hierarchical structure information Dhs.

FIG. 37 is a diagram schematically showing an input of a source code Sc displayed on the source screen Rce into a text editor.

FIG. 38 is a diagram showing a state where the source code Sc is being displayed on the source screen Roe of the editing screen Se2.

FIG. 39 is a diagram showing a state where individual HTML elements contained in a source code have been recognized by analysis of the input source code Sc.

FIG. 40 is a diagram schematically showing a source code being read by a browser.

FIG. 41 is a diagram showing a state where a content is displayed on the preview screen Rep of the editing screen Se2 by a browser reading the source code Sc.

FIG. 42 is a diagram showing a browser DOM (hierarchical structure of HTML elements) Eh1, which is generated by a browser dependent function upon reading of a source code by a browser.

FIG. 43 is a diagram showing how a display element guide is generated by comparison of an HTML element of the source element map Mse with an HTML element of browser DOM (hierarchical structure).

FIG. 44 is a diagram for explaining a display element guide. FIG. 44(a) schematically shows how a display element guide is applied to a content on the preview screen Rep. FIG. 44(b) shows a state where a display element guide has been applied to a content. FIG. 44(c) shows a state where a guide symbol has been given to a display element guide.

FIG. 45 is a diagram showing how the browser DOM (hierarchical structure of HTML elements) Eh1 is converted to a DOM structure (hierarchical structure) Eh matching a source element.

FIG. 46 is a diagram schematically showing the assignment of a symbol to a hierarchical node of a DOM structure and assignment of a guide sign to a symbol.

FIG. 47 is a diagram schematically showing how a symbol assigned to a hierarchical node of a DOM structure is reflected in the hierarchical structure screen Rhd.

FIG. 48 is a diagram showing how clicking on an HTML element on the source screen Roe results in a corresponding content on the preview screen Rep and a corresponding hierarchical node on the hierarchical structure screen Rhd to be highlighted.

FIG. 49 is a diagram showing how clicking on a content of the preview screen Rep results in a corresponding HTML element on the source screen Roe and a corresponding hierarchical node on the hierarchical structure screen Rhd to be highlighted.

FIG. 50 is a diagram showing how clicking on a symbol on the hierarchical structure screen Rhd results in a corresponding HTML element on the source screen Rce and a corresponding content on the preview screen Rep to be highlighted.

FIG. 51 is a diagram for explaining an HP creation assisting device 30 according to embodiment 3 of the present invention.

FIG. 52 is a diagram showing the editing screen Se displayed on the display unit 14a of an HP creation assisting device 30 shown in FIG. 51.

FIG. 53 is a diagram showing only an expanded preview screen Rep on the editing screen Se shown in FIG. 52.

FIG. 54 is a diagram for explaining the operation of the HP creation assisting device 30 shown in FIG. 51, and shows a state where a block (child bock) contained in a block in an individual editing mode has been copied.

FIG. 55 is a diagram for explaining the operation of the HP creation assisting device 30 shown in FIG. 51, and shows a change in the display on the preview screen when the editing mode of a block (parent block) containing a block is switched from an individual editing mode to a batch editing mode.

FIG. 56 is a diagram for explaining the operation of the HP creation assisting device 30 shown in

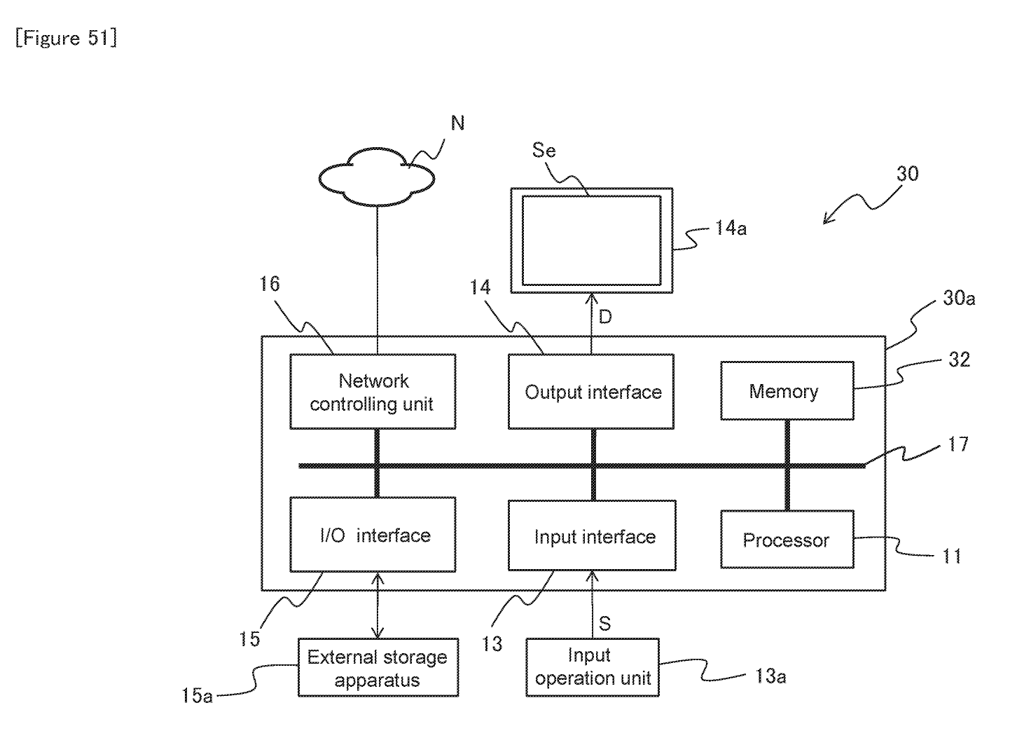

FIG. 51, and shows a state where a parent block in batch editing mode has been copied.

FIG. 57 is a diagram for explaining the operation of the HP creation assisting device 30 shown in FIG. 51, and shows a change in the display on the preview screen when a parent block in the batch edit mode is copied and then the editing mode for the original parent block is returned to the individual editing mode.

FIG. 58 is a diagram for explaining the operation of the HP creation assisting device 30 shown in

FIG. 51, and shows a process in a flow chart for executing a process in accordance with an editing operation of a user according to the editing mode of a block targeted for editing by a computer.

FIG. 59 is a diagram for explaining an HP creation assisting device 40 according to embodiment 4 of the present invention.

FIG. 60 is a diagram showing the editing screen Se displayed on the display unit 14a of the HP creation assisting device 40 of embodiment 4.

FIG. 61 is a diagram for explaining the operation of the HP creation assisting device 40 shown in FIG. 59, and shows a change in the source code when various styles are set for contents in style setting processes S400 to S407.

FIG. 62 is a diagram for explaining the operation of the HP creation assisting device 40 shown in FIG. 59, and shows a change in the source code when various styles are set for contents in style setting processes S408 to S410.

FIG. 63 is a diagram for explaining the operation of the HP creation assisting device 40 shown in FIG. 59. FIG. 63(a) shows analysis of the first cycle for organizing the source code of contents. FIG. 63(b) shows results of organizing the source code in the first cycle.

FIG. 64 is a diagram for explaining the operation of the HP creation assisting device 40 shown in FIG. 59. FIG. 64(a) shows analysis of the second cycle for organizing the source code of contents. FIG. 64(b) shows results of organizing the source code in the second cycle.

FIG. 65 is a diagram for explaining the operation of the HP creation assisting device 40 shown in FIG. 59. FIG. 65(a) shows analysis of the third cycle for organizing the source code of contents. FIG. 65(b) shows results of organizing the source code in the third cycle.

FIG. 66 is a diagram for explaining the operation of the HP creation assisting device 40 shown in

FIG. 59. FIG. 66(a) shows analysis of the fourth cycle for organizing the source code of contents. FIG. 66(b) shows results of organizing the source code in the fourth cycle.

### DESCRIPTION OF EMBODIMENTS

The present application comprises four inventions for assisting the creation of a home page so that a general user can create a home page by a simple and intuitive operation on a home page editing screen.

The first invention is a method in which, when a home page is designed on a home page editing screen, a source code for displaying a designed home page in a browser is generated.

The second invention is an invention in which a preview screen for displaying a content constituting a home page, a source screen for displaying the source code of the home page, and a hierarchical structure screen for displaying a hierarchical structure of the content are displayed as home page editing screens, and the content of the home page, an element on the source screen, and a node of the hierarchical structure are associated so that the corresponding relationship with one another is recognized.

The third invention is an invention in which, when a plurality of blocks for placing contents on a home page editing screen are placed so that at least one block is contained within another block, the block editing operation is switched between an operation in a unit of individual blocks contained in another block and an operation in a unit of the another block.

The fourth invention is an invention in which, a type of adjacent tags, an attribute contained in a tag, and an attribute value contained in a source code of a created home page are determined, and the source code is organized by replacing the adjacent tags with one tag if a result of the determination meets a predetermined condition.

The embodiments of the present invention are explained hereinafter.

The aforementioned first to fourth inventions have the following relationship with the following embodiments (drawings).

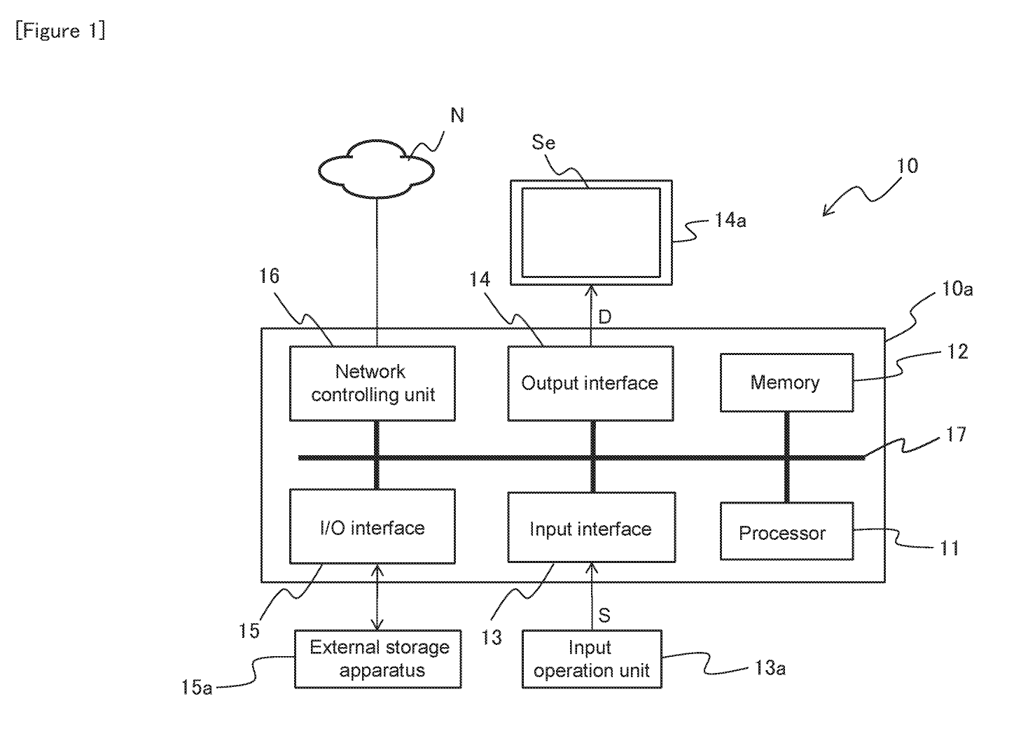

First invention: Embodiment 1 (FIGS. 1 to 30)

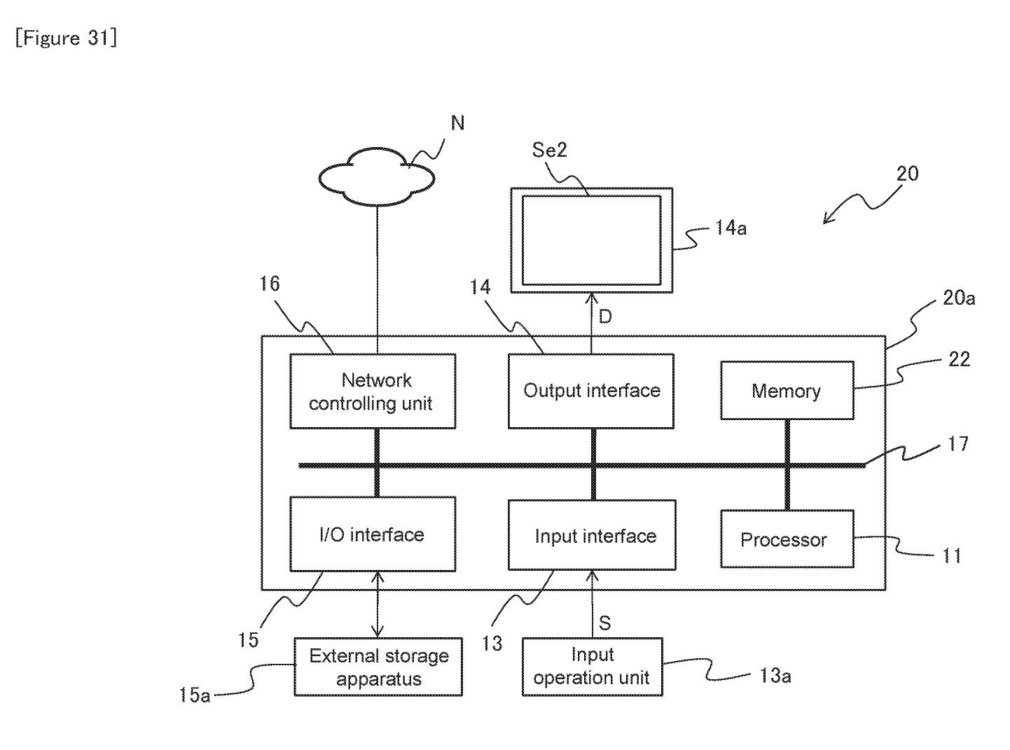

Second invention: Embodiment 2 (FIGS. 31 to 50)

Third invention: Embodiment 3 (FIGS. 51 to 58)

Fourth invention; Embodiment 4 (FIGS. 59 to 66)

### Embodiment 1

Embodiment 1 of the present invention is a method for assisting the creation of a home page with a computer, where a content of the home page designed on a home page editing screen is converted to a source code according to a layout rule for a box model. After summarizing a device used for assisting the creation of a home page, the presumed approach for a box model, a representative style sheet CSS used for specifying the style of a box, and the layout rule for a box model are explained before specifically explaining the main subject of the method of converting a content of a home page into a source code.

The subject method for creating a home page and home page creation assisting process with a computer are explained thereafter.

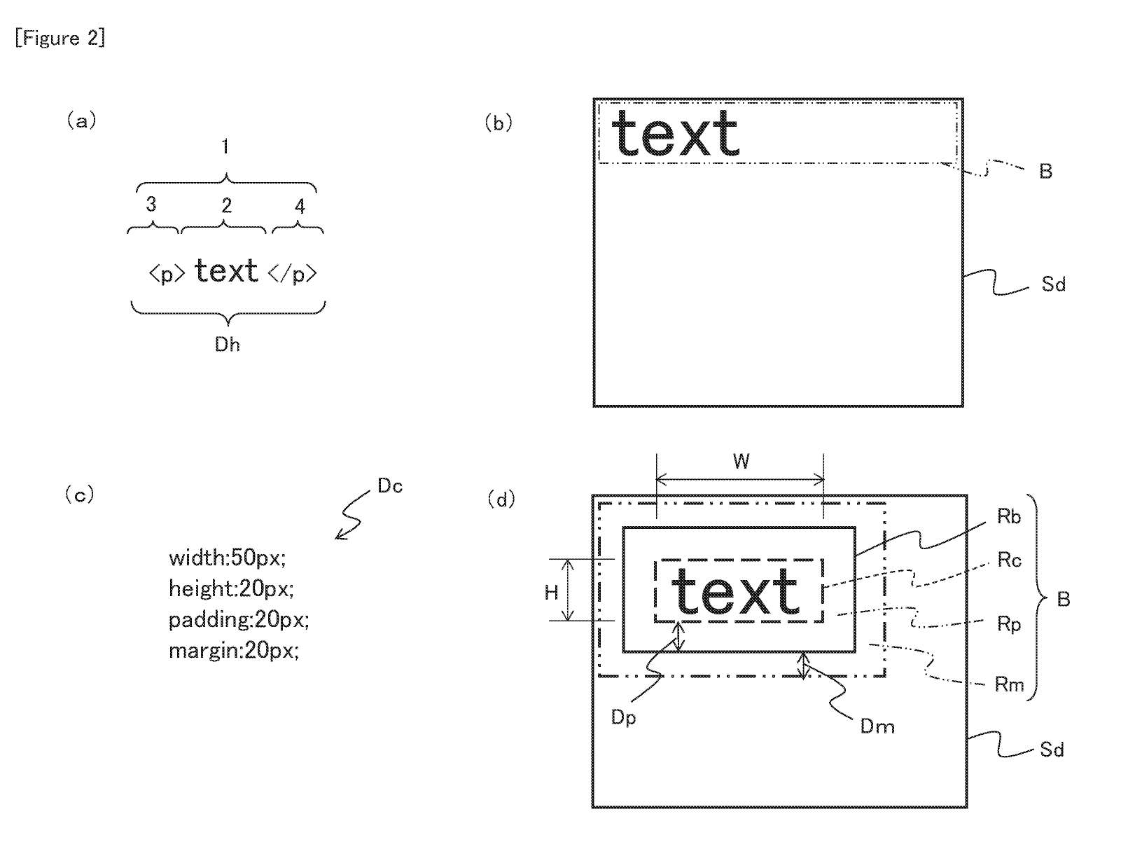

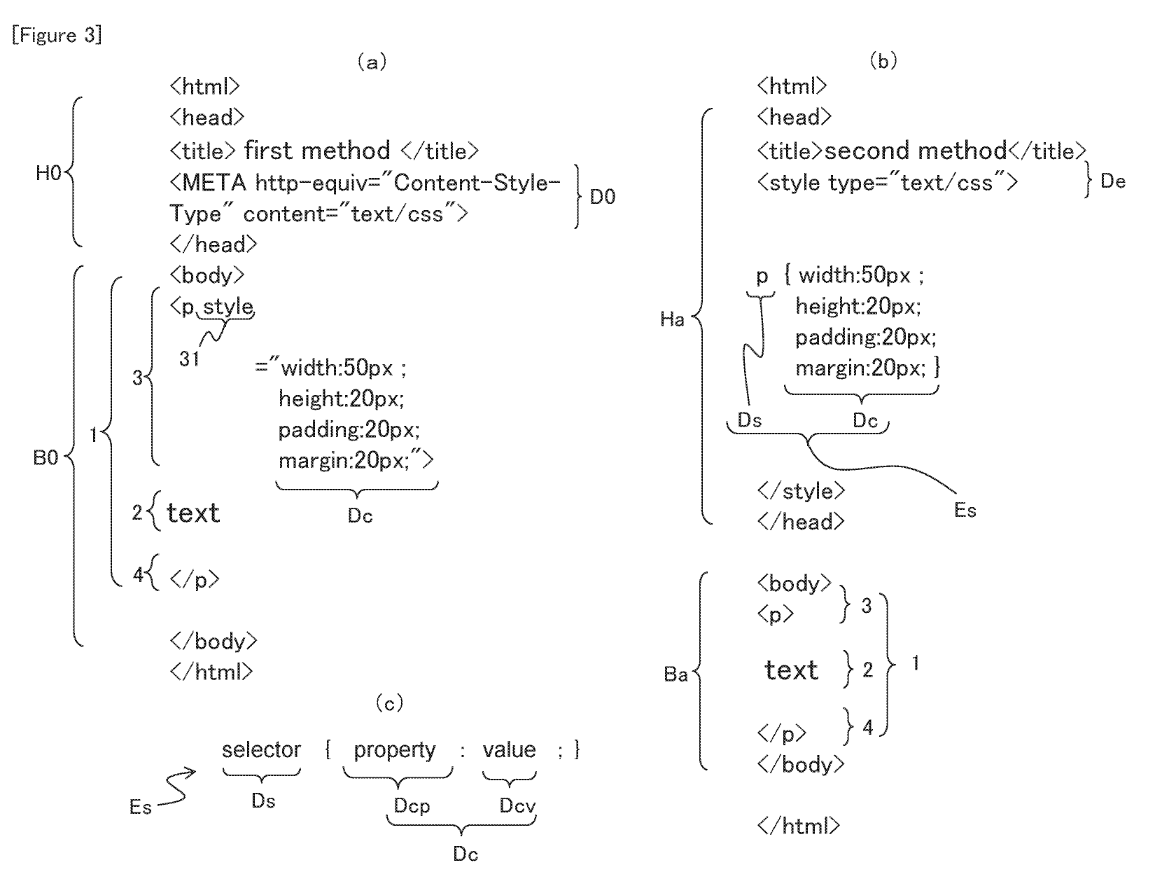

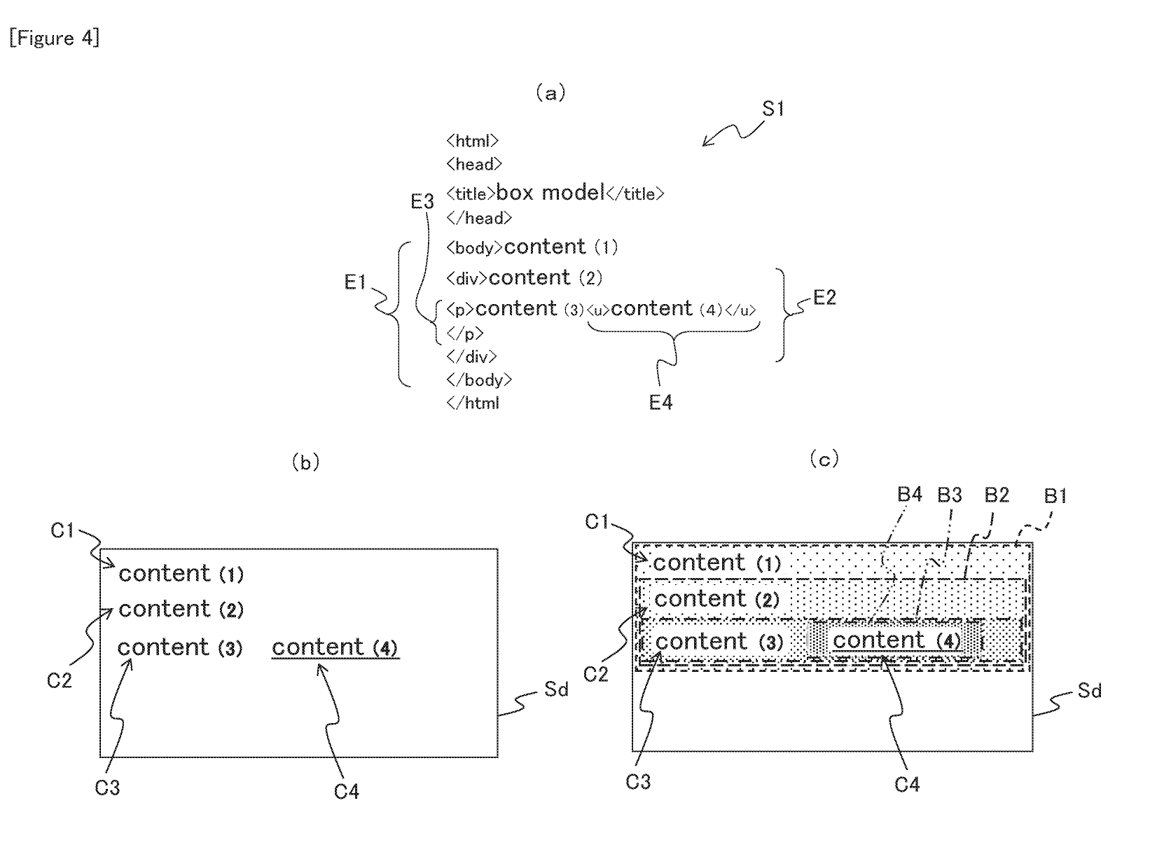

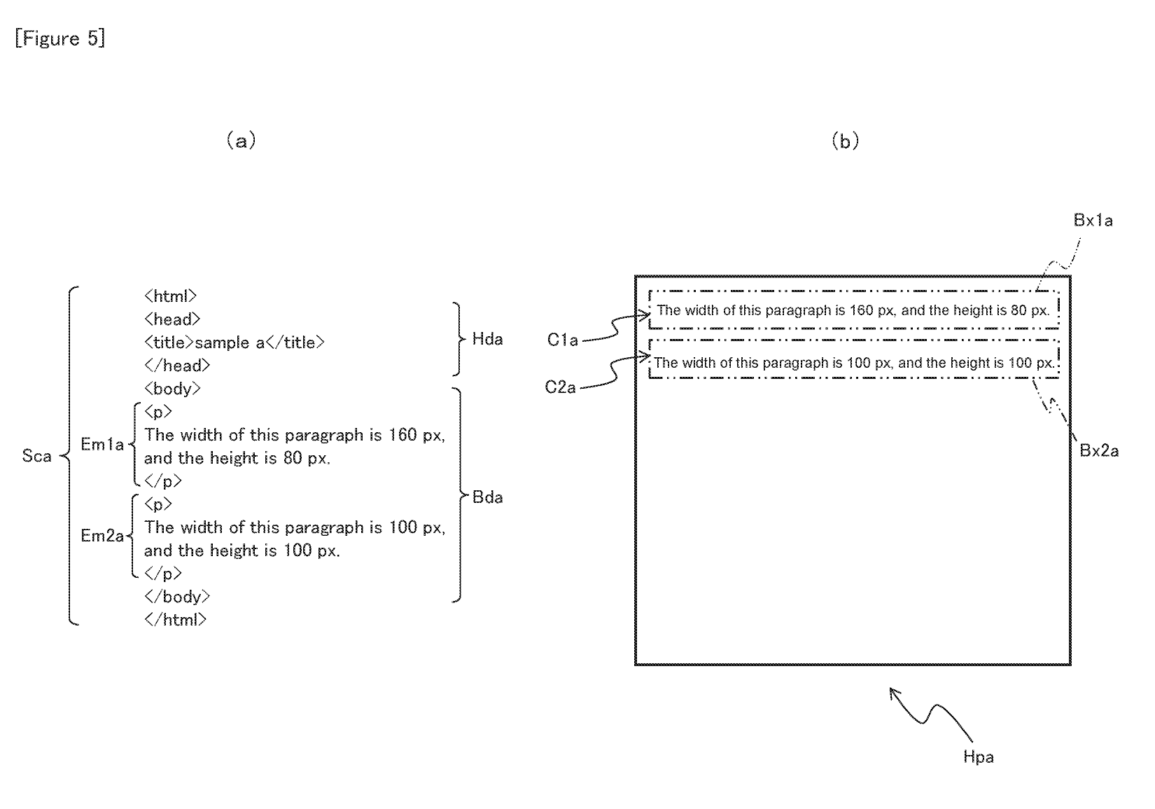

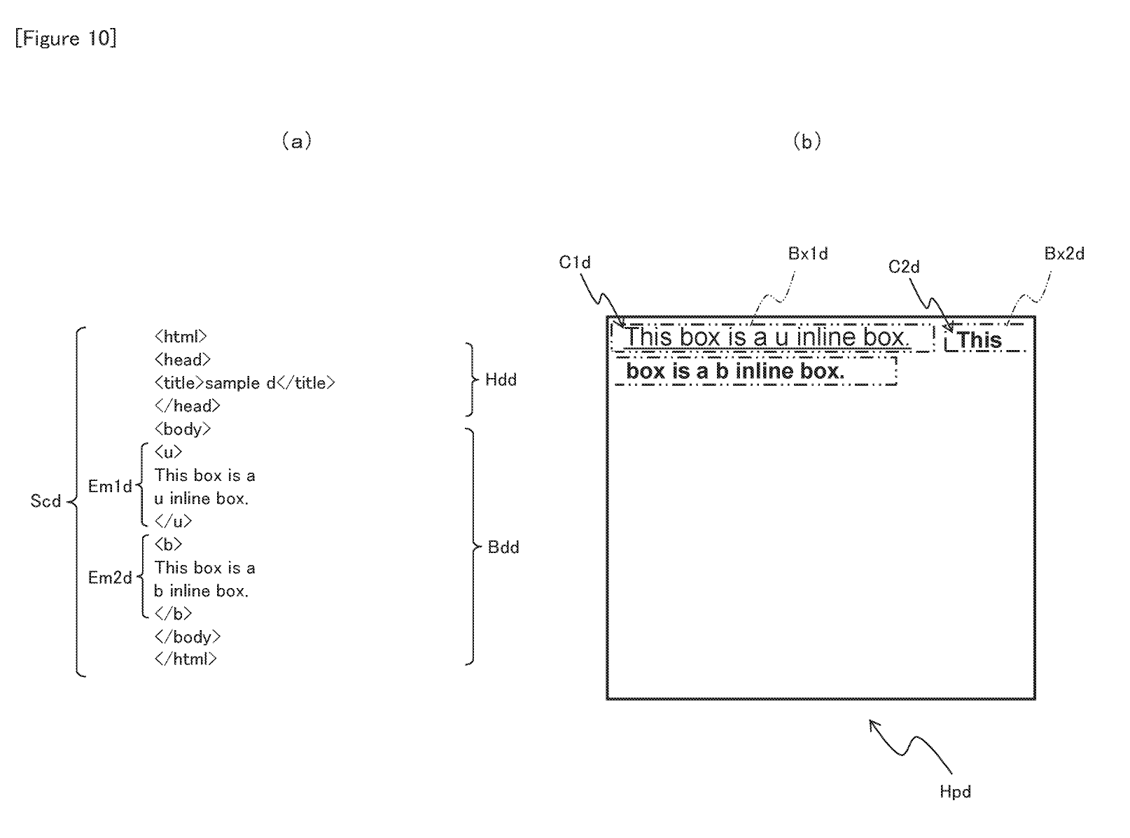

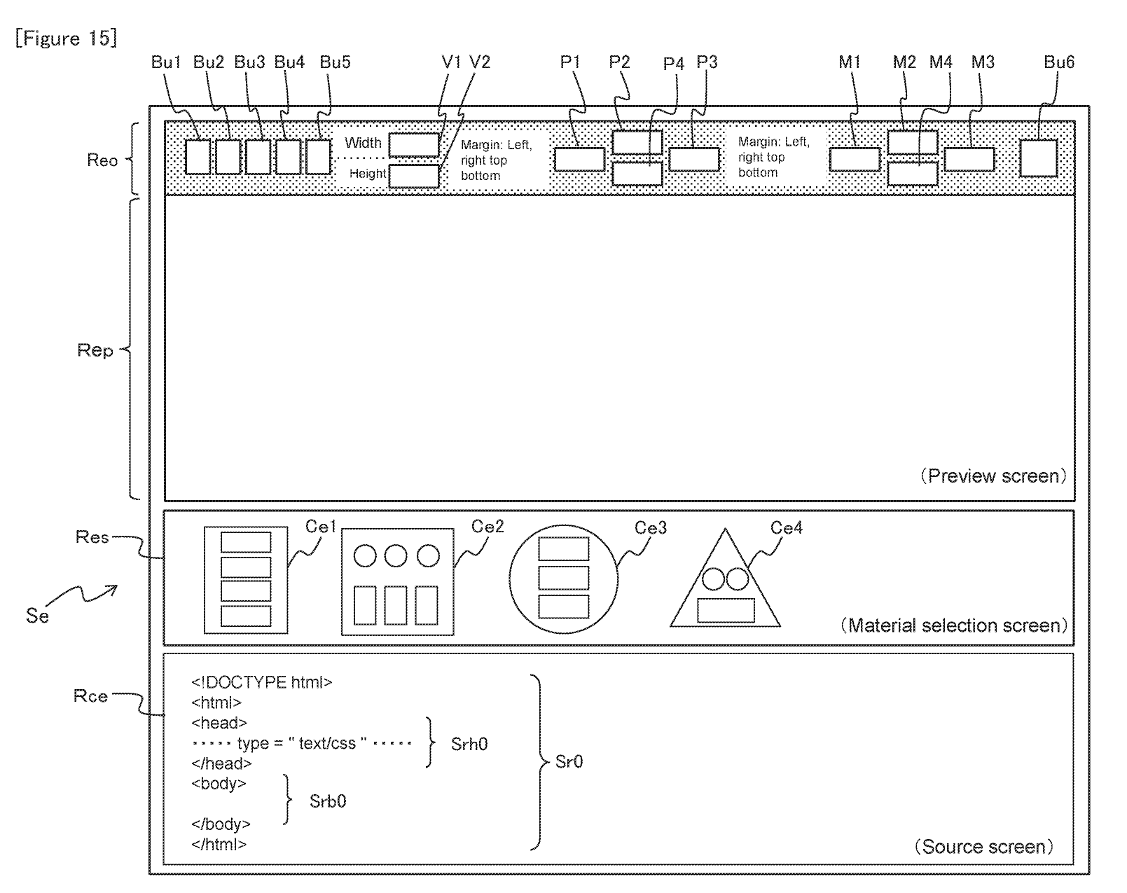

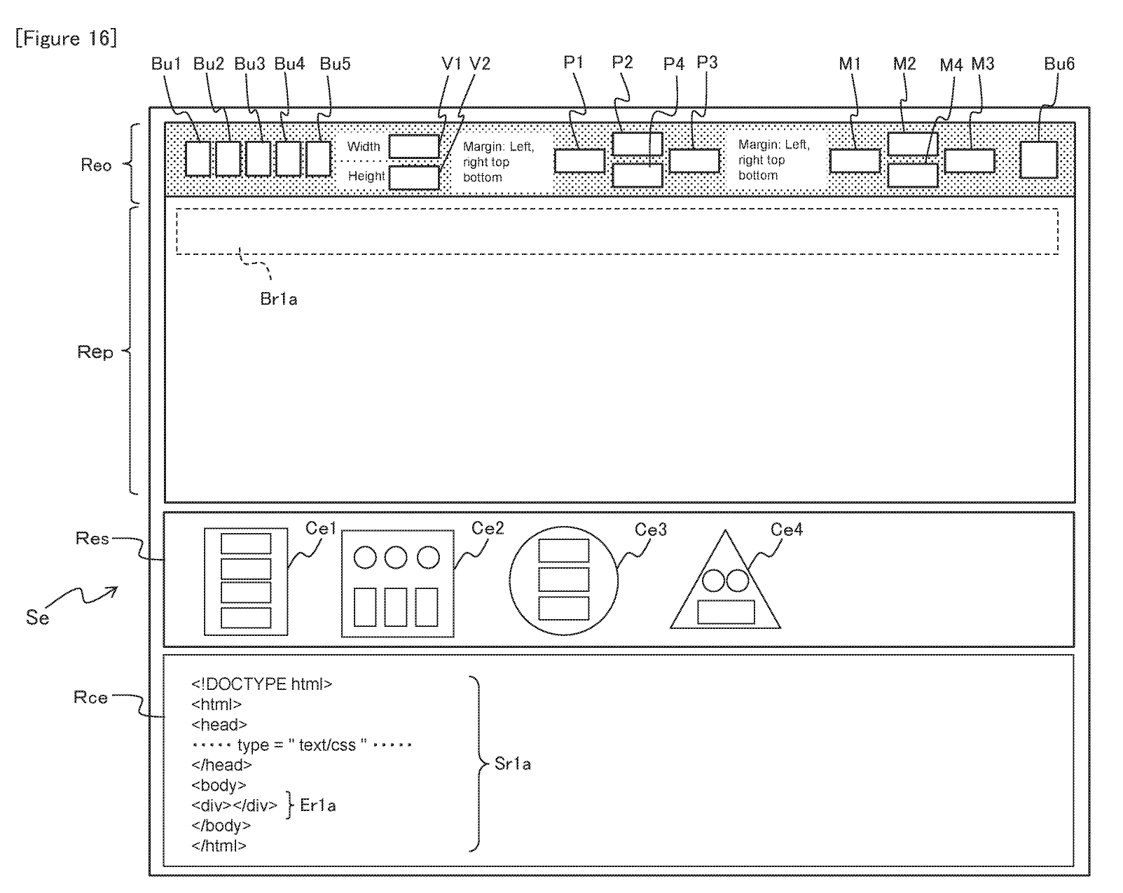

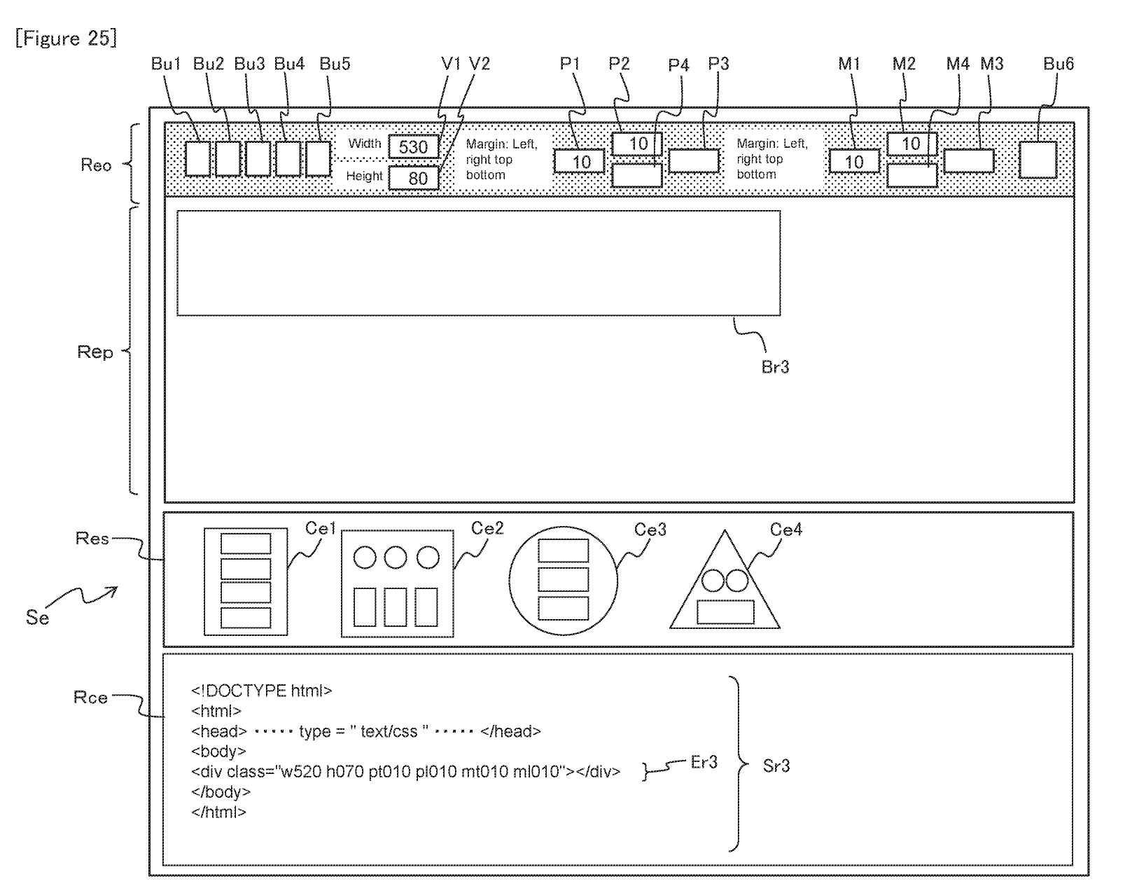

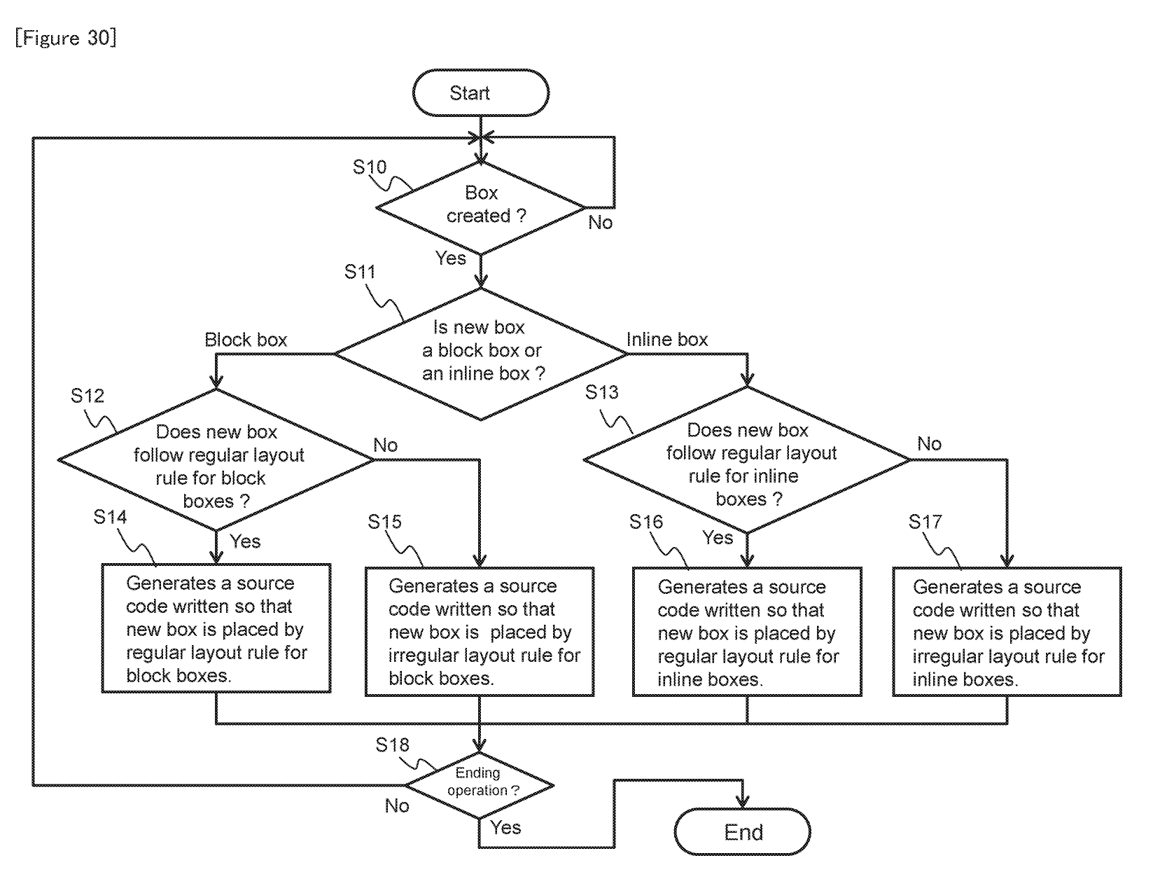

The flow of explanation for this embodiment is shown in the following table of contents for embodiment 1.
[Table of contents for embodiment 1]
(1) Box model [FIG. 2]
(1-1) Elements
(1-2) Box
(2) Method of applying CSS [FIGS. 3 to 4]
(2-1) First method
(2-2) Second method
(3) Layout rule for box [FIGS. 5 to 14]
(3-1) Layout rule for block box [FIGS. 5 to 9]
(3-2) Layout rule for inline box [FIGS. 10 to 14]
(4) Home page creation method
(4-1) Explanation of editing screen [FIG. 15]
(4-2) Creation of source code of block element [FIGS. 16 to 24]
(4-3) Creation of source code of inline element [FIGS. 25 to 29]
(5) Home page creation process [FIG. 30] Embodiment 1 is explained in detail hereinafter.

FIG. 1 shows a device for assisting the creation of a home page according to embodiment 1 of the present invention (hereinafter, also referred to as an HP creation assisting device) 10.

The HP creation assisting device 10 of embodiment 1 has a computer 10a for processing information, an input operation unit 13a for inputting operation information S into the computer 10a by a user operation, and a display unit 14a for displaying an image based on display data D from the computer 10a.

The computer 10a comprises a processor 11, a memory 12, an input interface 13, an output interface 14, an I/O interface 15, and a network controlling unit 16. The processor 11, memory 12, input interface 13, output interface 14, I/O interface 15, and network controlling unit 16 are connected to one another via a data bus 17. The input operation unit 13a comprises input devices such as a keyboard, mouse, and touch panel, which are connected to the input interface 13. The output interface 14 is connected to a display device such as a liquid crystal display as the display unit 14a. An external storage device 15a or the like is connected to the I/O interface 15. A network N such as the Internet is connected to the network controlling unit 16. A scanner or the like can also be connected as an input device to the input interface 13. A printer or the like can also be connected to the output interface 14.

In this regard, the memory 12 stores a program for making the processor 11 assist in the creation of a home page based on an operation signal S from the input operation unit 13a. The processor 11 executes a process for assisting the creation of a home page based on the operation signal S with the program stored in the memory 12. It is understood that the memory 12 also stores a general operation system for making the processor 11 function as a text editor or as a browser.

A process for assisting the creation of a home page comprises a process for displaying an editing screen Se for editing the home page on the display unit 14a, a process for inputting, drawing, or pasting one or more contents constituting the home page based on an operation signal S from a user operation, and a process for generating a source code matching the status of content created on the editing screen Se according to a box model.

For this reason, a user does not need to edit a source code of a home page when creating the home page using the HP creation assisting device 10. A user can intuitively create a home page with an intended design by simply inputting a text, or drawing or pasting an image, in a desired region of the editing screen Se of the HP creation assisting device 10.

Specific explanation is provided hereinafter according to the table of contents.

(1) Box Model

First, a box model is explained.

A box model is a scheme where a rectangular frame (hereinafter, referred to as a box) is provided for each of the one or more elements constituting a source code of a home page, and the content of elements (i.e., what is displayed as a content constituting the home page) is placed inside the box. Thus, when creating a home page using a box model, the content of an element can be positioned with a layout rule for a box or an attribute value of the box (height or width of the box, distance from an adjacent box, or the like).

In this regard, elements include block elements and inline elements. A block element is an element defining a content of a home page. An inline element is an element giving a predetermined role to a content of a home page. A box generated by a block element is a block box, which is a rectangular frame comprising the entire content of the block element. A box generated by an inline element is an inline box, which is a band-like frame with a height of one row, comprising the entire content of the inline element.

FIG. 2 is a diagram for explaining a box model. FIG. 2(a) shows an example of a description of HTML element 1. FIG. 2(b) shows the default placement of box B corresponding to the HTML element on a display screen. FIG. 2(c) shows a description Dc which specifies the style of box B. FIG. 2(d) shows the placement of box B with a specified style on the display screen.

(1-1) Element

A source code is written in a markup language such as HTML (Hypertext Markup Language) or XHTML (Extensible Hypertext Markup Language). A markup language is a type of computer language for describing appointments regarding the sentence structure (paragraph or the like) or appearance (font size or the like), with the sentence in a text file.

For example, individual elements (HTML elements) contained in a source code (HTML source) described in HTML are descriptions obtaining by sandwiching a content to be displayed with a start tag and an end tag. For example, p element 1 shown in FIG. 2(a) consists of a description Dh obtained by sandwiching the content to be displayed “text” 2 with a start tag “<p>” 3 and an end tag “</p>” 4.

The expression HTML element herein comprehensively indicates all elements described in HTML, while the expression html element is distinguished as indicating a description (source code) obtained by sandwiching a content with html tags, that is, “<html>” and “</html>”.

(1-2) Box

When the description “<p>text</p>” Dh of the p element 1 shown in FIG. 2(a) is read by a browser, the content “text” of the p element 1 is displayed as shown in FIG. 2(b). A rectangular frame (box) B is provided for the p element 1 on a display screen Sd of a browser (hereinafter, also simply referred to as a display screen) as shown in FIG. 2(b). Since the description Dh of the p element 1 shown in FIG. 2(a) does not set the width or height of the box B, the width of the box B is extended fully on the display screen Sd, and the height of the box B is the default value in a browser. The description Dh of the p element 1 shown in FIG. 2(a) also does not set the width or color of the border of box B, so that reading of the description Dh of the p element 1 only displays the content “text” 2 of the p element 1 on the display screen Sd as shown in FIG. 2(b). The box B corresponding to the p element 1 appears to be absent. The box B corresponding to the p element 1 which is actually not observable is indicated by a double-dotted chain line for convenience of explanation in FIG. 2(b).

Attributes of a box, such as the width and height of box B (FIG. 2(b)) corresponding to p element 1 and the position of the content relative to outer edges of the box, can be specified to place contents without information indicating the position to be placed according to a layout rule of the box.

The attributes of a box of an HTML element can be set using a tag as well as a style sheet specifying the style for the HTML element. A style sheet is a language that is different from HTML. Use of a style sheet can efficiently specify the style of an HTML element. Representative style sheets include CSS (Cascading Style Sheet). A style sheet can also specify the positional relationship (layout) of two or more boxes. The positional relationship (layout) of adjacent boxes can also be specified by a specific tag (e.g., br tag “<br/>”) instead of a style sheet.

For example, attribute information Dc shown in FIG. 2(c) is information specifying the style (attribute) of box B corresponding to the p element 1. When the style of box B is specified with such attribute information Dc, a portion (content region) Rc displaying the content “text” 2 of p element 1, a border Rb of the box positioned around the content region Re, a margin (padding region) Rp between the content region Re and the border Rb of the box, and a margin (margin region) Rm between the border Rb of the box and a border of another box are specified for box B as shown in FIG. 2(d).

Specifically, a width W and a height H of the content region Rc of box B are specified by the width property “width: 50 px” and height property “height: 20 px” of the attribute information Do. The width Dp of the padding region Rp of box B is specified by the padding property “padding: 20 px” of the attribute information DC, and the width Dm of the margin region Rm of box B is specified by the margin property “margin: 20” of the attribute information Do.

(2) Method of Applying CSS

A method of applying CSS to an HTML element is now specifically explained.

There are two methods of applying CSS to an HTML element. Each method is briefly explained hereinafter with the p element 1 shown in FIG. 2(a) as an example.

FIG. 3 is a diagram for explaining a method of applying CSS to an HTML element. FIG. 3(a) shows a method of applying CSS to each HTML element (first method). FIG. 3(b) shows a method of applying CSS in batch to a plurality of HTML elements (second method). FIG. 3(c) shows a description for specifying an HTML element to which CSS is applied.

(2-1) First Method

For example, as shown in FIG. 3(a), CSS is declared as the style sheet by the declaration element (<META http-equiv=“Content-Style-Type” content=“text/css”>) DO in a head element HO of the source code. In the body element B0, a style attribute 31 is added to a start tag 3 of p element 1 shown in FIG. 2(a), and attribute information Dc is set as the attribute value of the style attribute 31. And thereby CSS is applied to the p element 1.

(2-2) Second Method

This is a method in which, as shown FIG. 3(b), CSS is declared as the style sheet by a declaration element (<style type=“text/css”>) De in a head element Ha of the source code and CSS is applied in the body element Ba. However, to apply CSS in the body element Ba, it is necessary to specify which attribute of which HTML element in the body element Ba is set to what state. For this reason, a description Es for setting the style is used. The description Es for setting the style comprises a selector Ds, property Dcp, and value Dcv as shown in FIG. 3(c). The attribute information Dc (see FIG. 2(c)) for applying CSS to an HTML element is created by the property Dcp and value Dcv as shown in FIG. 3(b). In this regard, the selector Ds indicates an element to which the style is set, the property Dcp indicates the attribute to be set, and the value Dcv is a value indicating what state the attribute is set. Thus, in the second method, it is not necessary to set a style in the body element Ba. For this reason, the description within a body element comprising many elements can be readily understood.

Since such a box is present for every HTML element, the positional relationship of boxes which are provided for each HTML element when a single home page source code contains a plurality of HTML elements is briefly explained hereinafter.

FIG. 4 is a diagram for explaining the positional relationship of a plurality of boxes formed by a plurality of elements contained in a home page source code.

The source code S1 shown in FIG. 4(a) comprises, as HTML elements, a body element E1, a div element E2, a p element E3, and a u element E4. When the source code S1 is read by a browser, the display screen Sd displays content (1) C1, content (2) C2, content (3) C3, and content (4) C4 as shown in FIG. 4(b). At this time, boxes B1, B2, B3, and B4 are reserved for each HTML element, i.e., each of the body element E1, div element E2, p element E3, and u element E4, as shown in FIG. 4(c). In this regard, body element E1, div element E2, p element E3 are block elements, and the u element E4 is an inline element.

Such boxes generated by HTML elements do not have information indicating the position where the boxes are to be placed, but these boxes are positioned on the display screen Sd according to a regular layout rule or irregular layout rule in accordance with the application of information related to a layout of boxes for HTML elements (information from style sheet such as CSS or a specific tag such as a br tag).

(3) Layout Rule for Box

The layout rule for a box is now specifically explained.

(3-1) Layout Rule for Block Box

FIG. 5 is a diagram for explaining a layout rule (regular layout rule) for a block box when CSS is not applied to a block element.

The source code Sca shown in FIG. 5(a) comprises a head element Hda including the title element “sample a” and a subsequent body element Bda. Within the body element Bda, two block elements, that is, p element Em1a and Em2a, are subsequently described. The content C1a of the p element Em1a is “The width of this paragraph is 160 px, and the height is 80 px.” The content C2a of the p element Em2a is “The width of this paragraph is 100 px, and the height is 100 px.”

If CSS is not applied to these block elements Em1a and Em2a, two block boxes Bx1a and Bx2a corresponding to the block elements Em1a and Em2a are placed according to a regular layout rule of block boxes as shown in FIG. 5(b). Specifically, the block box Bx2a corresponding to the block element Em2a is placed below the block box Bx1a corresponding to the block element Em1a described before the block element Em2a on a display screen Hpa of a browser. However, in this case, the block boxes Bx1a and Bx2a are not displayed. Only the contents C1a and C2a positioned inside the block boxes Bx1a and Bx2a are displayed on the display screen Hpa in alignment from top to bottom.

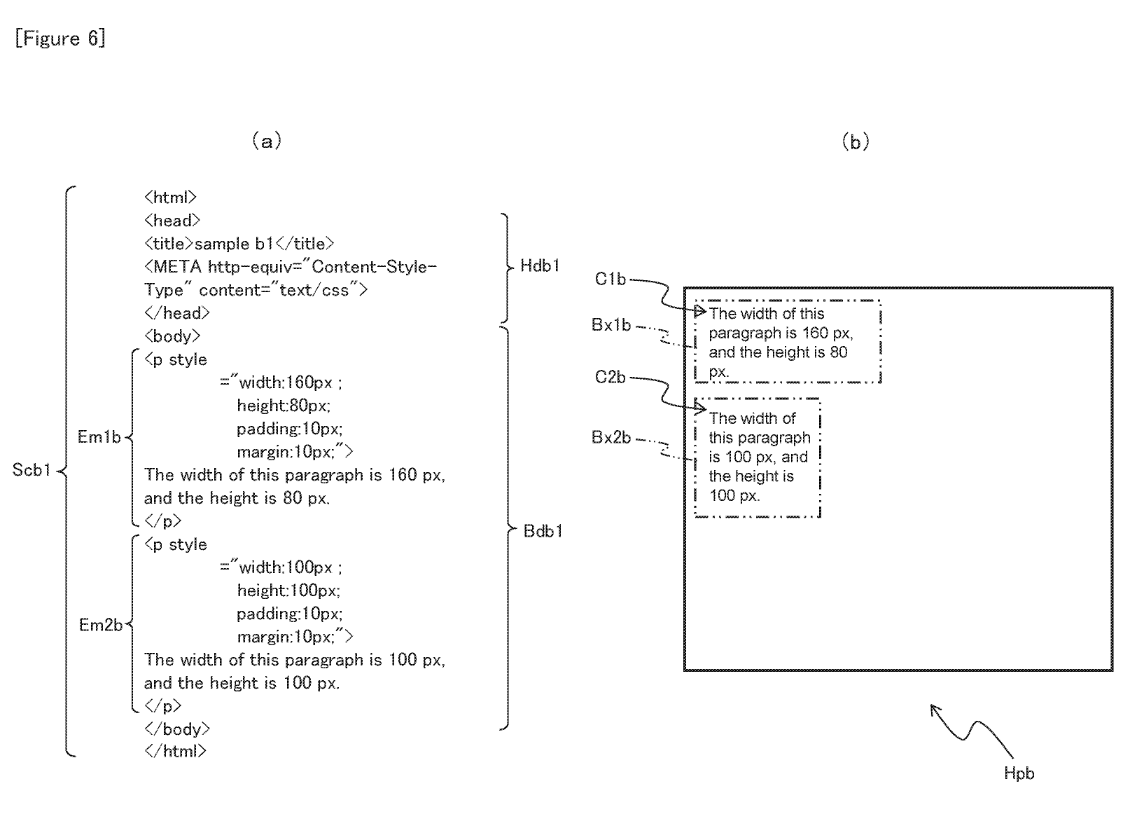

FIG. 6 is a diagram for explaining a regular layout rule for a block box when CSS is applied to a block element by the first method.

The source code Scb1 shown in FIG. 6(a) is substantially different from the source code Sca shown in FIG. 5(a) in that CSS is applied by the first method (see FIG. 3(a)) to two block elements (p elements) Em1b and Em2b contained in a body element Bdb1 following the head element Hdb1 comprising the title element “sample b1”.

Thus, in the block boxes Bx1b and Bx2b corresponding to the block elements Em1b and Em2b, as shown in FIG. 6(b), the width, height, width of a padding region, and the width of the margin region are set according to the applied CSS.

However, the layout is not specified by CSS in the block elements Em1b and Em2b for the block boxes Bx1b and Bx2b, so that the block box Bx2b corresponding to the trailing block element Em2b is placed below the block box Bx1b corresponding to the block element Em1b which is described first according to a regular layout rule. In this case, a display screen Hpb displays contents C1b and C2b in alignment from top to bottom so that the contents fit within the corresponding block boxes Bx1b and Bx2b. However, the block boxes Bx1b and Bx2b are not displayed.

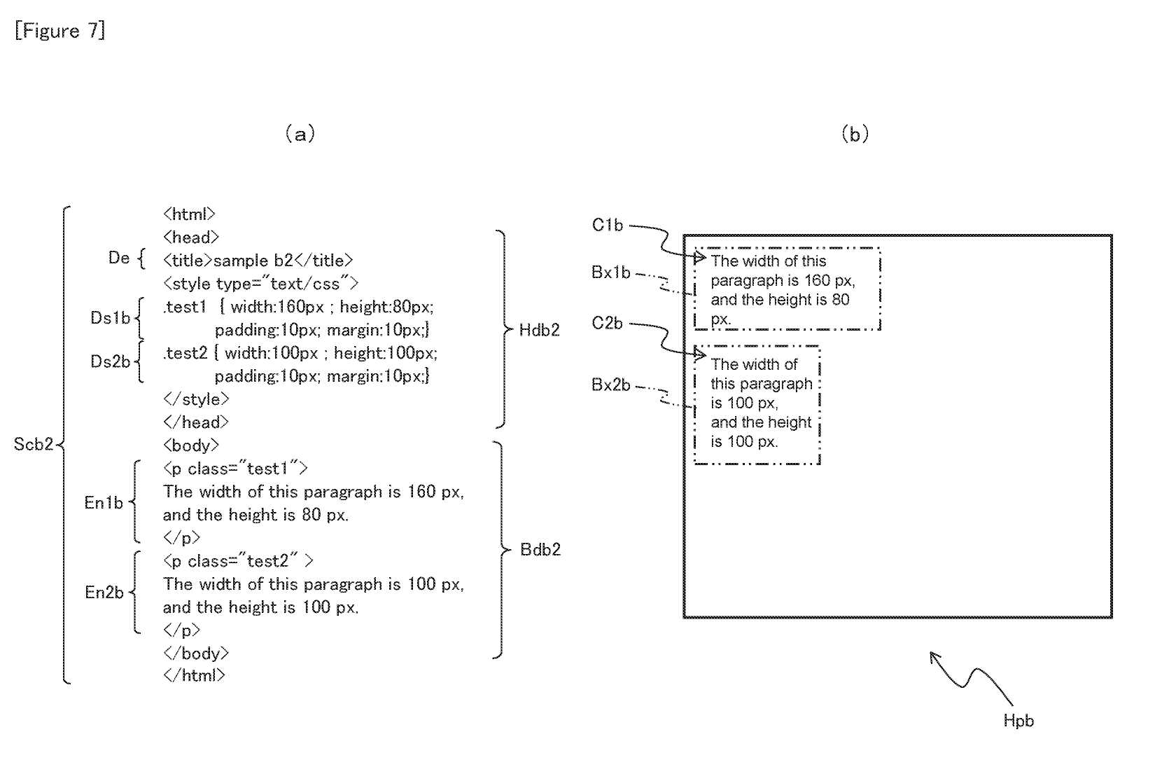

FIG. 7 shows a regular layout rule for a block box when CSS is applied to a block element by the second method.

The source code Scb2 shown in FIG. 7(a) is identical to the source code Scb1 shown in FIG. 6(a), other than applying CSS by the second method. Specifically, in the source code Scb2, CSS is declared with the declaration element (<style type=“text/css”>) De and a style to be applied is declared with test 1 attribute Ds1b and test 2 attribute Ds2b in a head element Hdb2, and the declared style is specified by a class attributes of each block element En1b and En2b. And thereby CSS is applied in the body element Bdb2. The display (FIG. 7(b)) based on the source code Scb2 is identical to the display (FIG. 6(b)) based on the source code Scb1.

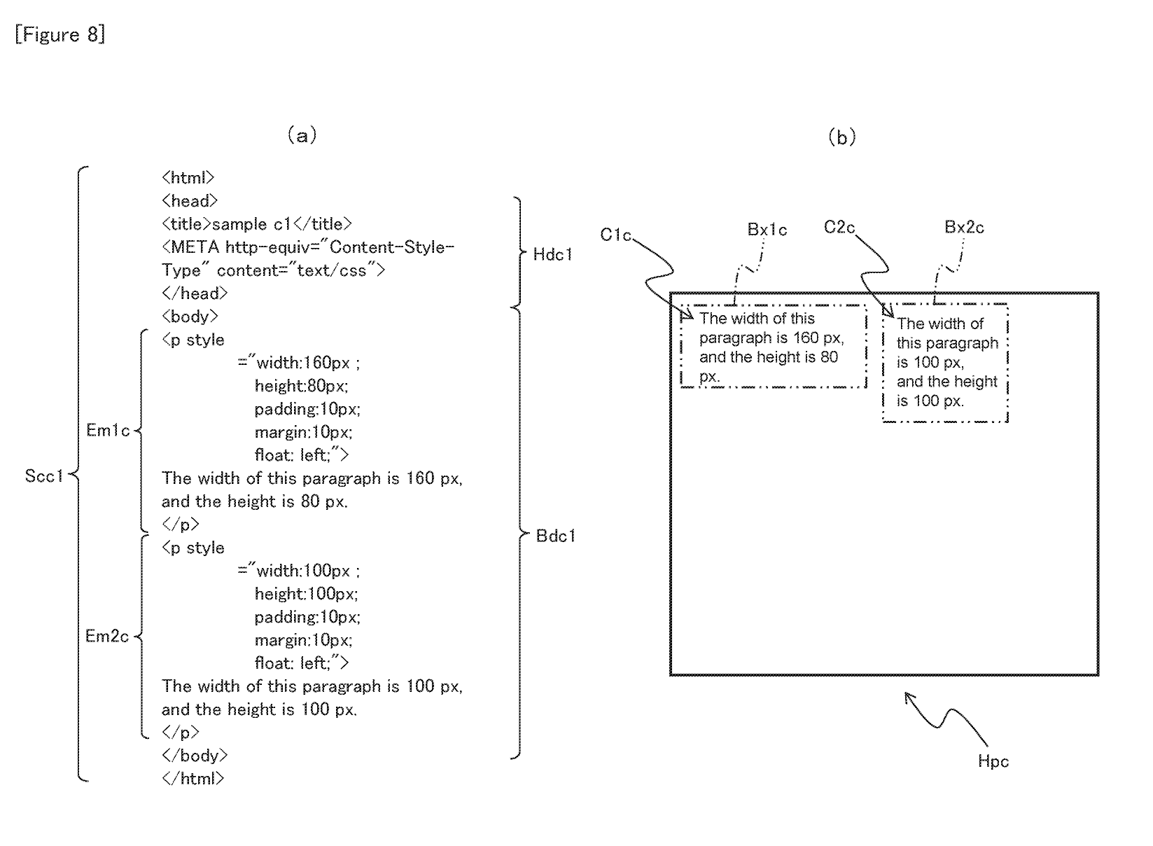

FIG. 8 is a diagram for explaining an irregular layout rule for a block box when CSS is applied to a block element by the first method.

The source code Scc1 shown in FIG. 8(a) is different from the source code Scb1 shown in FIG. 6(a) in that the layout for block boxes is also specified in two block elements (p elements) Em1c and Em2c contained in a body element Bdc1 following a head element Hdc1 including the title element “sample c1”.

Specifically, in p elements Ernie and Em2c, the width, height, padding, and margin of block boxes Bx1c and Bx2c generated by the p elements Ernie and Em2c are specified and further the layout information “float: left” specifies that the block box Bx2c corresponding to the p element Em2c is placed on the right side of the block box Bx1c corresponding to the p element Em1c, which is described in front of the p element Em2c.

According to the source code Scc1, the block box Bx2c corresponding to the block element Em2c in the back is placed towards the top left direction on the right side of the block box Bx1c corresponding to the block element Em1c in the front on the display screen Hpc according to an irregular layout rule of block boxes specified by CSS as shown in FIG. 8(b). In this case, the display screen Hpc displays contents C1c and C2c in alignment from left to right so that the contents fit within the corresponding block boxes Bx1c and Bx2c. However, the block boxes Bx1c and Bx2c are not displayed.

However, if there is no space to place the entire block box Bx2c corresponding to the block element Em2c in the back on the right side of the block box Bx1c corresponding to the block element Ernie in the front on the display screen, the block box Bx2c corresponding to the block element Em2b in the back is placed below the block box Bx1c corresponding to the block element Ernie in the front according to this irregular layout rule.

An irregular layout rule is not limited to placing the block box Bx2c corresponding to the block element Em2c in the back to the right side of the block box Bx1c corresponding to the block element Ernie in the front. An irregular layout rule can place the block box Bx2c corresponding to the block element Em2c in the back, for example, the left or top side of the block box Bx1c corresponding to the block element Ernie in the front. In this case, information specifying a layout for block boxes such as the layout information “float: right” can be used.

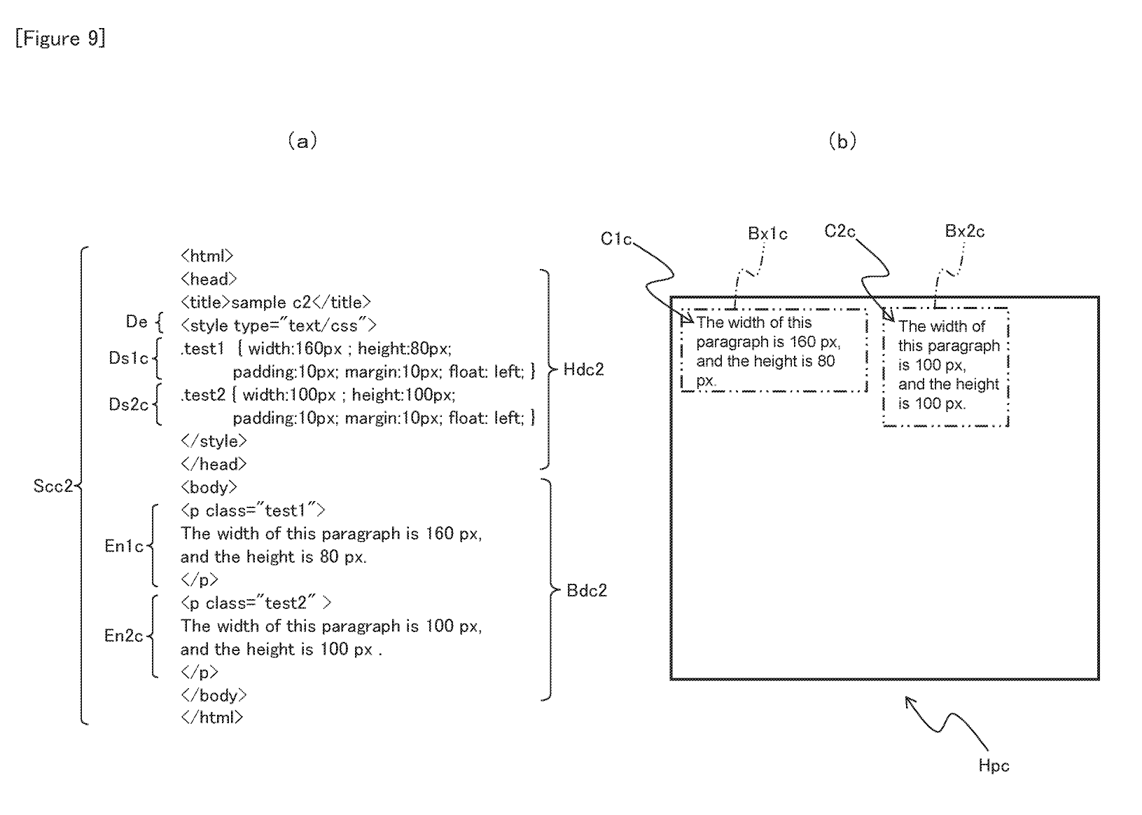

FIG. 9 shows an irregular layout rule for a block box when CSS is applied to a block element by the second method. The source code Scc2 shown in FIG. 9(a) is identical to the source code Scc1 shown in FIG. 8(a), other than applying CSS by the second method. Specifically, in the source code Scc2, CSS is declared with the declaration element (<style type=“text/css”>) De in a head element Hdc2, and a style including a layout for a block box is declared with test 1 attribute Ds1c and test 2 attribute Ds2c and the declared style is specified by a class attribute of each block element En1c and En2c. And thereby CSS is applied in the body element Bdc2. The display (FIG. 9(b)) based on the source code Scc2 is identical to the display (FIG. 8(b)) based on the source code Scc1.

(3-2) Layout Rule for Inline Box

FIG. 10 is a diagram for explaining a layout rule (regular layout rule) for an inline box when CSS is not applied to an inline element.

According to a regular layout rule for inline boxes, a plurality of inline boxes corresponding to a plurality of inline elements placed in order in the document described in HTML are basically placed so that the inline box in the back corresponding to the inline element in the back follows on the right side of the inline box in the front corresponding to the inline element in the front successively without changing the row. However, if there is no space to place the entire inline box in the back on the right side of the inline box in the front on a display screen Hpd, only the front portion of the inline box in the back is placed on the right side of the inline box in the front, and the rest of the inline box in the back is placed below the inline box in the front after changing the row.

For example, the source code Scd shown in FIG. 10(a) comprises a head element Hdd including the title element “sample d” and a subsequence body element Bdd. The body element Bdd includes two inline elements Em1d and Em2d therein. If CSS is not applied to these inline elements, contents C1d and C2d of the two inline elements Em1d and Em2d are displayed on the display screen Hpd to align with a sentence writing path from the top left end on the display screen Hpd according to the regular layout rule as shown in FIG. 10(b). In this regard, the content C1d of the inline element Em1d is “This box is a u inline box. (underlined)”, and the content C2d of the inline element Em2d is “This box is a b inline box. (bolded)”.

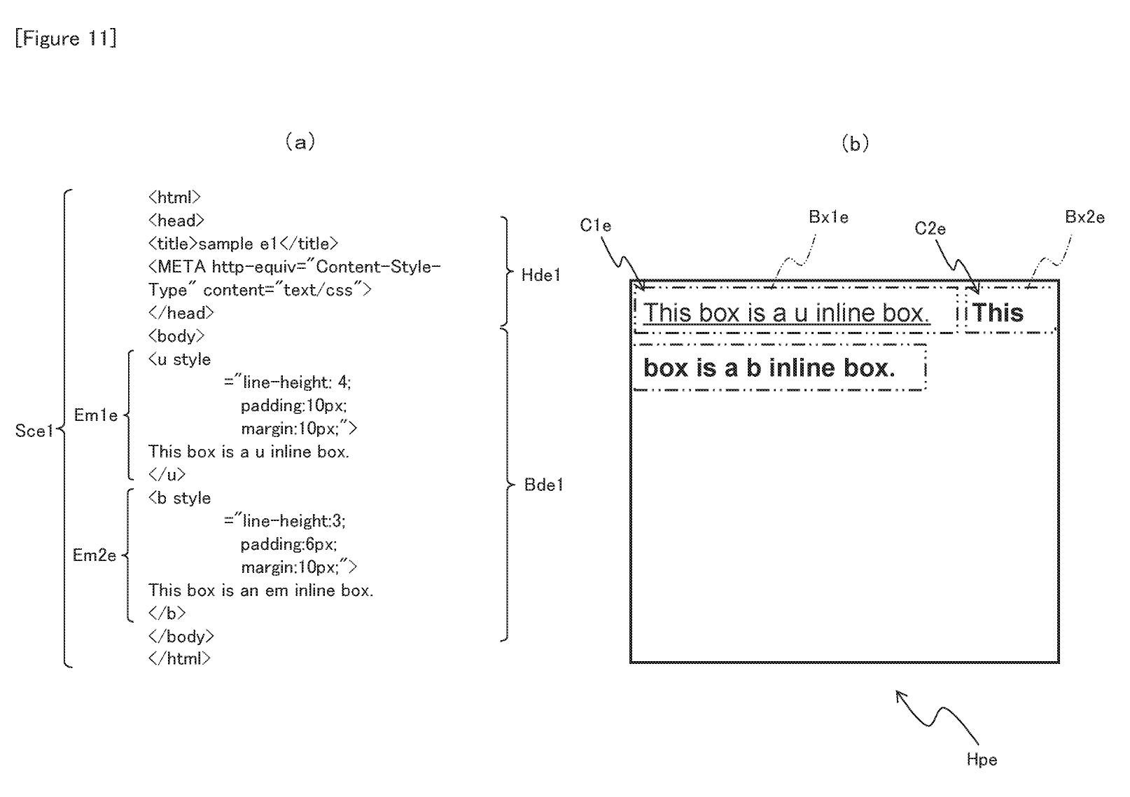

FIG. 11 is a diagram for explaining a regular layout rule for an inline box when CSS is applied to an inline element by the first method.

The source code Sce1 shown in FIG. 11(a) is substantially different from the source code Scd shown in

FIG. 10(a) in that CSS is applied by the first method (see FIG. 3(a)) to each element Em1e and Em2e contained in a body element Bde1 following a head element Hde1 including the title element “sample e1”.

Thus, row spacing, padding, and margin are set according to the applied CSS as shown in FIG. 11(b) for inline boxes Bx1e and Bx2e corresponding to the inline elements Ernie and Em2e.

However, a layout for inline boxes is not specified by CSS in the corresponding inline elements Ernie and Em2e. Thus, the inline boxes Bx1e and Bx2e corresponding to each inline element Ernie and Em2e are placed so that the inline box Bx2e corresponding to the inline element Em2e in the back is placed on the right side of the inline box Bx1e corresponding to the inline element Ernie in the front along the sentence writing path in the same manner as a case where CSS is not set according to a regular layout rule for inline boxes as shown in FIG. 11(b). However, if there is no space to place the entire inline box Bx2e on the right side of the inline box Bx1e, the portion of the inline box Bx2e sticking out from a display screen Hpe is placed on the next line. Also, in this case, the inline boxes Bx1e and Bx2e are not displayed on the display screen Hpe. Contents C1e and C2e are displayed along the sentence writing path so that the contents fit within the corresponding inline boxes Bx1e and Bx2e.

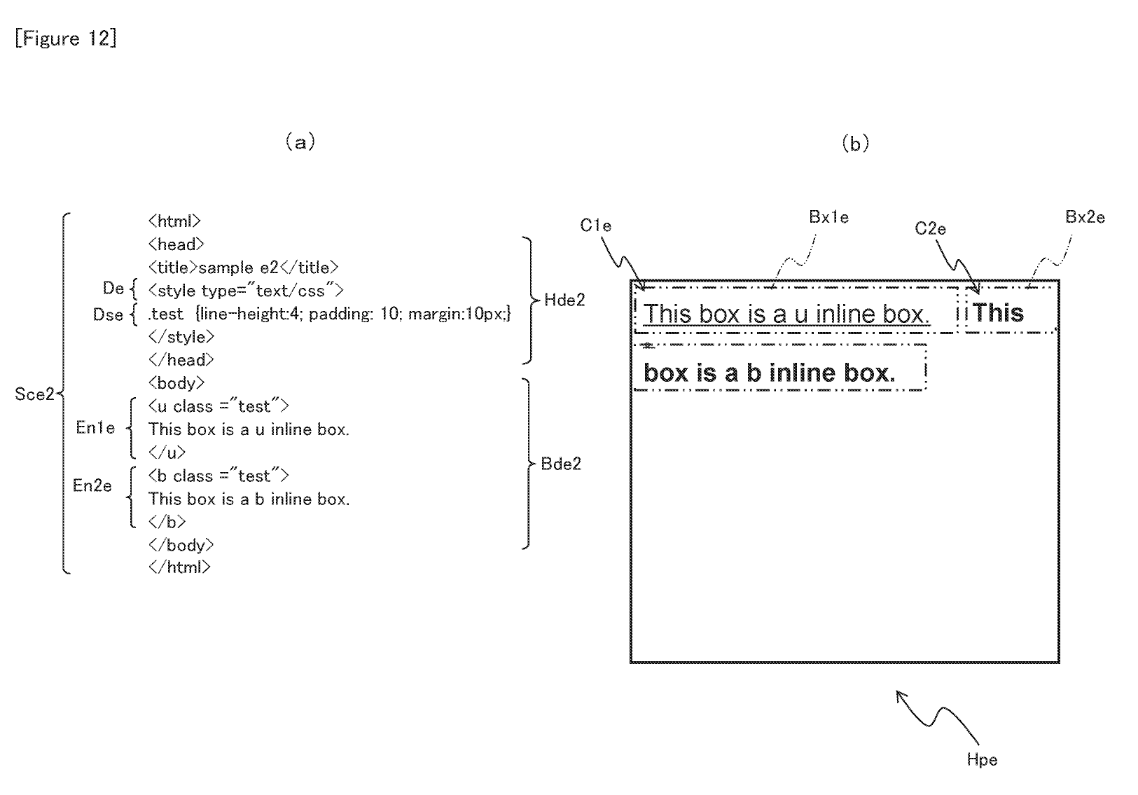

FIG. 12 shows a regular layout rule for inline boxes when CSS is applied to inline elements by the second method. The source code Sce2 shown in FIG. 12(a) is identical to the source code Sce1 shown in FIG. 11(a), other than applying CSS by the second method. Specifically, in the source code Sce2, CSS is declared with the declaration element (<style type=“text/css”>) De and a style to be applied is declared with test attribute Dse in a head element Hde2, and the declared style attribute is specified by a class attribute of inline element En1e and En2e. And thereby CSS is applied in the body element Bde2. The display (FIG. 12(b)) based on the source code Sce2 is identical to the display (FIG. 11(b)) based on the source code Sce1.

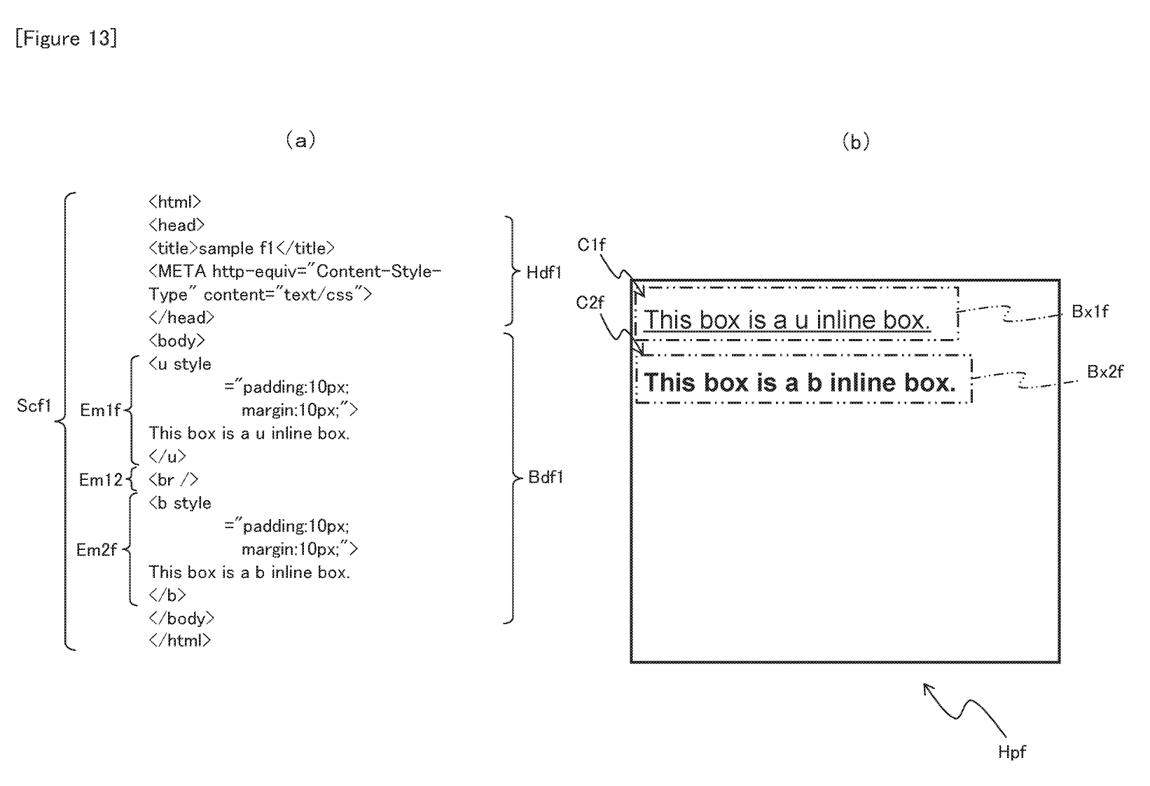

FIG. 13 is a diagram for explaining an irregular layout rule for an inline box when CSS is applied to an inline element by the first method and a br tag is used to specify a layout.

The source code Scf1 shown in FIG. 13(a) is fundamentally different from the source code Sce1 shown in FIG. 11(a) in terms of comprising two inline elements Em1f and Em2f contained in a body element Bdf1 following a head element Hdf1 including the title element “sample f1” as well as a br tag “<br/>” Em12 between the inline elements Em1f and Em2f placed to specify the layout for inline boxes. Specifically, as shown in FIG. 13(b), the inline box Bx2f in the back is placed below the inline box Bx1d in the front when there is no space to place the entire inline box Bx2f in the back for the trailing inline element Em2f on the right side of the inline box Bx1f in the front corresponding to the inline element Em1f described first.

Also in this case, contents C1f and C2f are displayed on a display screen Hpf so that the contents fit within the corresponding inline boxes Bx1f and Bx2f, while the inline boxes Bx1f and Bx2f are not displayed.

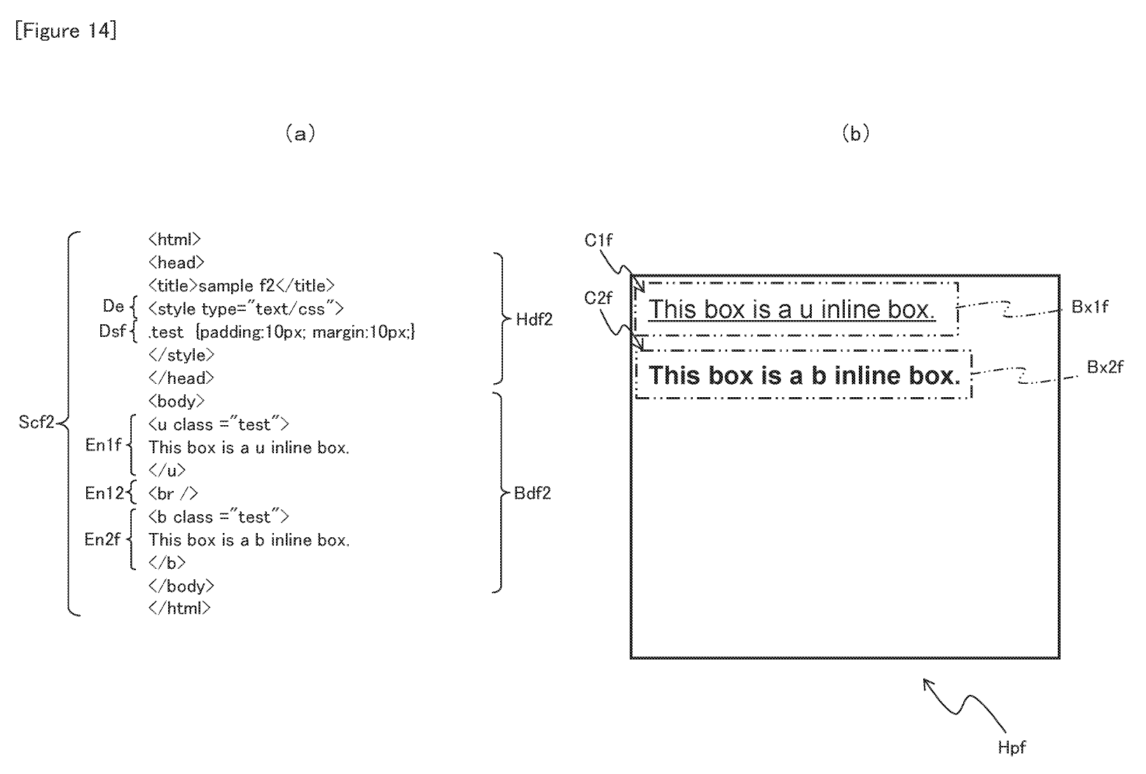

FIG. 14 shows an irregular layout rule for an inline box when CSS is applied to an inline element by the second method and a br tag is used for specifying a layout. The source code Scf2 shown in FIG. 14(a) is identical to the source code Scf1 shown in FIG. 13(a), other than applying CSS by the second method. Specifically, In the source code Scf2, CSS is declared with the declaration element (<style type=“text/css”>) De and a style that is not a layout for an inline box is declared with test attribute Dsf in a head element Hdf2, and the declared style is specified by a class attribute of each of the elements En1f and En2f. And thereby CSS is applied in the body element Bdf2. Furthermore, the layout for the inline boxes Bx1f and Bx2f is specified by a br tag “<br/>” En12 positioned between the two inline elements En1f and En2f.

The display (FIG. 14(b)) based on the source code Scf2 is identical to the display (FIG. 13(b)) based on the source code Sce1.

An irregular layout rule for inline boxes is not limited to a rule that places a new inline box below an existing inline box as discussed above, but can be freely set with a specific tag or with CSS in some cases. For example, a new inline box can be placed on the top side or the like of an existing inline box.

(4) Home Page Creation Method

A method of creating a home page by a user using the HP creation assisting device 10 shown in FIG. 1 is now explained.

Since a box is generated according to a given layout rule on a display screen by all the HTML elements in a source code, and the contents of the HTML elements are displayed within the boxes as discussed above, the HP creation assisting device 10 is configured to set a region for displaying a content as a box on an editing screen Se based on a user operation and to generate a description of an HTML element corresponding to the content created within the box according to a layout rule.

(4-1) Explanation of Editing Screen

FIG. 15 is a diagram showing a home page editing screen provided by the HP creation assisting device 10.

The editing screen Se comprises an operation screen Reo for creating a content of a home page, a preview screen Rep for displaying the created content, a material selection screen Res for selecting a material used in editing the home page, and a source screen Rae for editing a source code.

A plurality of operation buttons Bu1 to Bu6 and a plurality of value inputting regions V1 to V2, P1 to P4, and M1 to M4 for inputting a numerical value are placed on the operation screen Reo.

The operation button Bu1 is a button for creating a new block box. The operation button Bu2 is an editing button for inputting a text as a content within a created block box. The operation button Bu3 is a button for copying a selected box. The operation button Bu4 is a button for deleting a selected box. The operation button Bu5 is a lock button for denying individual operation on each of the plurality of boxes contained within a box. The operation button Bu6 is a button for switching between displaying and not displaying a line (outer line) representing the contour of a box (outer edge of a padding region). The function of the operation button Bu5 is explained in more detail as an invention for switching the operation on a region (referred to as a block in embodiment 3) for placing contents between batch operation and individual operation in embodiment 3.

The value inputting region V1 is a region for inputting a numerical value indicating the width of a box (value obtained by adding, to the width of the content region, the size of the left and right inside margins thereof, i.e., width of left and right padding regions thereof). The value inputting region V2 is a region for inputting a numerical value indicating the height of a box (value obtained by adding, to the height of the content region, the size of the top and bottom inside margins thereof, i.e., width of the top and bottom padding regions thereof). The value inputting regions P1 to P4 are regions for inputting a numerical value for setting the inside margin (width of a padding region) of a box. The inside margin on the left, top, right, and bottom sides of a box is set with the numerical values input into the value inputting regions P1, P1, P3, and P4. The value inputting regions M1 to M4 are regions for inputting a numerical value to set the outside margin (width of a margin region) of a box. The outside margin on the left, top, right, and bottom sides of a box is set with the numerical values input into the value inputting regions M1, M2, M3, and M4.

The preview screen Rep displays a created content and a box that is set for the content. However, a box can be displayed or not displayed by operating the operation button Buff.

The material selection screen Res displays, for example, a plurality of materials Ce1 to Ce4, which can include materials that are created in advance with the HP creation assisting device 10, materials that are downloaded from an Internet site, or materials that are copied from a recording medium. These materials are used as a content on the editing screen Se. A source code for displaying the material on a display screen as a content of a home page is stored in the memory 12 for each material. The material is not limited to those shown in FIG. 15 and the like. The material can be anything that can be utilized as a content of a home page.

The source screen Roe displays a source code matching the creation stage of a content on the editing screen Se. In the initial state before content creation, the source screen Roe displays a source code Sr0 comprising a head element Srh0 including a declaration (abbreviated) for applying CSS and an empty body element Srb0.

The editing screen Se that has been explained using FIG. 15 is one example of an editing screen. The arrangement of the operation buttons Bu1 to Bu6, and the placement and the shape of the preview screen Rep, source scree Rce, and material selection screen Res are not limited to those shown in FIG. 15. The preview screen Rep and the source screen Rce can be placed from left to right instead of the alignment from top to bottom. The material selection screen Res is not required. The operation region Reo with operation buttons placed therein does not necessarily need to be placed at a determined position. The operation buttons can be configured to appear at any position on the editing screen Se by an operation such as a right click of a mouse.

(4-2) Creation of Source Code of Block Element

First, a case is explained where a user creates a home page comprising two contents C1b and C2b placed on top and bottom as shown in FIG. 6(b) (or FIG. 7(b)).

A user opens the editing screen Se of the HP creation assisting device 10 and operates the creation button Bu1. The operation of the creation button Bu1 creates a new block box Br1a whose width extends fully on the preview screen Rep of the editing screen Se as shown in FIG. 16. A source code Sr1a reflecting the creation of the new block box Br1a is generated on the source screen Roe.

In the body element of the source code Sr1a, a description corresponding to the new block box Br1a is formed as a div element “<div></div>” Er1a. A description corresponding to a block box is not limited to a div element without any meaning (style). While this may be another block element with a meaning such as a p element, the HP creation assisting device 10 basically uses a div element without a meaning in a newly created block element so as not to restrict the degree of freedom upon giving a block element a meaning using a style sheet such as CSS with a class attribute at a later time.

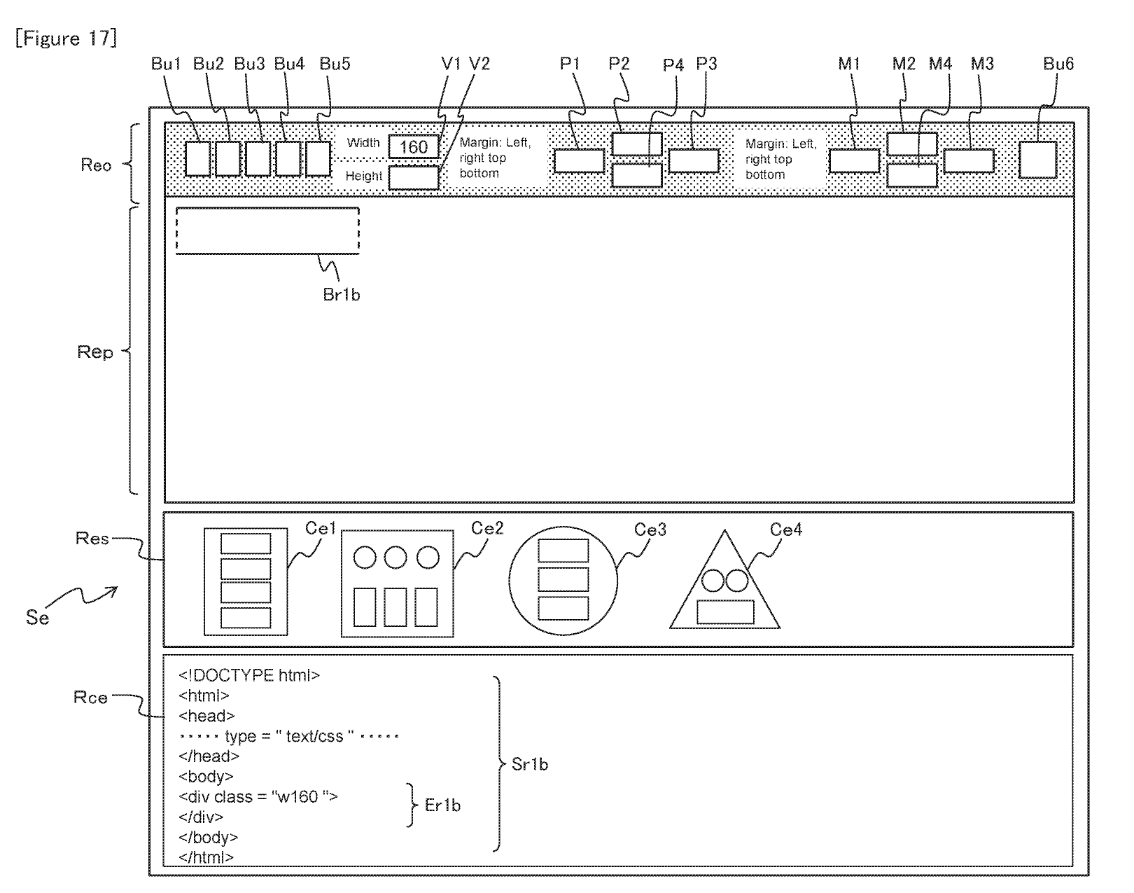

If a numerical value “160” is input into the value inputting region V1 on the editing screen Se in this state, the width of the block box Br1a is set. The block box Br1a (see FIG. 16) displayed on the preview screen Rep is changed thereby to a block box Br1b with a set width as shown in FIG. 17. In the source screen Rae, a source code Sr1b comprising a div element “<div class=“w160”></div>” Er1b is created by editing the div element aria of the source code Sr1a.

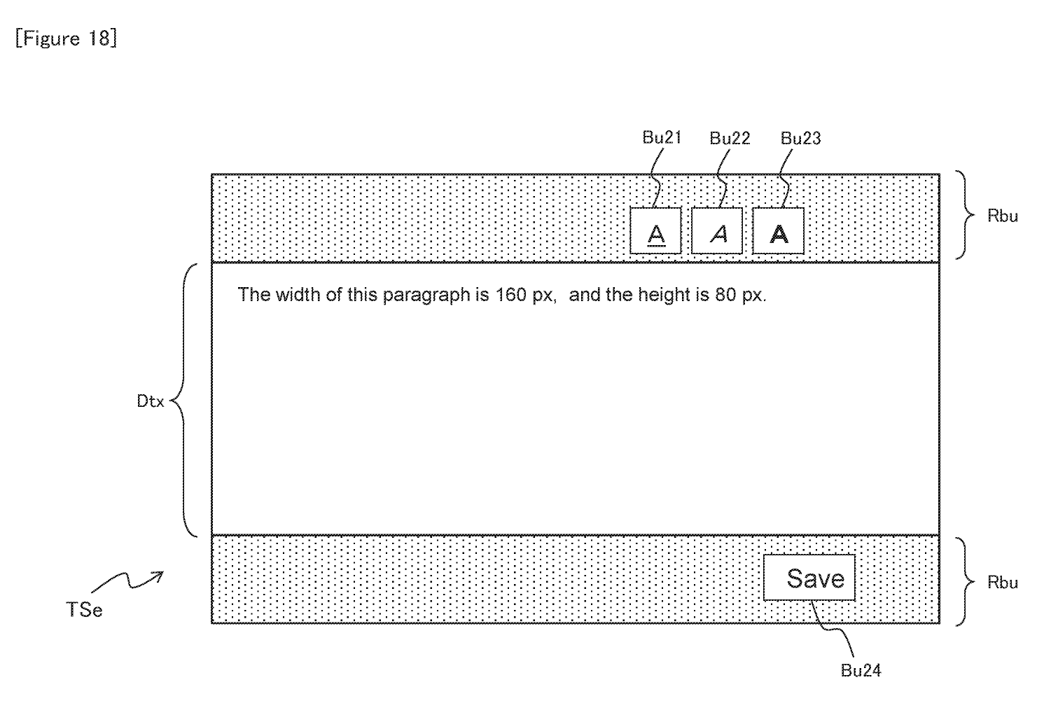

When a user selects the newly created block box Br1a as a target for inputting a text by a click operation on the preview screen Rep and operates the editing button Bu2, a text editing screen TSe is displayed to enable input of text information as shown in FIG. 18.

The text editing screen TSe comprises a text inputting region Dtx and a button placement region Rbu comprising operation buttons Bu21 to Bu24. The operation button Bu21 is a button for underlining a selected portion of a text. The operation button Bu22 is a button for italicizing a selected portion of a text. The operation button Bu23 is a button for bolding a selected portion of a text. The operation button Bu24 is a save button for displaying the input text data on the block box Br1b. However, the operation buttons are not limited thereto. A button for setting the text color or background color, a button for setting other styles for a text and the like can be provided.

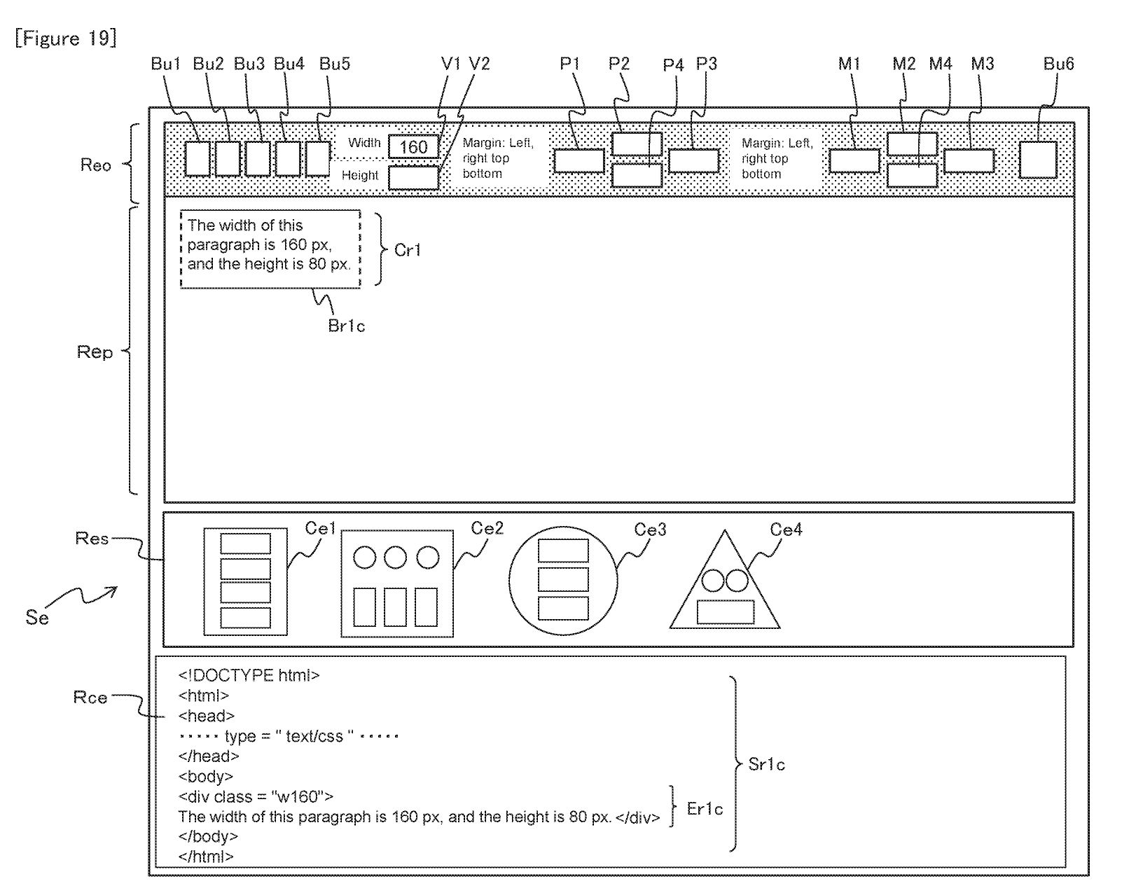

When a user inputs, for example, “The width of this paragraph is 160 px, and the height is 80 px” as a content into the text inputting region Dtx, and operates the save button Bu24, the new block box Br1b (see FIG. 17) displayed on the preview screen Rep is changed to a block box Br1c comprising the content “The width of this paragraph is 160 px, and the height is 80 px.” Cr1, and the source code Sr1b is changed to a source code Sr1c on the source screen Roe as shown in FIG. 19. In the source code Sr1c, the div element “<div class “w160”></div>” Er1b within the body element of the source code Sr1b is changed to a div element “<div class=“w160”> The width of this paragraph is 160 px, and the height is 80 px.</div>” Eric.

When only one of width and height of a block box is specified, the block box extends in the direction for which the size of width or height is not specified with an input of a text if a region occupied by the text does not fit within the block box due to the input of the text into the block box.

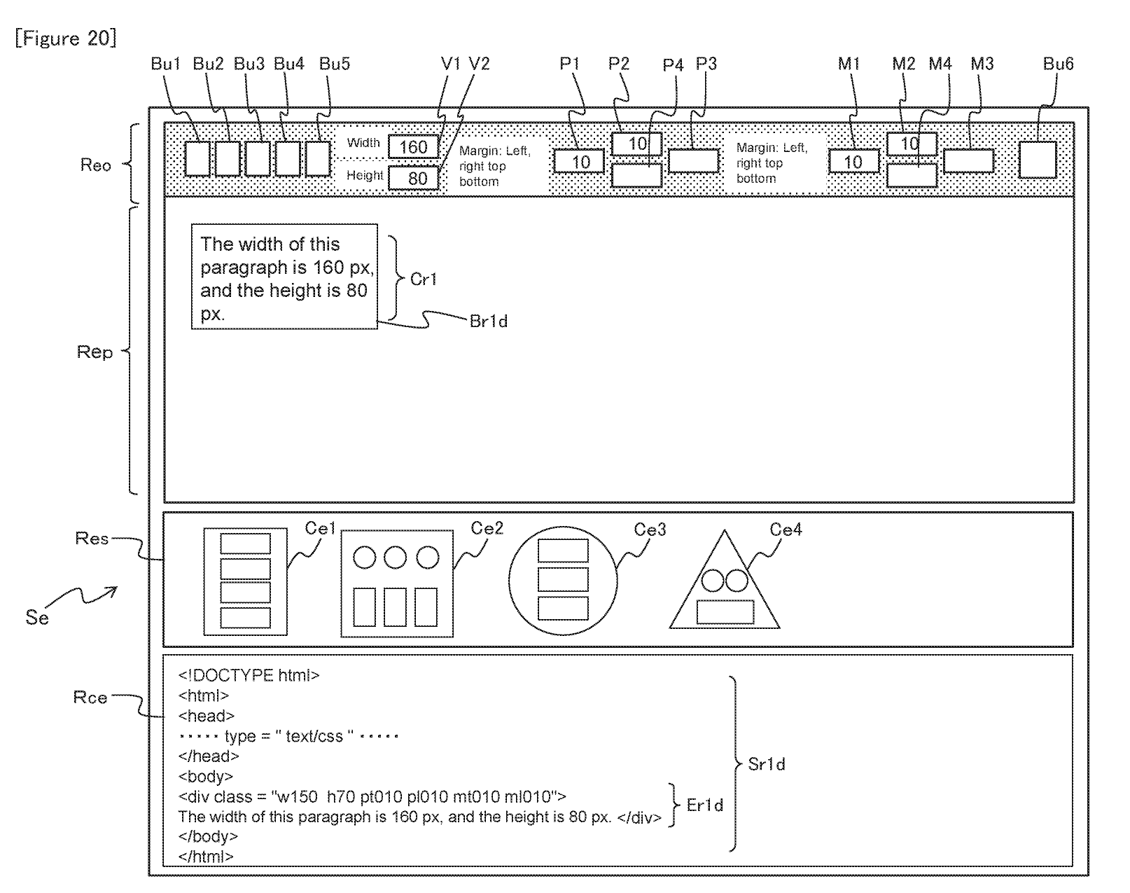

If the numerical values “80”, “10”, “10”, “10”, and “10” are input into the value inputting regions V2, P1, P2, M1, and M2 of the editing screen Se, respectively, the height, left inside margin, top inside margin, left outside margin, and the top outside margin of the block box Br1c are set, which changes the new block box Br1c (see FIG. 19) with only a set width to a new block box Br1d with a set width, height, left and top inside margins, and left and top outside margins in the preview screen Rep, and changes the source code Sr1c to a source code Sr1d in the source screen Rce as shown in FIG. 20. In the source code Sr1d, the description of a div element Er1d has changed to “<div class=“w150 h70 pt010 p1010 mt010 m1010”> The width of this paragraph is 160 px, and the height is 80 px.</div>” to reflect the inputs of numerical values on the editing screen Se.

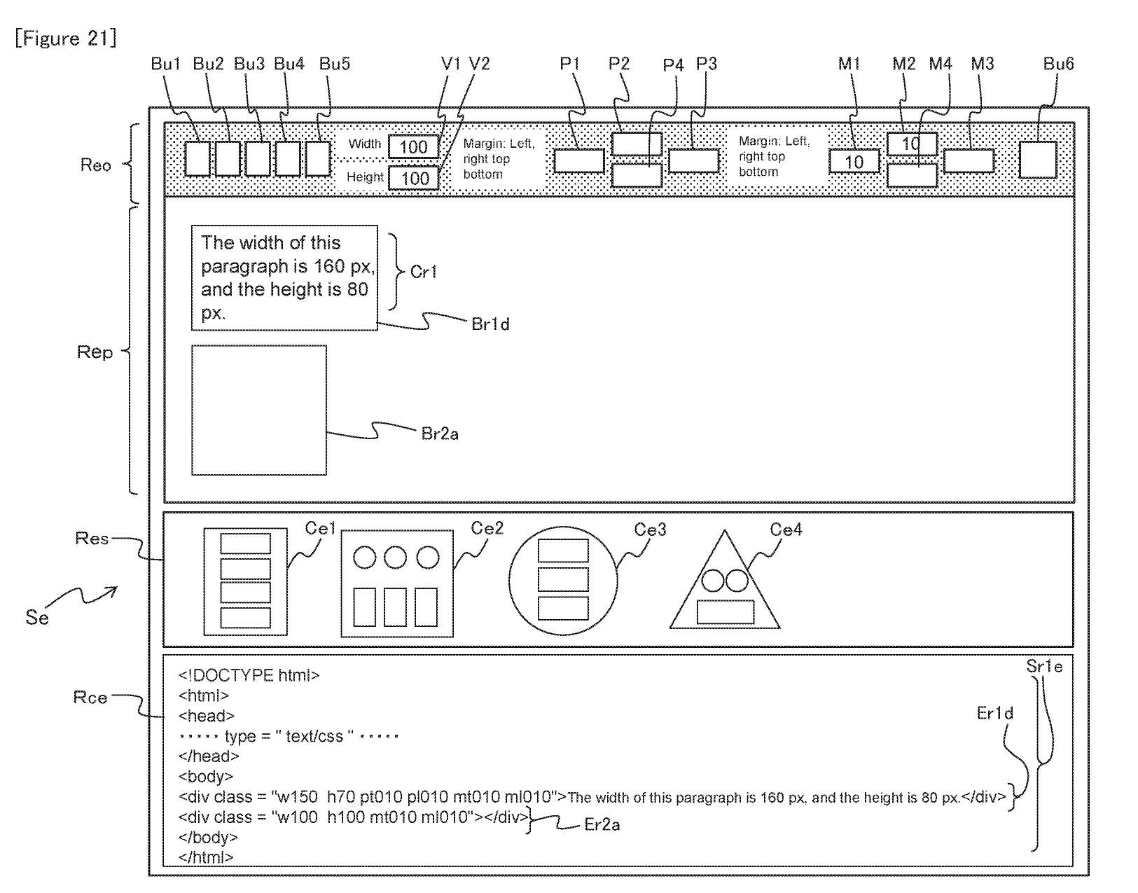

If the operation button Bu1 is pressed, for example, to create a second content thereafter, a new block box is placed below the first block box Br1d as shown in FIG. 16. If the new block box is set to width “100”, height “100”, left outside margin “10”, and top outside margin “10”, the new block box becomes a block box Br2a that is set to width “100”, height “100”, left outside margin “10”, and top outside margin “10” as shown in FIG. 21. At this time, the source code Sr1d (see FIG. 20) is changed to a source code Sr1e on the source screen Roe in accordance with the generation of a new block box. Since the placement of the new block box Br2a relative to the existing block box Br1d in this case is a placement according to a regular layout rule as explained in FIGS. 6 and 7, a div element Er2a containing no information specifying the layout for the block box is generated as an element corresponding to the block box Br2a in the source code Sr1e. The code of the div element Er2a is “<div class=“w100 h100 mt010 m110”></div>”.

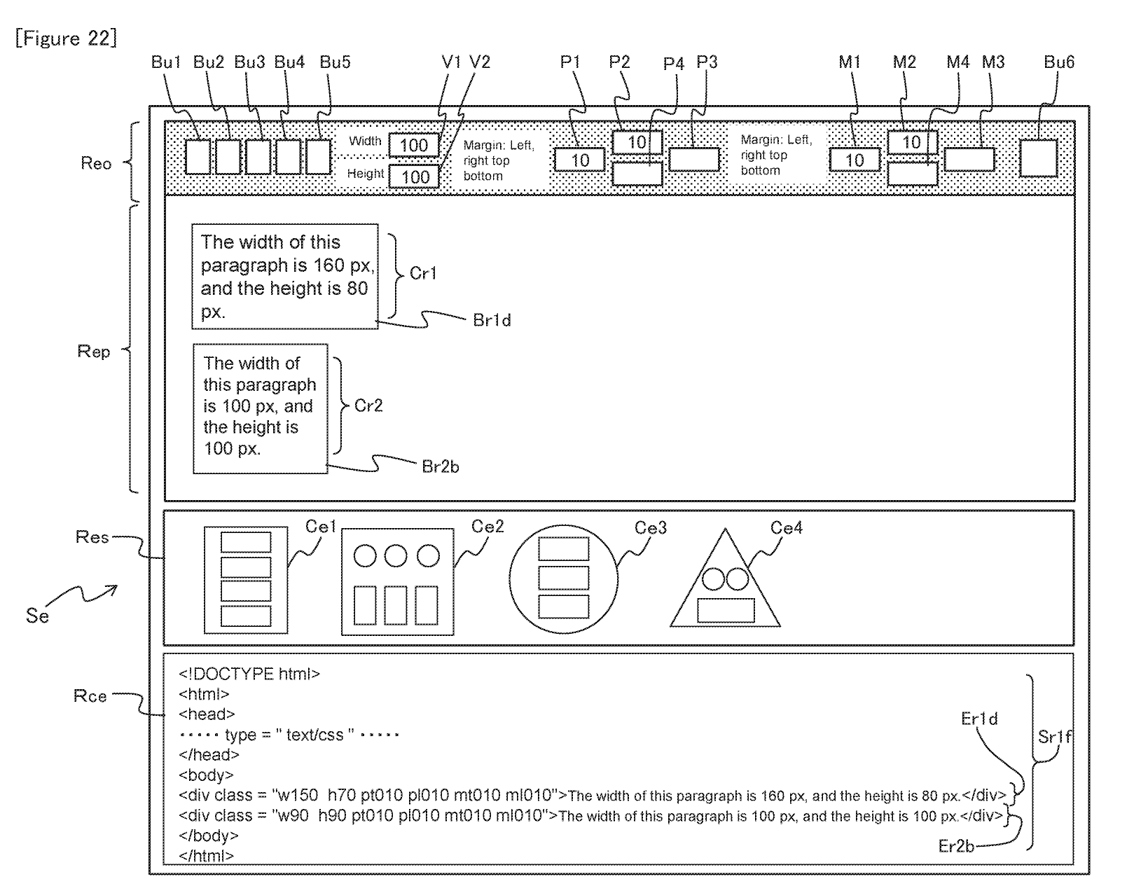

When a text is then input into the newly created block box Br2a, and the left inside margin is set to “10” and the top inside margin is set to “10”, a home page with contents Cr1 and Cr2 placed on the top and bottom is created on the preview screen Rep, and the source code Sr1e (see FIG. 21) is changed to a source code Sr1f due to a change from the div element Er2a to a div element Er2b in the source screen Roe as shown in FIG. 22. In this regard, the code of the div element Er2b is “<div class=“w90 h90 pt010 p1010 mt010 m1010”> The width of this paragraph is 100 px, and the height is 100 px.</div>”.

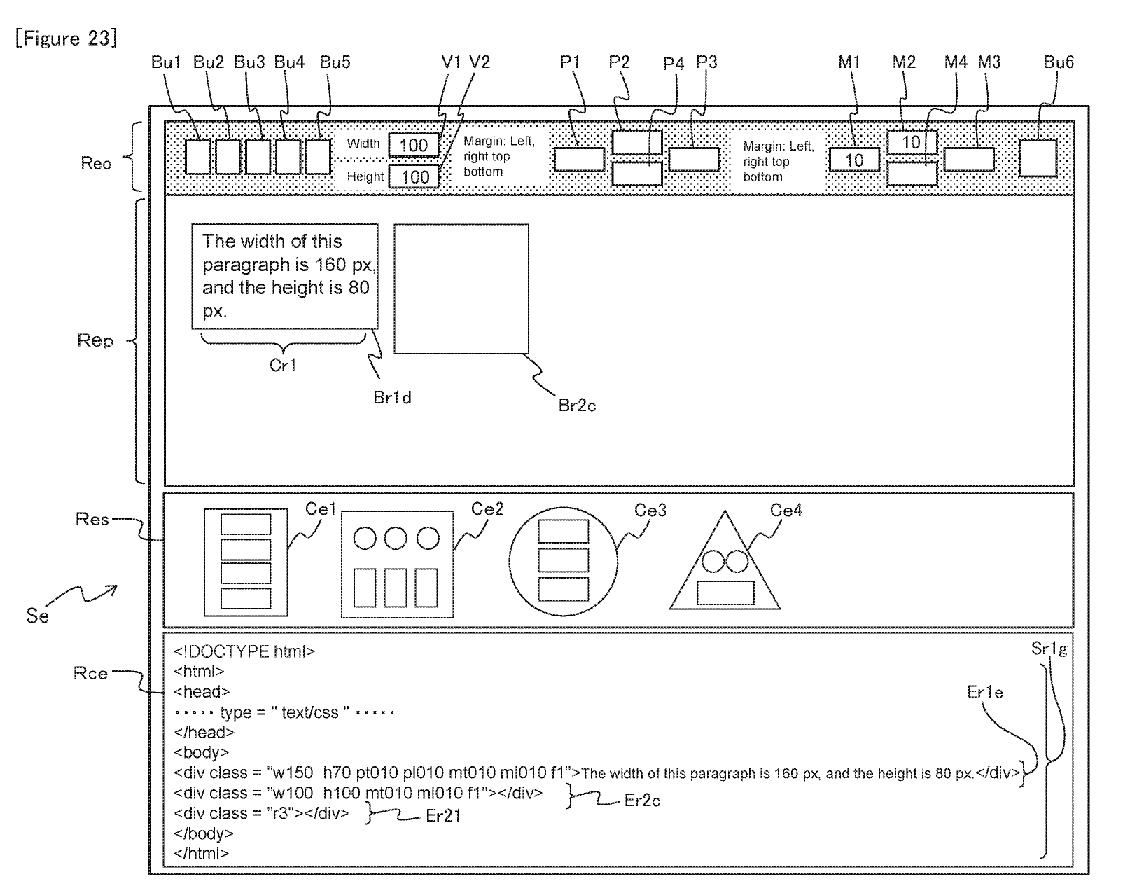

Meanwhile, when a user creates a home page comprising two contents C1c and C2c placed on the left and right as shown in FIG. 8(b) (or FIG. 9(b)), if the new block Br2a is created below the existing block box Br1d as shown in FIG. 21, and then the new block box Br2a is moved to the right side of the existing block box Br1d by dragging with a mouse or the like, the source code Sr1e is changed to a source code Sr1g on the source screen Roe as shown in FIG. 23. The new block box Br2a after the move is considered block box Br2c for convenience of explanation.

In this case, the placement of the new block box Br2c after the movement relative to the existing block box Br1d is a placement according to one of the irregular layout rules. Thus, a div element Er2c comprising information “f1” for specifying the layout of the block box is generated as an element corresponding to the block box Br2c in the source code Sr1g. The description of the div element Er2c is “<div class=“w100 h100 mt010 m110 f1”></div>”.

The div element Enid corresponding to the existing block box Br1d is also rewritten into a div element Erie, which is written to add the information “f1” specifying the layout for the block box to the description of the div element Er1d. Furthermore a div element Er21 for blocking the effect due to the information “f1” for forcibly placing a block box side by side is generated as an HTML element following the div element Er2c. The description of the div element Er21 is “<div class=“r3”><div>”.

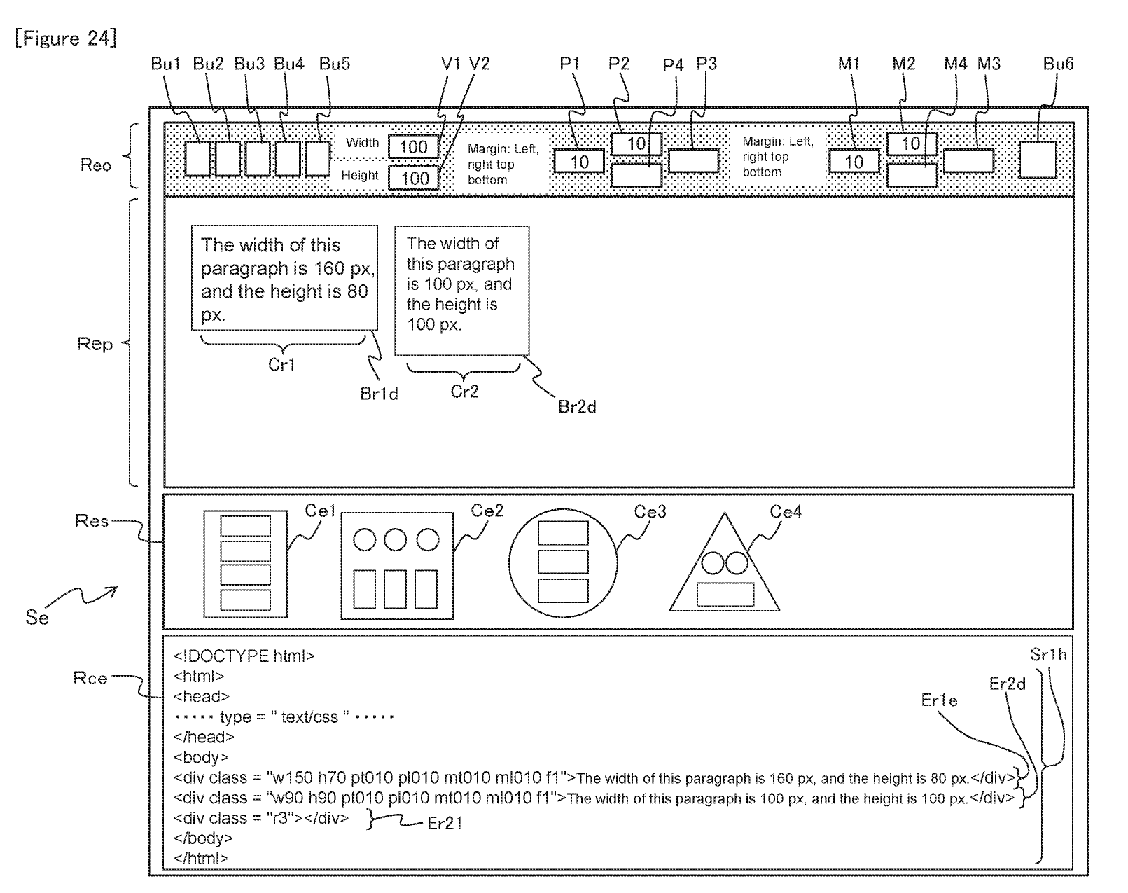

A text is then input into the newly created block box Br2c, and the left inside margin is set to “10” and the top inside margin is set to “10” to create a home page with contents Cr1 and Cr2 placed on the left and right, while the source code Sr1g is simultaneously changed to a source code Sr1h as shown in FIG. 24. Specifically, the div element Er2c changes to a div element Er2d “<div class=“w90 h90 pt010 p110 mt010 m110 f1”> The width of this paragraph is 100 px, and the height is 100 px.</div>”.

Editing of a block box such as inputting a text within the block boxes Br1d and Br2c can be performed any time after the creation of the block boxes. Clicking on a region of a block box to select a target block box for text input and then pressing the editing button Bu2 displays the text editing screen TSe, enabling input of a text into the selected block box.

The above explanation of content creation does not show an instance where another block box is placed in a block box, but editing operations such as inputting a text into each block box when at least one other block box is contained in a block box is performed in the same manner as when a block box does not contain another block as discussed above. In this regard, in a method of placing a block box inside a block box, a block box is placed within a block box by pressing the creation button Bu1 while a block box is selected, for example, by clicking. When the creation button Bu1 is pressed without selecting an existing block box, a new block box is placed below an existing block box.

The placement of hierarchical block boxes where a block box is contained in another block box can be a multi-hierarchy placement in which a block box is contained in another block box, and the another block box is further contained in another block box.

(4-3) Creation of Source Code of Inline Element

For example, when a user creates a home page comprising two contents C1e and C2e as shown in FIG. 11(b) (or FIG. 12(b)), the user operations the creation button Bu1. By the operation of the creation button Bu1, a new block box Br1a is created on the editing screen Se, and the newly created block box Br1a is displayed on the preview screen Rep of the editing screen Se as shown in FIG. 16. A div element “<div></div>” Er1a corresponding to the new block box Br1a is added to the body element of the source code Sr1a in the source screen Rce.

If, for example, the numerical values “530”, “80”, “10”, “10”, “10”, and “10” are input into the value inputting regions V1, V2, P1, P2, M1, and M2 of the editing screen Se in this state, the width, height, left inside margin, top inside margin, left outside margin, and top outside margin of the block box Br1a are set, which results in display of a new block box Br3 with a set width, height, left inside margin, top inside margin, left outside margin, and top outside margin on the preview screen Rep as shown in FIG. 25. A div element “<div class=“w520 h70 pt010 p1010 mt010 m1010”></div> Er3 is generated in a source code Sr3 displayed on the source screen Rce. As discussed above, the width and height of a block box indicated by a source code are values subtracting the set values of the left and right and top and bottom inside margins from the width and height shown in the value inputting regions V1 and V2 on the editing screen Se due to the specification of the device.

Next, when a user selects the newly created block box Br3 by clicking on the preview screen Rep as a target of text input and operates the editing button Bu2, the text editing screen TSe is displayed, enabling the input of text information.

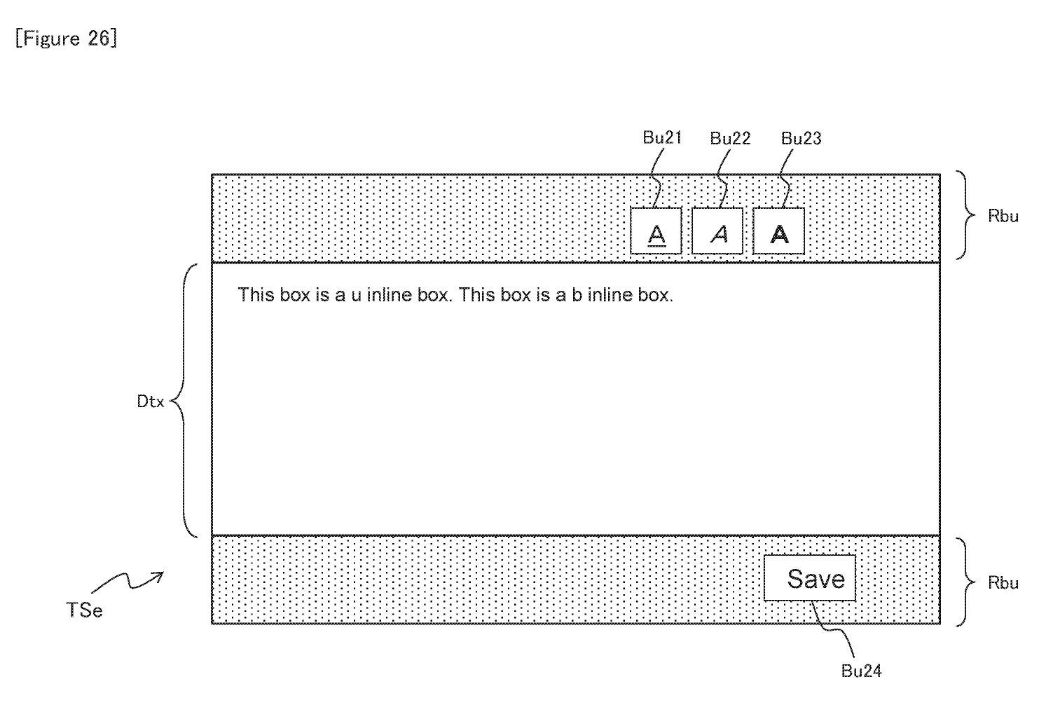

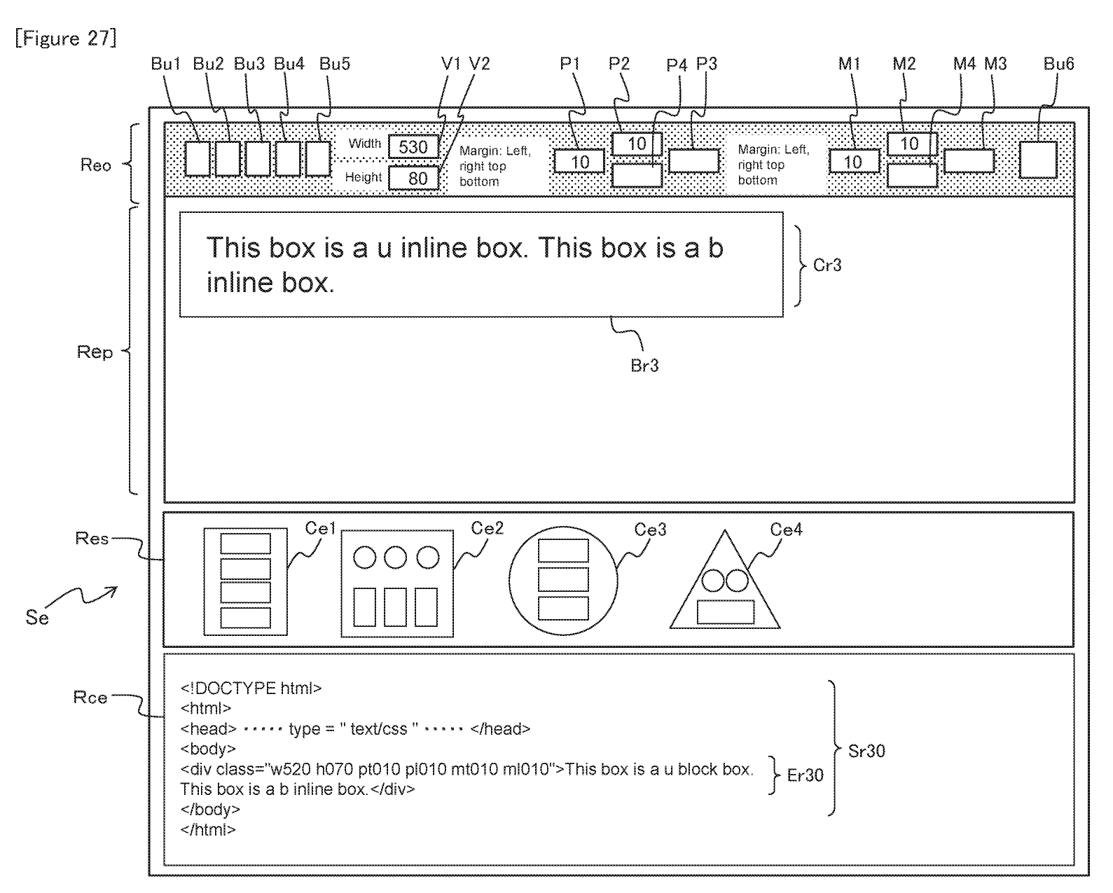

If for example the content “This box is a u inline box. This box is a b inline box.” is input into a text inputting region Dtx on the text editing screen TSe as shown in FIG. 26, a content “This box is a u inline box. This box is a b inline box.” Cr3 is generated in the block box Br3 on the preview screen Rep as shown in FIG. 27. When the content Cr3 is generated, a source code Sr30 displayed on the source screen Roe on the editing screen Se includes the div element “<div class=“w520 h70 pt010 p1010 mt010 m1010”> This box is a u inline box. This box is a b inline box.</div>” Er30

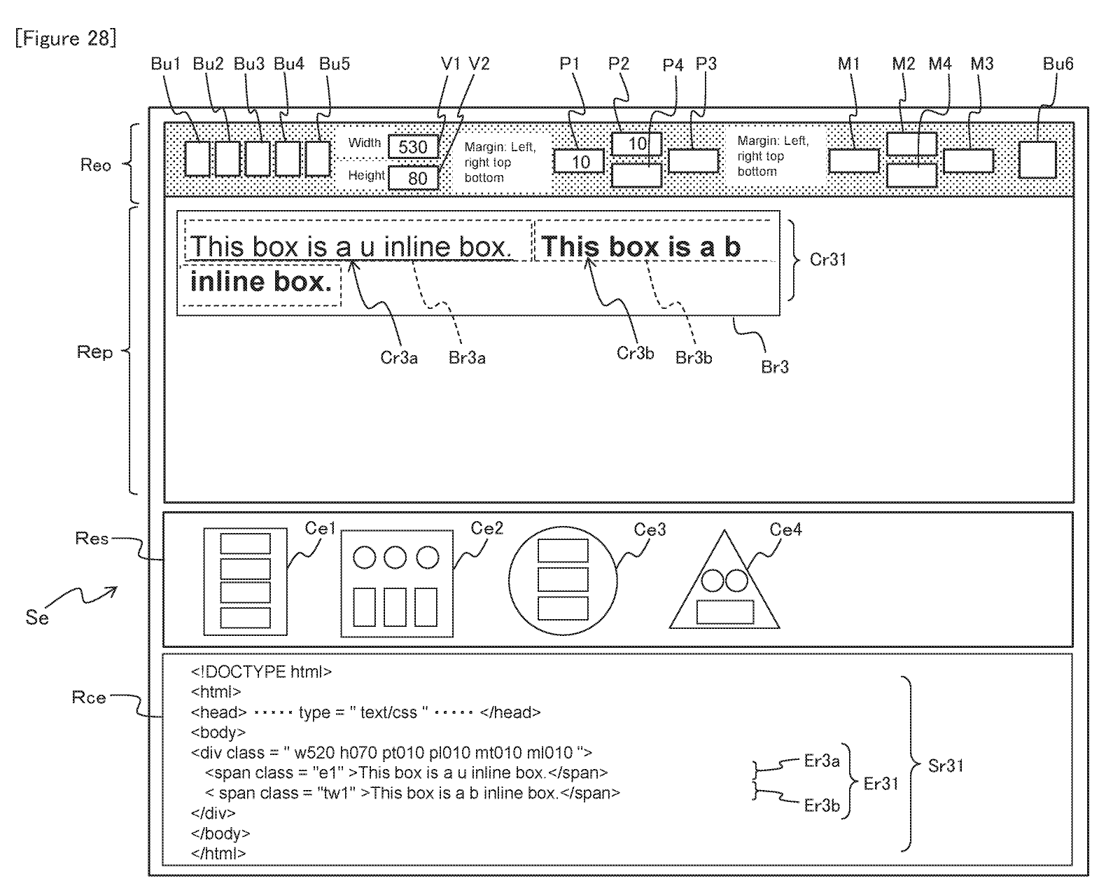

When the description for the first half of the content “This box is a u inline box.” is underlined with the operation button Bu21 and the description for the second half “This box is a b inline box.” is bolded with the operation button Bu23 followed by the operation of the save button Bu24, content Cr31 comprising two contents Cr3a and Cr3b is displayed inside the new block box Br3 displayed on the preview screen Rep as shown in FIG. 28. An inline box corresponding to a tag specifying a style is generated by setting the style (underlined characters, bolded characters, or the like) of the content Cr3 of a block element displayed within the block box Br3 in this manner.

In this case, the two contents Cr3a and Cr3b are contents of an inline element, and the contents are displayed within the corresponding inline boxes Br3a and Br3b.

The placement of the inline boxes Br3a and Br3b matches the regular layout rule, in which the inline box corresponding to the trailing inline element successively is placed on the right side of the inline box corresponding to the preceding inline element on the same line. Thus, the source code Sr31 is described so that the descriptions of inline elements Er3a and Er3b do not contain information indicating the positional relationship of the inline boxes Br3a and Br3b as shown in FIG. 28. Attribute value “e1” of the class attribute of a span element in the inline element Er3a is an attribute value specifying an underline by CSS. Attribute value “tw1” of the class attribute of a span element in the inline element Er3b is an attribute value specifying bold by CSS.

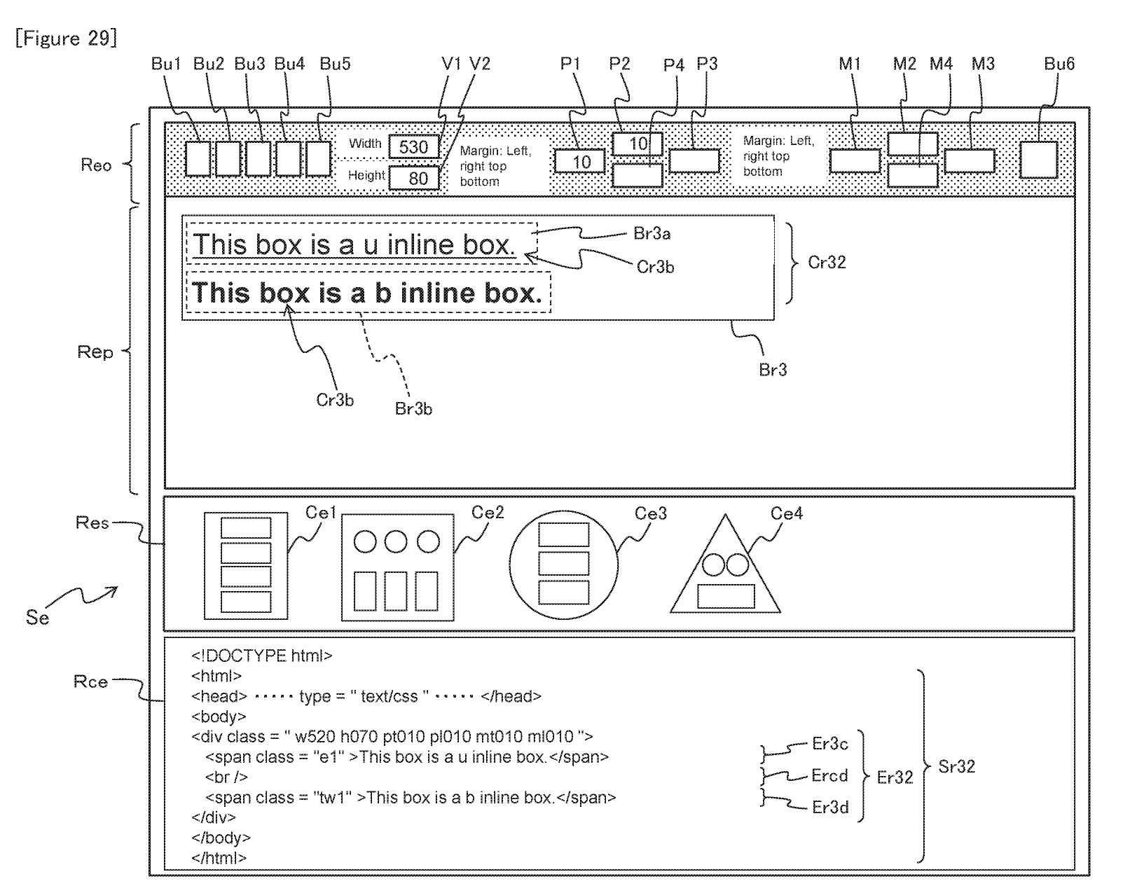

Meanwhile, when the two contents Cr3a and Cr3b are moved to align on the top and bottom as shown in FIG. 29 by dragging the content Cr3b with a mouse while the two contents Cr3a and Cr3b are aligned with the writing path as shown in FIG. 28, the contents follow one of the irregular layout rules of inline boxes. In this case, as shown in FIG. 29, a content Cr32 comprising the two contents Cr3a and Cr3b placed on top and bottom is displayed inside the new block box Br3 displayed on the preview screen Rep. In a source code Sr32, descriptions of inline elements Er3c and Er3d comprise information indicating the positional relationship of the inline boxes Br3a and Br3b. Specifically, span elements Er3c and Er3d are generated such that the span elements Er3c and Er3d sandwich information (br tag “<br/>”) Ercd specifying the layout of the inline boxes Br3c and Br3d, as an inline element. Attribute value “e1” of the class attribute of a span element in the inline element Er3c is an attribute value specifying an underline by CSS. Attribute value “tw1” of the class attribute of a span element in the inline element Er3d is an attribute value specifying bold by CSS.

Edits such as text input into the inline boxes Br3a and Br3b can also be made any time after the inline boxes have been created in the same manner as block boxes.

A process of generating a description of an HTML element corresponding to contents based on positional relationship of the contents on the editing screen Se with the computer 10a of the HP creation assisting device 10 is now explained.

The source codes shown in FIGS. 15 to 29 are unique to the HP creation supporting device 10. After the source codes of a home page have been completed with the HP creation assisting device 10, the unique source codes are automatically converted to a common source code explained in FIGS. 5 to 14.

Specifically, the source code Sr1f of a home page shown in FIG. 22 is converted to the source code Scb1 or Scb2 shown in FIG. 6(a) or 7(a). The source code Sr1h of a home page shown in FIG. 24 is converted to the source code Scc1 or Scc2 shown in FIG. 8(a) or 9(a).

The source code Sr31 of a home page shown in FIG. 28 is converted to the source code Sce1 or Sce2 shown in FIG. 11(a) or 12(a). The source code Sr32 of a home page shown in FIG. 29 is converted to the source code Scf1 or Scf2 shown in FIG. 13(a) or 14(a).

A case explained as for the aforementioned home page creation methods is a case where, simply by a user designing the home page by creating or moving a content on the preview screen Rep, the HP creation assisting device 10 generates a source code of a home page designed by the user.

It is understood however that a user can directly edit the source code of a home page.

(5) Home Page Creation Process

FIG. 30 is a diagram showing an HTML element generation process according to a layout rule for a box in a flowchart.

First, when a user operates the input operation unit 13a of the HP creation assisting device 10, an operation signal S is input into the processor 11 via the input interface 13 from the input operation unit 13a. The processor 11 performs a computation in accordance with the operation signal S. For example, the processor 11 outputs display data D to the display unit 14a via the output interface 14 to display a display screen such as the home page editing screen Se, or operates the network controlling unit 16 to communicate data via the network N such as the Internet, or accesses data between the external storage device 15a and the memory 12 via the I/O interface 15 to read or write data from/on the external storage device 15a.

When a user creates one or more contents constituting a home page on the editing screen Se displayed on the display unit 14a in the HP creation assisting device 10, the created content is automatically converted to a source code of a home page and whereby the creation of the home page is assisted.

This is specifically explained.

The processor 11 executes a process of displaying the home page editing screen Se on the display unit 14a based on the operation of the input operation unit 13a by a user and starts the following processes of steps S10 to 18.

The processor 11 determines whether a new box is created on the editing screen Se (step S10), and repeats the determining process if a new box is not created. On the other hand, if a new box has been created, the processor determines whether the new box is a block box or an inline box (step S11).

For example, a block box is formed in a process of generating a new box in addition to the existing block box Br1d as shown in FIG. 21, and two inline boxes Br3a and Br3b are formed inside the block box Br3 in a process of underlining the first half and bolding the latter half of content Cr3 within the block box Br3 as shown in FIG. 28.

Whether a newly formed box is a block box or an inline box in this manner is determined by whether the created element is a block element or an inline element,

If the new box is a block box, the processor 11 determines whether the new box follows a regular layout rule for block boxes (step S12). If the placement of the new box Br2a relative to the existing block box Br1d follows a regular layout rule for block boxes as shown in FIG. 21, the processor 11 generates a source code Sr1e described so that the new box is placed by the regular layout rule for block boxes (step S14).

On the other hand, if the placement of the new box Br2c does not follow a regular layout rule for block boxes, the processor 11 generates a source code (e.g., source code Sr1g) described so that the new box Br2c is placed by a rule compatible with the positional relationship of this case among the multiple irregular layout rules as shown in FIG. 23 (step S15).

The processor 11 then determines whether an ending operation such as closing the editing screen Se has been performed by a user operation (step S18). If an ending operation has been performed, the processor 11 ends the editing process. If not, a process of the processor 11 is returned to the process in step S10.

If a new box is determined to be an inline box in step S11, the processor 11 determines whether the new box follows an regular layout rule for inline boxes (step S13). If the placement of the new inline box Br3b relative to the inline box Br3a follows a regular layout rule for inline boxes, the processor 11 generates a source code (e.g., source code Sr31) described so that the new inline box is placed by a regular layout rule for inline boxes as shown in FIG. 28 (step S16).

On the other hand, if the positional relationship of the new inline box Br3b relative to the inline box Br3a does not follow a regular layout rule for inline boxes as shown in FIG. 29, a source code described so that the new inline box Br3b is placed by a rule compatible with the positional relationship of this case among the multiple irregular layout rules is generated (step S17).

It is then determined whether an ending operation such as closing the editing screen Se has been performed by a user operation (step S18). If an ending operation has been performed, the editing process is ended. If not, a process of the processor 11 is returned to the process in step S10.

In this manner, in the HP creation assisting device 10 of embodiment 1, the processor 11 creates a box for placing a content of a home page on an editing screen based on a user operation, and determines the positional relationship between a target box which is a target of creation and an existing box adjacent the target box, and edits the description of at least the target box of the target box and the existing box in the source code so that the description is in accordance with a layout rule compatible with the positional relationship among multiple layout rules for specifying the placement of boxes. Thus, a user can create a source code of a home page on which a plurality of contents without information indicating the position to be placed on an editing screen are placed at a desired position simply by specifying the relative positional relationship of boxes for placing contents. As a result, a general user can create an intended home page by a simple operation on an editing screen of a computer.

A case explained in Embodiment 1 is the case where, when a positional relationship between a target box which is a target of creation and an existing box adjacent to the target box does not follow a regular layout rule for these boxes, descriptions for both the target box and the existing box in a source code is edited to be descriptions in accordance with a layout rule compatible with the positional relationship among multiple layout rules specifying the placement of boxes. Meanwhile, if the positional relationship between a target box and an existing box does not follow a regular layout rule, the description for only the target box in the source code can be edited to be a description in accordance with a layout rule compatible with the positional relationship.

A case explained in Embodiment 1 is also the case where a program for assisting the creation of a home page is stored on a user side terminal, but such a program can be stored on a server on the Internet. The user side terminal can transit an operation signal to the server to create the home page and assist the creation of the home page by a user on the server.

In particular, the home page creation process explained in embodiment 1 can be executed by a web application which operates in cooperation between a program installed on a web server and a program in a programming language that operates on a browser on the user side terminal instead of a stand-alone application that is operated by a program installed on the user side terminal as in embodiment 1.

Specifically, an environment is constructed where a web browser (browser) on the user side terminal can access a home page creation assisting site (web server) and a web application can execute a home page creation assisting process on the browser by cooperation between a program operated on the browser and a program for performing a home page creation assisting process on the server side.

In this case, a source code of a home page completed by the home page creation assisting process can be stored on the server side or provided to the user side terminal from the server side.

### Embodiment 2

FIG. 31 is a diagram for explaining an HP creation assisting device according to embodiment 2 of the present invention.

The HP creation assisting device 20 of embodiment 2 has a computer 20a for processing information, an input operation unit 13a, and a display unit 14a as in the HP creation assisting device 10 in embodiment 1. The computer 20a comprises a memory 22 instead of the memory 12 of the computer 10a in embodiment 1. A program for making the processor 11 execute a process that is different from that of the HP creation assisting device 10 in embodiment 1 as a process for assisting the creation of a home page is stored in the memory 22.

The configuration of the HP creation assisting device 20 in embodiment 2 is identical to the configuration of the HP creation assisting device 10 in embodiment 1 other than the memory 22 of the computer 20a.

A process of assisting the creation of a home page (hereinafter, the HP creation assisting process) performed by the HP creation assisting device 20 in embodiment 2 is specifically explained hereinafter.

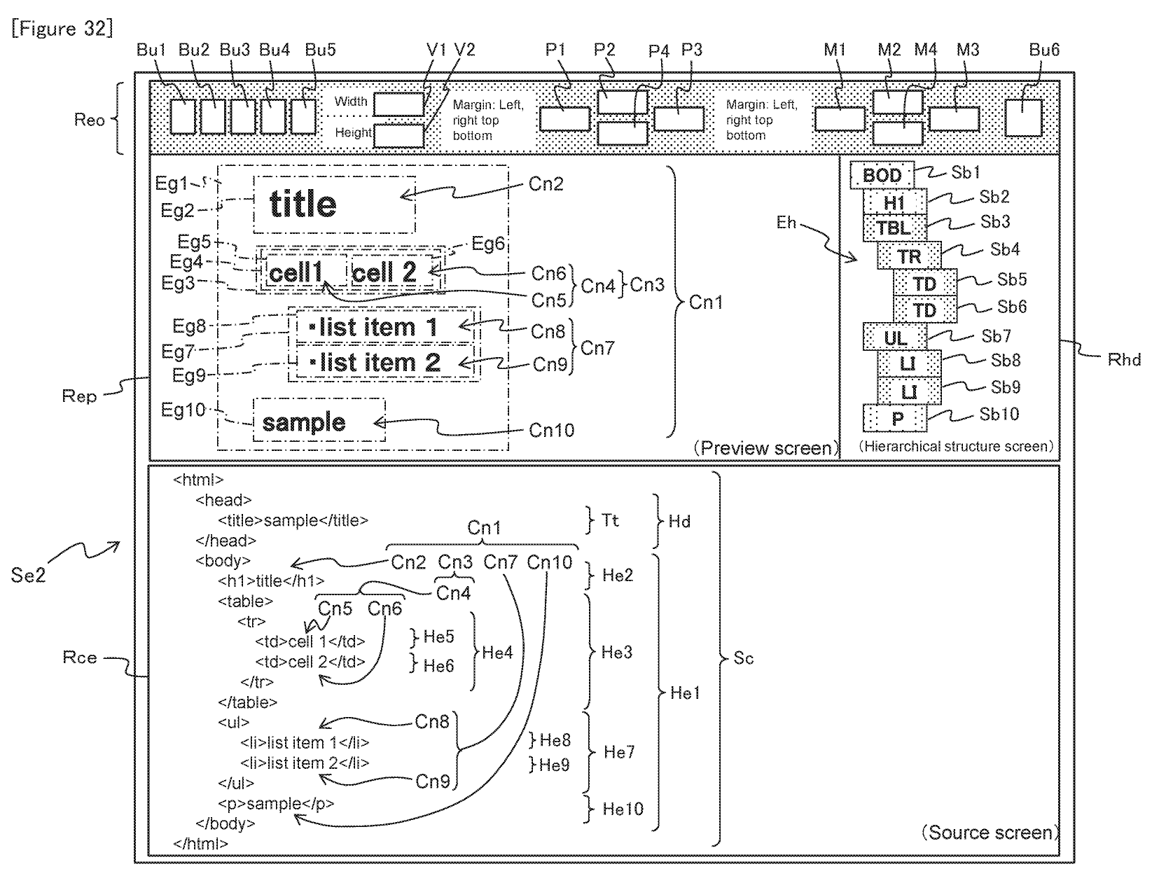

FIG. 32 is a diagram showing an editing screen Se2 that is displayed on a display unit 14a of the HP creation assisting device 20 in embodiment 2. Elements in FIG. 32 assigned with the same symbol as those in FIG. 15 are identical to those in the editing screen Se of embodiment 1.

The HP creation assisting process performed by the HP creation assisting device 20 in embodiment 2 comprises a process of displaying the editing screen Se2 for editing a home page on the display unit 14a, a process of creating (inputting, drawing, pasting, or the like) one or more contents constituting the home page based on an operation signal S by a user operation, and a process of simultaneously displaying the status of content creation on the preview screen Rep, source screen Roe, and hierarchical structure screen Rhd. These processes are performed by the processor 11 executing a program stored on the memory 22. It is understood that a common operation system is stored on the memory 22 for functioning the processor 11 as a text editor or as a browser. A program for performing a process of assisting the creation of a home page in the same manner as the HP creation assisting device 10 in embodiment 1 can be further stored in the memory 22. In this case, a content can be edited on the preview screen Rep. In addition, a source code corresponding to one or more contents that have been edited on the preview screen Rep is displayed on the source screen Rce, and the hierarchical structure of the one or more contents that have been edited on the preview screen Rep is displayed on the hierarchical structure screen Rhd. However, to simplify the explanation, the HP creation assisting device 20 in embodiment 2 is assumed to lack a function for performing the HP creation assisting process of the HP creation assisting device 10 in embodiment 1.

In this regard, in the source screen Rae, an HTML element contained in a source code Sc that has been input into a text editor is displayed. In the preview screen Rep, contents of one or more elements contained in the source code Sc are displayed. In the hierarchical structure screen Rhd, a hierarchical structure Eh of the one or more contents is displayed.

For example, when 10 contents Cn1 to Cn10 are created by an input of a source code on the editing screen Se2 of the HP creation assisting device 20, in the source screen Roe, the source code Sc comprising HTML elements He1 to He10 specifying the contents Cn1 to Cn10 are displayed. In the preview screen Rep, the contents Cn1 to Cn10 of the HTML elements He1 to He10 contained in the body portion of the source code Sc are displayed as shown in FIG. 32. In the hierarchical structure screen Rhd, the hierarchical structure Eh of the HTML elements He1 to He10 contained in the body portion of the source code Sc is displayed with symbols Sb1 to Sb10 indicating a hierarchical node.

In the HP creation assisting device 20 in embodiment 2, the corresponding HTML elements He1 to He10 contained in the source code Sc displayed on the source screen Rae, the contents Cn1 to Cn10 displayed on the preview screen Rep, and the hierarchical node-indicating symbols Sb1 to Sb10 displayed on the hierarchical structure screen Rhd are associated with one another.

Thus, if a user clicks on any content on the preview screen Rep, any HTML element on the source screen Rce, or any symbol on the hierarchical structure screen Rhd, portions corresponding to the clicked content, HTML element, or symbol are highlighted on the screens other than the clicked screen.

A general home page contains a very large number of HTML elements. With such association, a user can see at a glance where on the home page the HTML element which the user is editing in the source screen Rce is positioned or which hierarchy in the hierarchical structure it belongs to.

The technique of identifying the position of a content displayed on a screen of the display unit 14a for displaying display data D from the computer 10 based on a reference position on the screen by the processor 11 and the technique for recognizing the position specified by a pointing device such as a mouse on the screen based on a reference position on the screen by a processor are conventional. The specific explanation thereof is omitted.

The mechanism for associating an HTML element displayed on the source screen Roe, content displayed on the preview screen Rep, and symbol displayed on the hierarchical structure screen Rhd is specifically explained hereinafter.

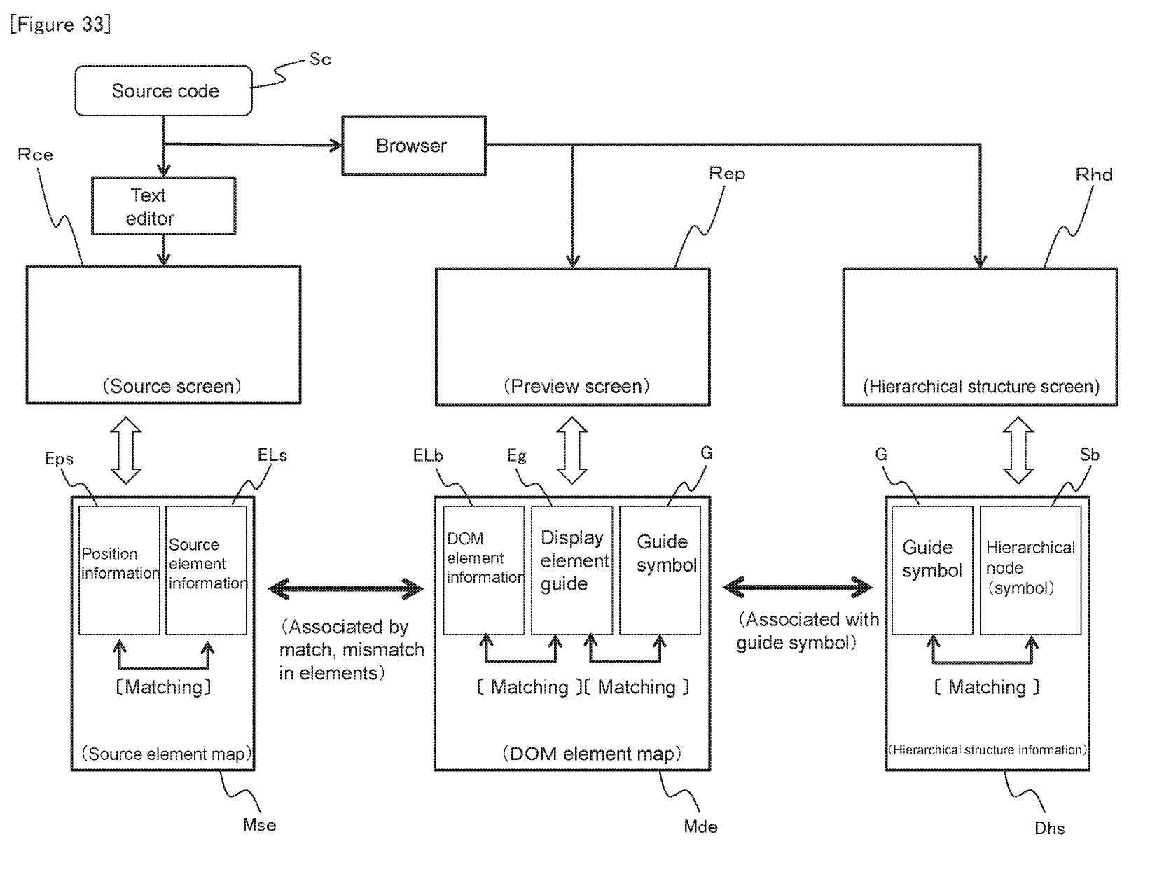

FIGS. 33 to 36 are diagrams for explaining such a mechanism.

For association between the screens, a source element map Mse, a DOM element map Mde, and hierarchical structure information Dhs are used. These maps are stored in the memory 22.

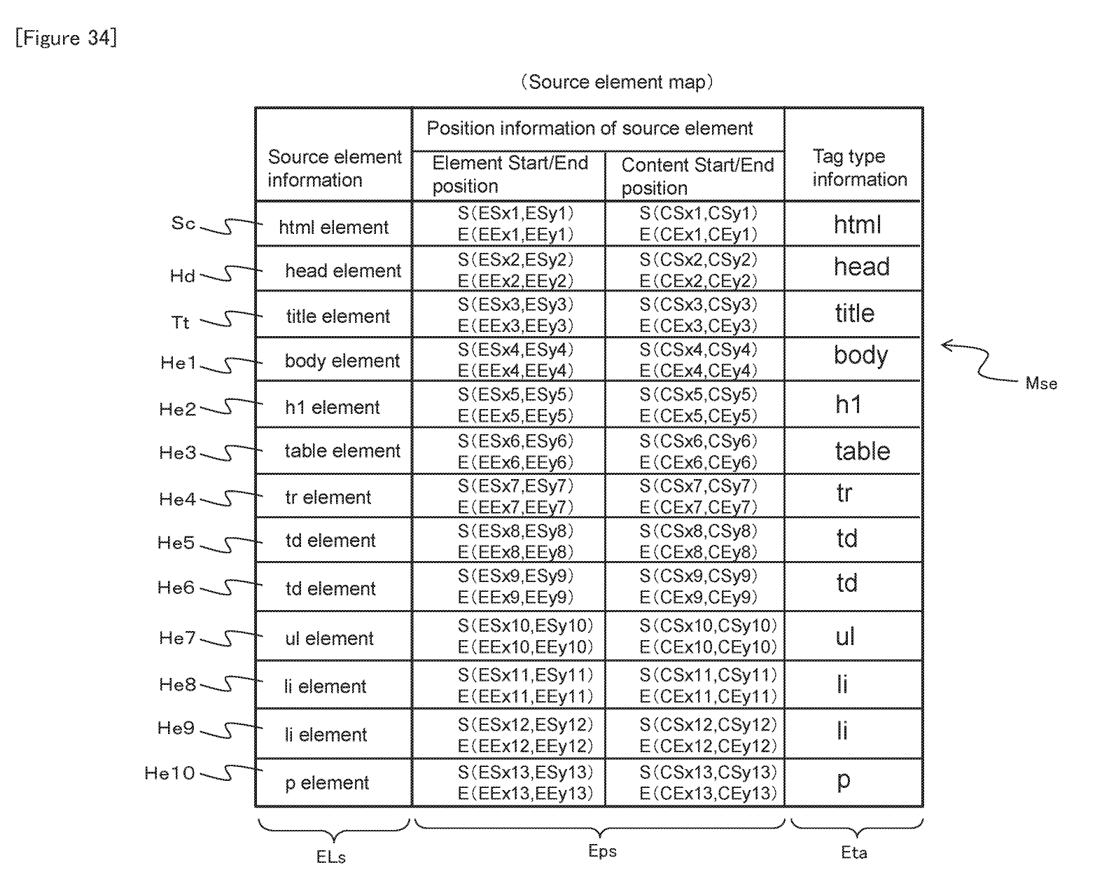

The source element map Mse shown in FIG. 34 is created based on at least the source code Sc that has been input into a text editor. The map comprises source element information ELs showing one or more HTML elements (source elements) contained in the source code Sc and position information Eps showing the position of each source element on the source screen Rce. Such a source element map Mse is updated so that the source element information ELs, position information Eps of the source element, and tag type information Eta correspond with the latest source code being edited when a source code is input into a text editor. In this regard, a source code from a text editor can be read on a periodic cycle or when a source code being edited changes.

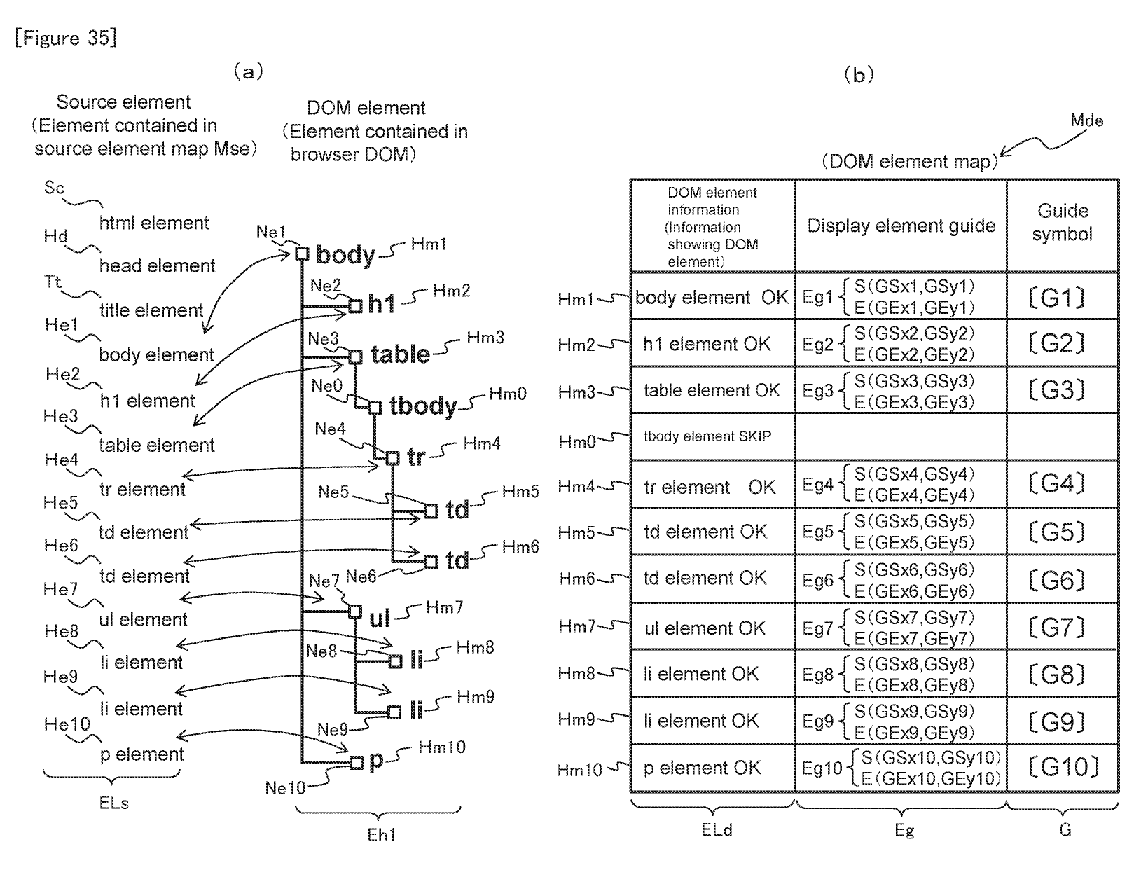

The DOM element map Mde shown in FIG. 35(b) is created based on the source element map Mse and browser DOM. The browser DOM is a hierarchical structure Eh1 of an HTML element generated by a browser reading a source code.

The DOM element map Mde comprises information (DOM element information) ELd showing one or more HTML elements (DOM elements) generated by a browser reading a source code, a display element guide Eg created for each DOM element, and a guide symbol G assigned to each display element guide Eg. DOM elements Hm0 to Hm10, display element guides Eg1 to Eg10, and guide symbols [G1] to [G10] correspond to one another.

In this regard, the DOM element information ELd shows the HTML elements Hm1 to Hm10 recognized when a browser reads the source code Sc and HTML element Hm0 generated by a browser dependent function. A display element guide Eg is a rectangular frame set for each content when a browser displays content on the preview screen Rep. The display element guide Eg has position information showing, for example, the positions of the top left corner and bottom right corner of the rectangular frame. Guide symbol G is an identifier for the display element guide Eg.

Such a DOM element map Mde is updated so that the latest source code being edited corresponds to the DOM element information ELd, display element guide Eg, and guide symbol G by a browser reading a source code. In this regard, a source code can be read by a browser on a periodic cycle, or when the source code being edited changes.

The hierarchical structure information Dhs shows the hierarchical structure Eh of an HTML in the body portion of the source code Sc with a symbol corresponding to each hierarchical node, wherein the hierarchical structure (browser DOM) Eh1 of an HTML element generated by a browser reading a source code is corrected based on a comparison of a DOM element with a source element. In the hierarchical structure information Dhs, the guide symbol G assigned to the display element guide Eg is matched with the symbol Sb representing a hierarchical node Nd of the hierarchical structure Eh. Such hierarchical structure information Dhs is updated so that the relationship between the guide symbol G and the symbol Sb representing the hierarchical structure Eh of an HTML element in the body portion of the source code Sc matches the latest source code being edited by a browser reading a source code.

The source element map Mse, DOM element map Mde, and hierarchical structure information Dhs are discussed in more detail hereinafter.

FIG. 34 is a diagram for explaining the source element map Mse.

The source element map Mse is a map where features of HTML elements that can be obtained from the source code Sc are stored on the memory 22 in a table format.

The source element map Mse contains the source element information ELs. The source element information ELs shows one or more HTML elements (source elements) contained in the source code Sc obtained by analysis of the source code Sc as shown in FIG. 34. In this regard, one or more source elements shown by the source code element information ELs are specifically the html element (source code itself) Sc, head element Hd, title element Tt contained in the head element Hd, body element He1, h1 element He2 contained in the body element He1, table element He3, tr element He4, td element He5, td element He6, ul element He7, li element He8, li element He9, and p element He10. Position information Eps of a resource element and tag type information Eta indicating the type of tag contained in source elements are recorded with being matched with each source element in a region assigned to the source element map Mse on the memory 22 in a table format.

In this regard, the position information Eps of source elements comprises information showing the start position and end position of each of the source elements Sc, Hd, Tt, and He1 to He10 (element start/end positions) and information indicating the start and end positions of a content of a source element (content start/end position). For the element start/end positions of the source elements Sc, Hd, Tt, and He1 to He10, the first positions S(ESx1, ESy1) to S(ESx13, ESy13) and the last positions of source elements E(EEx1, EEy1) to E(EEx13, EEy13)) of the source elements can be used. For the content start/end positions of the source elements Sc, Hd, Pt, and He1 to He10, the first positions (S(CSx1, CSy1) to S(CSx13, CSy13)) and last positions E(CEx1, CEy1) to E(CEx13, CEy13)) of the content of source elements can be used. Furthermore, tag type information for the source elements Sc, Hd, Pt, and He1 to He10 is indicated by “html”, “head”, “title”, “body”, “h1”, “table”, “tr”, “td”, “td”, “u1”, “li”, “li”, and “p”.

FIG. 35 is a diagram for explaining a DOM element map.

FIG. 35 shows only the source element information ELs in the source element map Mse shown in FIG. 34.

The DOM element map Mde is created based on the source element information ELs of the source element map Mse and the browser DOM (hierarchical structure of HTML elements generated by a browser reading a source code) Eh1 as shown in FIG. 35.

When, for example, the source code Sc displayed on the source screen Rce shown in FIG. 32 is read by a browser, a browser dependent function recognizes a description corresponding to the body portion of the source code Sc as the hierarchical structure Eh1 of the browser DOM shown in FIG. 35(a). In the hierarchical structure Eh1, a hierarchical node Ne1 corresponding to the body element He1 of the source code Sc is used as the root node, and the hierarchical nodes Ne2, Ne3, Ne7, and Ne10 corresponding to the h1 element He2, table element He3, u1 element He7, and p element He10 of the source code Sc are used as child hierarchical nodes of the hierarchical node Ne1. A hierarchical node Ne0 corresponding to the tbody element Hm0 with no corresponding source element in the source code is used as a child hierarchical node of the child hierarchical node Ne3 by a browser dependent function, and a hierarchical node Ne4 corresponding to the tr element He4 of the source code Sc is used as a child hierarchical node of the child hierarchical node Ne0. Hierarchical nodes Ne8 and Ne9 corresponding to the li elements He8 and He9 of the source code Sc are used as child hierarchical nodes of the child hierarchical node Ne7. Furthermore, hierarchical nodes Ne5 and Ne6 corresponding to the td elements He5 and He6 are used as child hierarchical nodes of the child hierarchical node Ne4.

In this regard, the DOM element map Mde shows results of comparing HTML elements (source elements) contained in the source element map Mse with the HTML elements (DOM elements) constituting the hierarchical structure Eh1 of the browser DOM (FIG. 35(a)) for each element corresponding to the nodes Ne0 to Ne10 of the browser DOM.

Specifically, the DOM element map Mde contains individual DOM elements Hm0 to Hm10 shown by the DOM element information ELd. In this regard, a description of “OK” is recorded with the element name for the DOM elements Hm1 to Hm10 matching with the source elements shown by the source element information ELs of the source element map Mse among the DOM elements shown by the DOM element information ELd. A description of “SKIP” is recorded with the element name for the DOM element Hm0 which does not match with the source element ELs of the source element map Mse. Furthermore, the DOM elements Hm1 to Hm10 matching the source elements are assigned with the display element guides Eg1 to Eg10 and the guide symbols [G1] to [G10].

In this regard, the display element guides Eg1 to Eg10 are rectangular frames placed to surround the individual contents Cn1 to Cn10 displayed on the preview screen Rep. The positions of the top left corner (S(GSx1, GSyl) to S(GSx10, GSy10)) of this rectangular frame and the positions of the bottom right corner (E(GEx1, GEy1) to E(CGx10, CGy10)) of the rectangular frame are recorded in advance in the memory 22. The guide symbols [G1] to [G10] are identifiers for the display element guides Eg1 to Eg10.

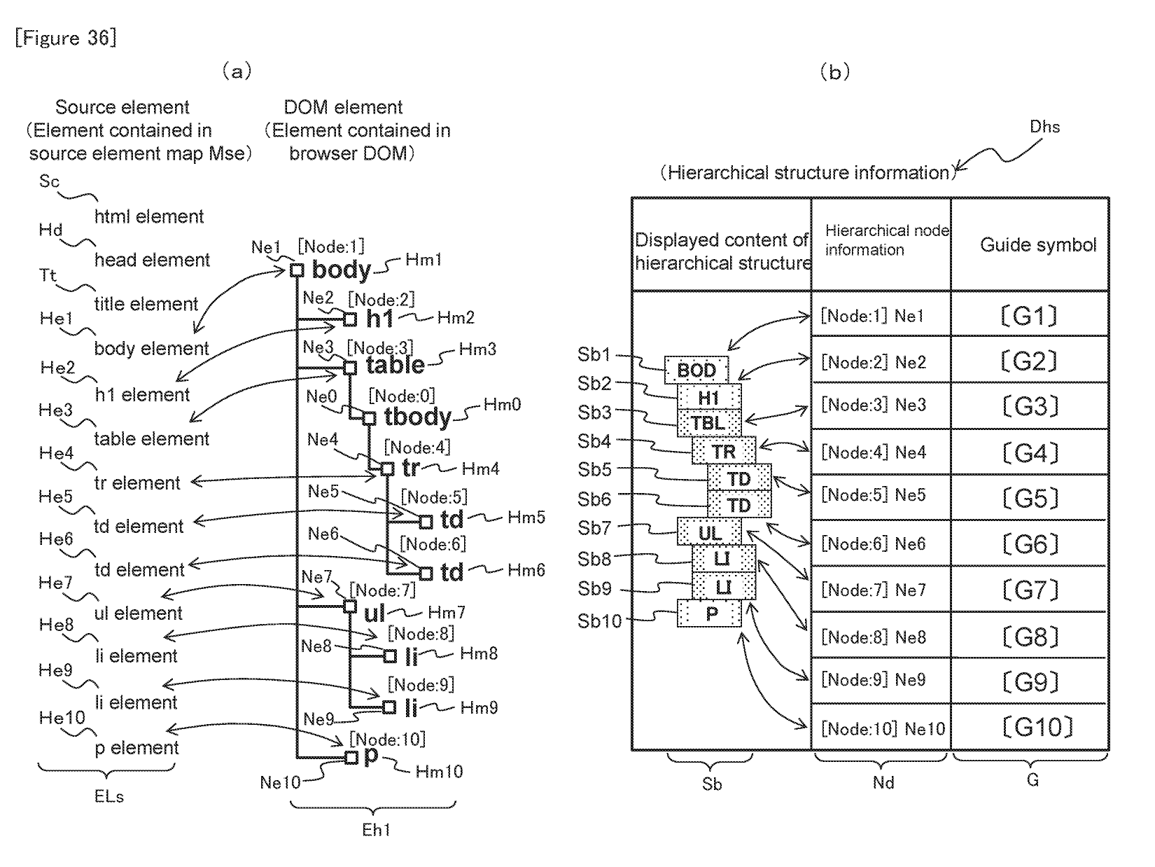

FIG. 36 is a diagram for explaining the hierarchical structure information Dhs.

In the hierarchical structure information Dhs shown in FIG. 36(b), the guide symbols G1 to G10 are matched with the hierarchical nodes Ne1 to Ne10 of the DOM elements Hm1 to Hm10, which match the source elements He1 to He10 of the source element map Mse among the DOM elements Hm0 to Hm10 shown by the DOM element information ELd. Furthermore, the hierarchical nodes Ne1 to Ne10 of the DOM elements Hm1 to Hm10 are assigned the symbols “BOD”, “H1”, “TBL”, “TR”, “TD”, “TD”, “UL”, “Li”, “Li”, and “P” indicating the respective nodes.

Specifically, information indicating the symbols Sb1 to Sb10 and the guide symbols [G1] to [G10] are associated with the nodes [Node: 1] Ne1 to node [Node: 10] Ne10 and stored in a region allotted to hierarchical structure information on the memory 22.

A process of creating the source element map Mse shown in FIG. 34 is explained.

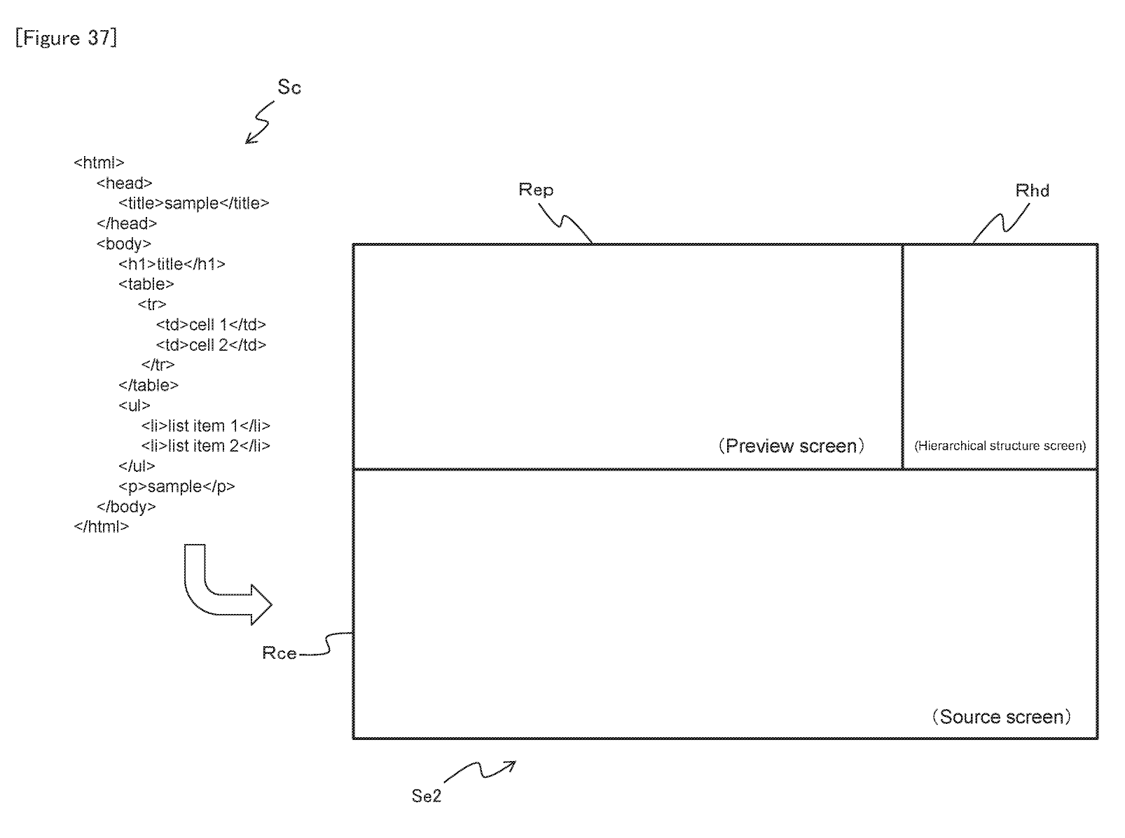

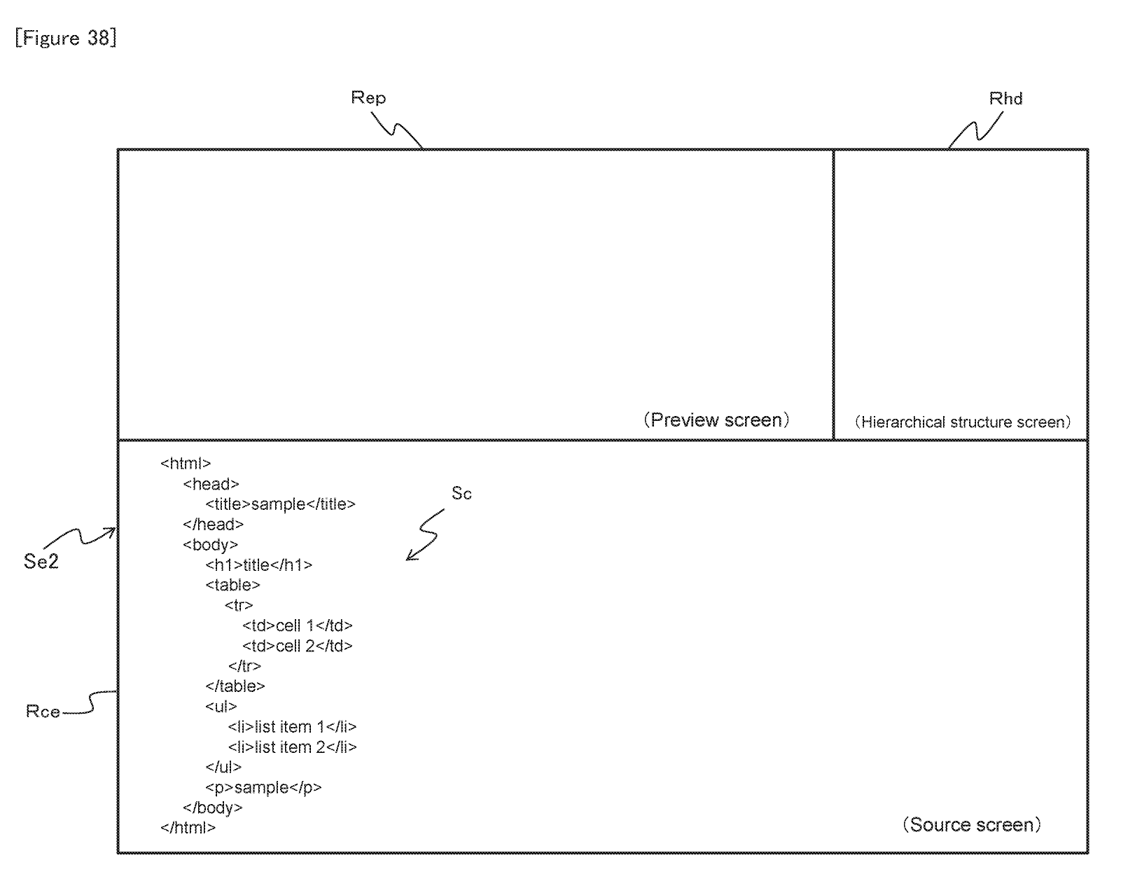

First, when the source code Sc is input into the HP creation assisting device 20 as shown in FIG. 37, the source code Sc is displayed on the source screen Rce as shown in FIG. 38 by a text editor materialized by the processor 11 of the HP creation assisting device 20.

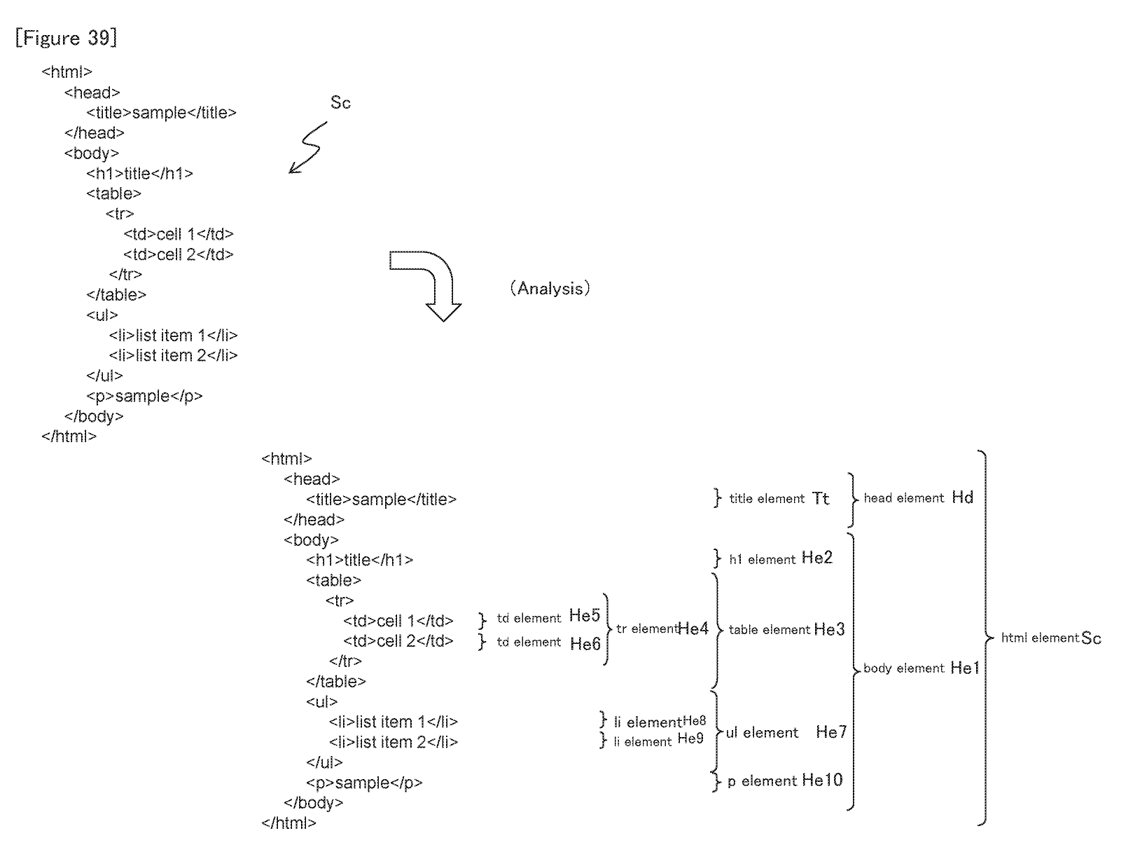

Subsequently, the input source code Sc is analyzed by the processor 11, and the individual HTML elements (source elements) Sc, Hd, Tt, and He1 to He10 in the source code Sc are recognized by the processor 11 as shown in FIG. 39. As a result, a feature of each HTML element that can be obtained from the source code Sc displayed on the source screen Rce is stored on the memory 22 in a table format.

In this regard, the element start/end positions and content start/end positions are matched with the source elements Sc, Hd, Tt, and He1 to He10 and stored as the position information Eps in the storage region of the memory 22 as shown particularly in FIG. 34. The tag type information Eta is also matched with source elements and stored in the storage region of the memory 22.

The source element map Mse matching the latest source code Sc being edited is completed thereby.

Next, a process of creating the DOM element map Mde shown in FIG. 35(b) is explained.

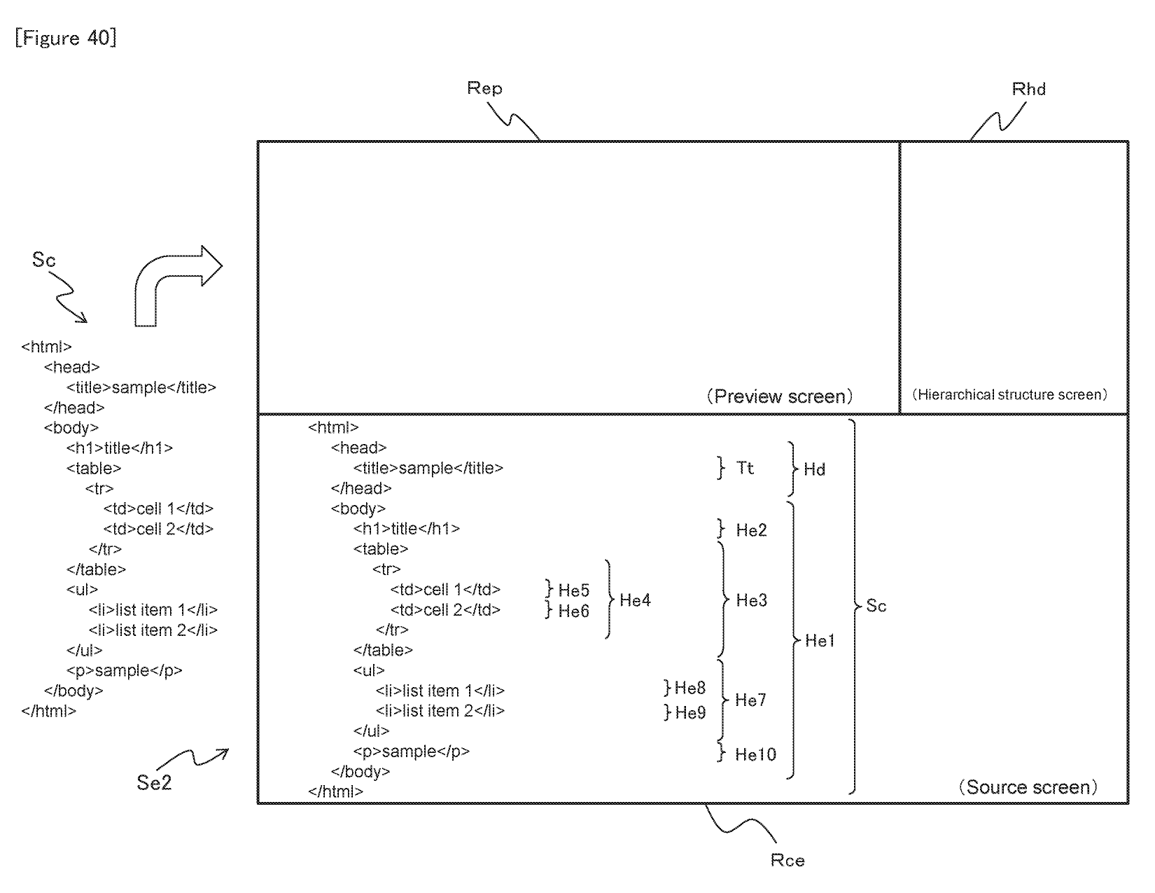

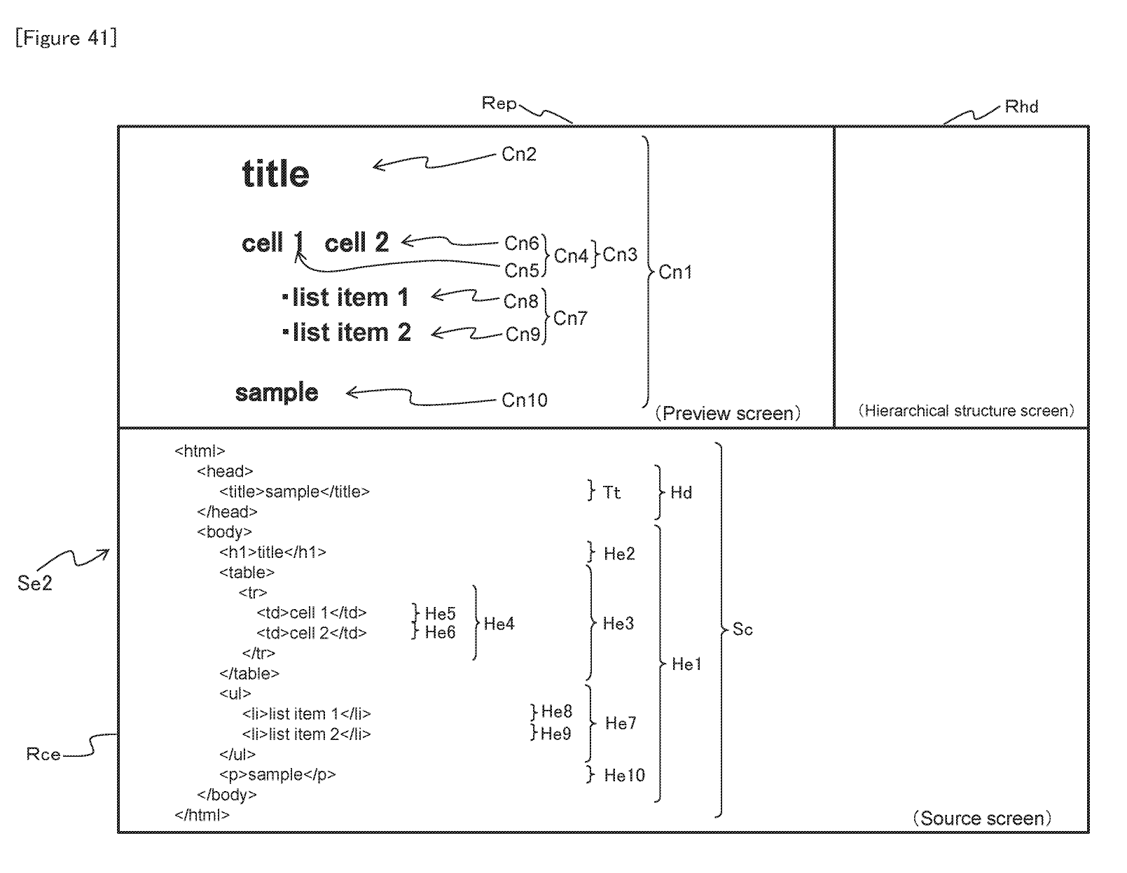

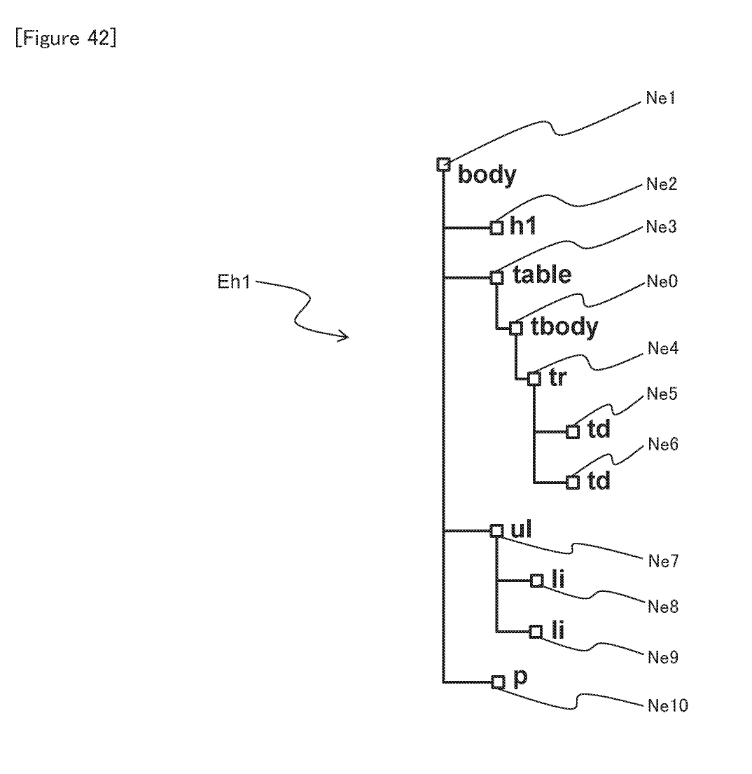

As shown in FIG. 40, when the source code Sc is read by a browser so that contents of the source code Sc are displayed on the preview screen Rep, in the preview screen Rep, the contents (home page contents) Cn1 to Cn10 contained in each element of the source code Sc are displayed as shown in FIG. 41. When the source code Sc is read into a browser in this manner, the browser recognizes the hierarchical structure Eh1 comprising a source element constituting the body portion of the source code Sc as browser DOM by a browser dependent function as shown in FIG. 42.

The hierarchical nodes Ne1 to Ne10 of the hierarchical structure Eh1 are nodes corresponding to the HTML elements He1 to He10 of the body portion of the source code Sc, respectively, while the hierarchical node Ned is an HTML element (tbody element) formed in a browser dependent manner, so that the node does not correspond to an element contained in the source code Sc.

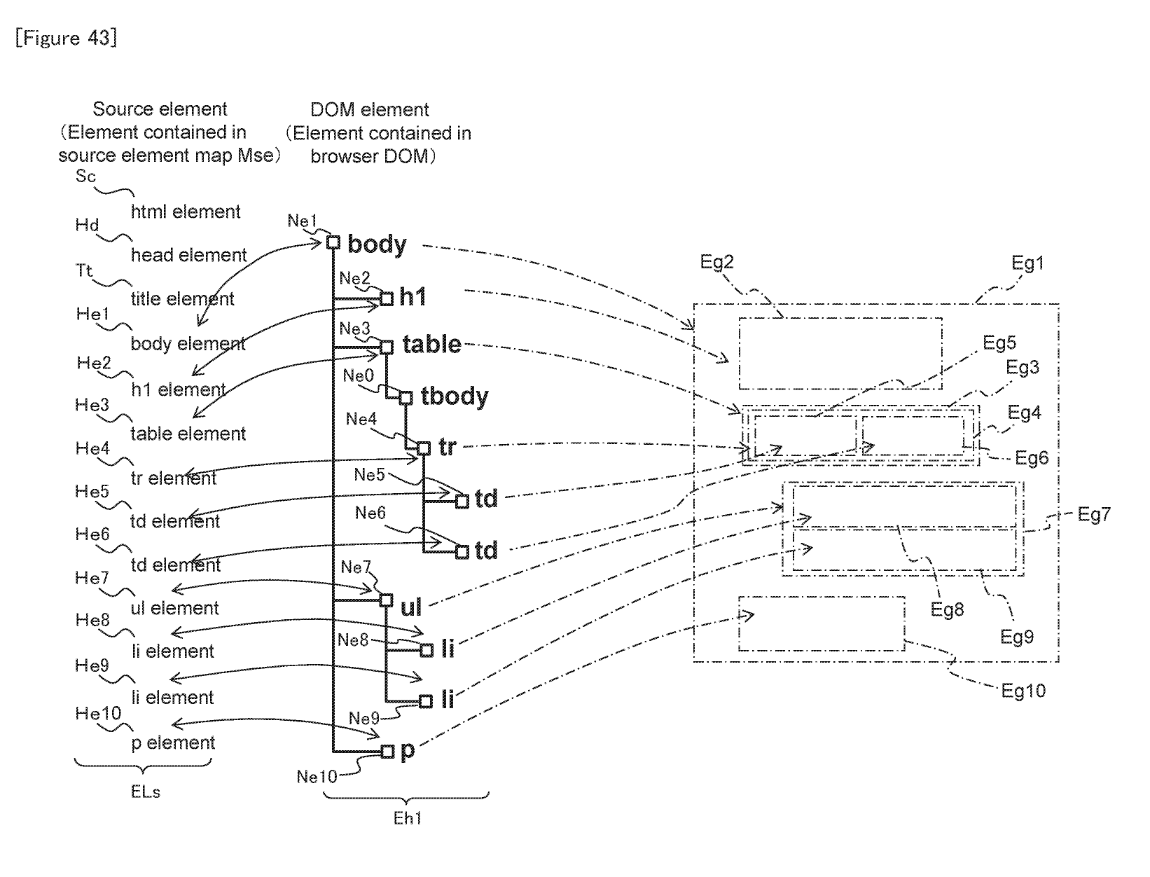

Next, as shown in FIG. 43, the display element guides Eg1 to Eg10 are created for the DOM elements Hm1 to Hm10 matching the source element, based on results of comparing the HTML elements contained in the source element map Mse (FIG. 34) with HTML elements corresponding to each of the hierarchical nodes Ned to Ne10 of browser DOM.

FIG. 43 omits the position information Eps in the source element map Mse. The display element guides Eg1 to Eg10 are rectangular frames placed on the preview screen Rep so as to surround contents corresponding to individual HTML elements displayed on the preview screen Rep.

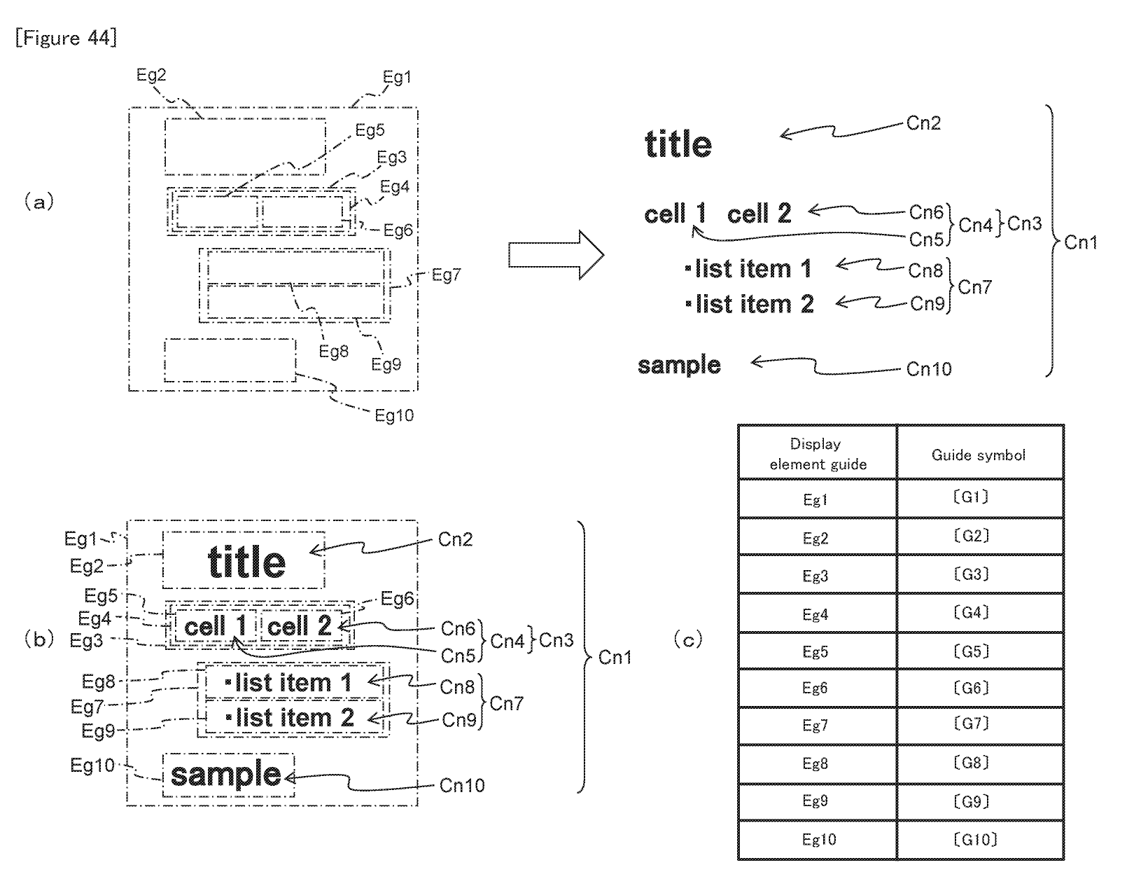

Furthermore, the display element guides Eg1 to Eg10 are applied to the contents Cn1 to Cn10 of individual HTML elements displayed on the preview screen Rep as shown in FIG. 44(a), resulting in the display element guides Eg1 to Eg10 being displayed on the preview screen Rep such that the display element guides Eg1 to Eg10 surround the contents Cn1 to Cn10 of DOM constituent element as shown in FIG. 44(b).

These display element guides Eg1 to Eg10 are further assigned the guide symbols [G1] to [G10] as shown in FIG. 44(c).

The DOM element map Mde (see FIG. 35) is thereby obtained, with the display element guides Eg1 to Eg10 and the guide symbols [G1] to [G10] matched to the HTML elements Hm1 to Hm10 corresponding to each hierarchical node of the hierarchical structure Eh1 of browser DOM, as a DOM element map corresponding to the latest source code Sc during editing of the source code.

A process of creating the hierarchical structure information Eh shown in FIG. 36 is now explained.

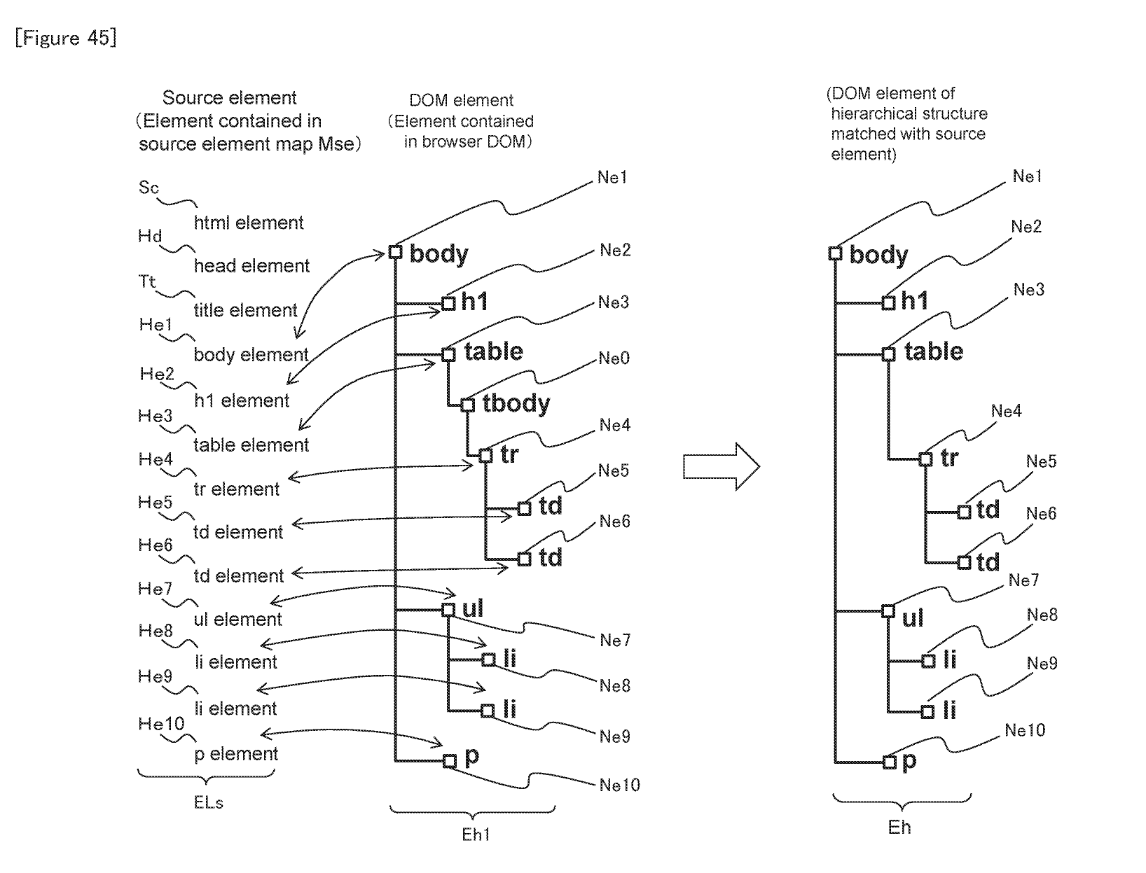

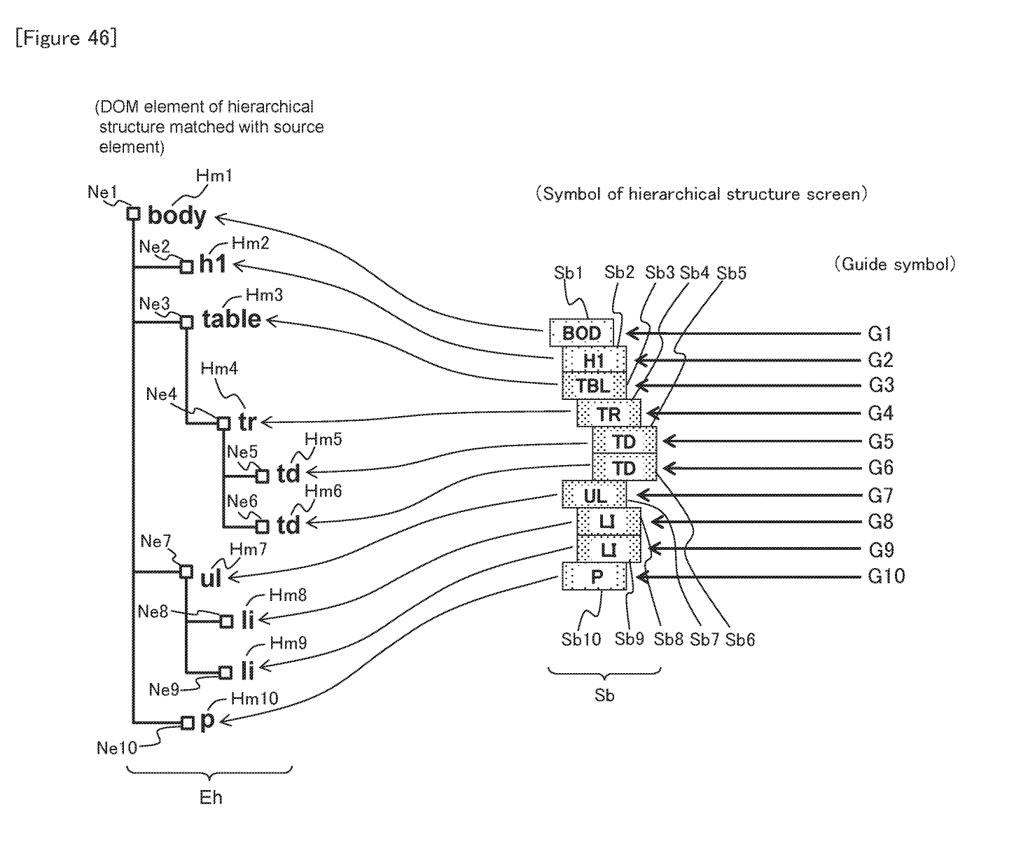

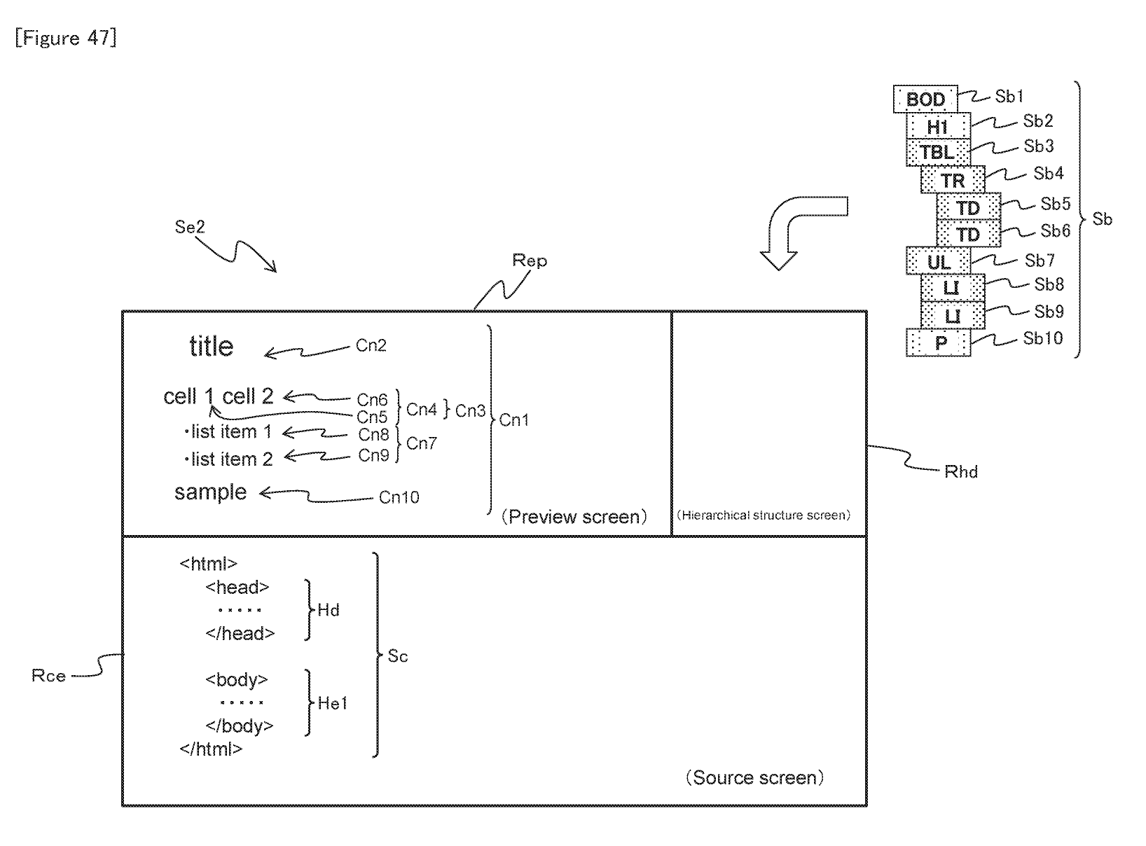

As shown in FIG. 45, the hierarchical structure Eh matching the source elements He1 to He10 is created as a hierarchical structure to be displayed on the hierarchical structure screen Rhd by excluding hierarchical nodes that do not correspond to a source element from hierarchical nodes in the hierarchical structure Eh1 of the browser DOM based on a comparison of elements (DOM elements) corresponding to each hierarchical node of the hierarchical structure Eh1 of the browser DOM with HTML elements (source elements) contained in the source element map Mse. The symbols Sb1 to Sb10 corresponding to the hierarchical nodes Ne1 to Ne10 of the hierarchical structure Eh are further created as shown in FIG. 46. Furthermore, as shown in FIG. 46, the guide symbols [G1] to [G10] are assigned to the symbols Sb1 to Sb10 so that the relationship between the guide symbols [G1] to [G10] and the symbols Sb1 to Sb10 indicating the DOM elements Hm1 to Hm10 of the hierarchical structure Eh matches the relationship between the guide symbols [G1] to [G10] and the DOM elements Hm1 to Hm10 shown in FIG. 35(b). The hierarchical structure information Dhs is thereby obtained. The symbols Sb1 to Sb10 are also displayed on the hierarchical structure screen Rhd so that the hierarchical structure Eh of the source elements He1 to He10 of the body portion of the source code Sc is recognized as shown in FIG. 47.

As a result, the source code Sc is displayed on the source screen Roe, the contents Cn1 to Cn10 of the HTML elements Net to He10 contained in the source code Sc are displayed on the preview screen Rep, and the hierarchical structure Eh of the HTML elements He1 to He10 contained in the source code Sc is displayed on the hierarchical structure screen Rhd, as shown in FIG. 32.

The HP creation assisting operation performed by the HP creation assisting device 20 is now explained.

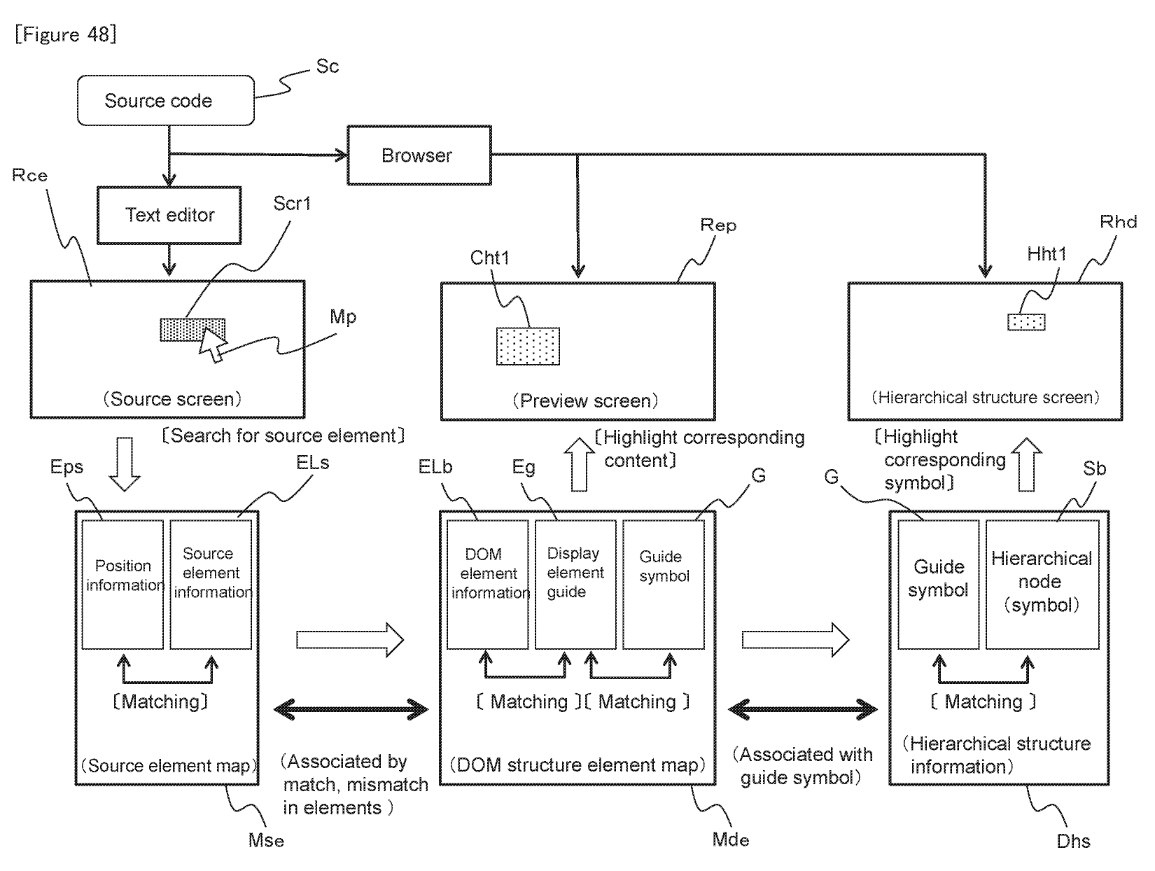

When a user clicks on a position on the source screen Roe with a mouse pointer Mp as shown in FIG. 48, the processor 11 search the position information Eps of the source element map Mse shown in FIG. 34 to recognize that a source element Scr1 at a position corresponding to the clicked position is a source element targeted by the search of the user.

For example, when the h1 element He2 is recognized as the clicked HTML element, the h1 element Hm2 is identified as a DOM element corresponding to the h1 element He2 based on the DOM element map Mde (FIG. 35(b)). This highlights a region Cht1 occupied by the display element guide Eg2 of the DOM element Hm2.

Furthermore, a symbol {H1} Sb2 assigned the same guide symbol as the guide symbol [G2] assigned to the display element guide Eg2 in the DOM element map Mde (FIG. 35(b)) is identified based on the hierarchical structure information Dhs (FIG. 36(b)), and a region Hht1 occupied by the symbol [H1] Sb2 is highlighted.

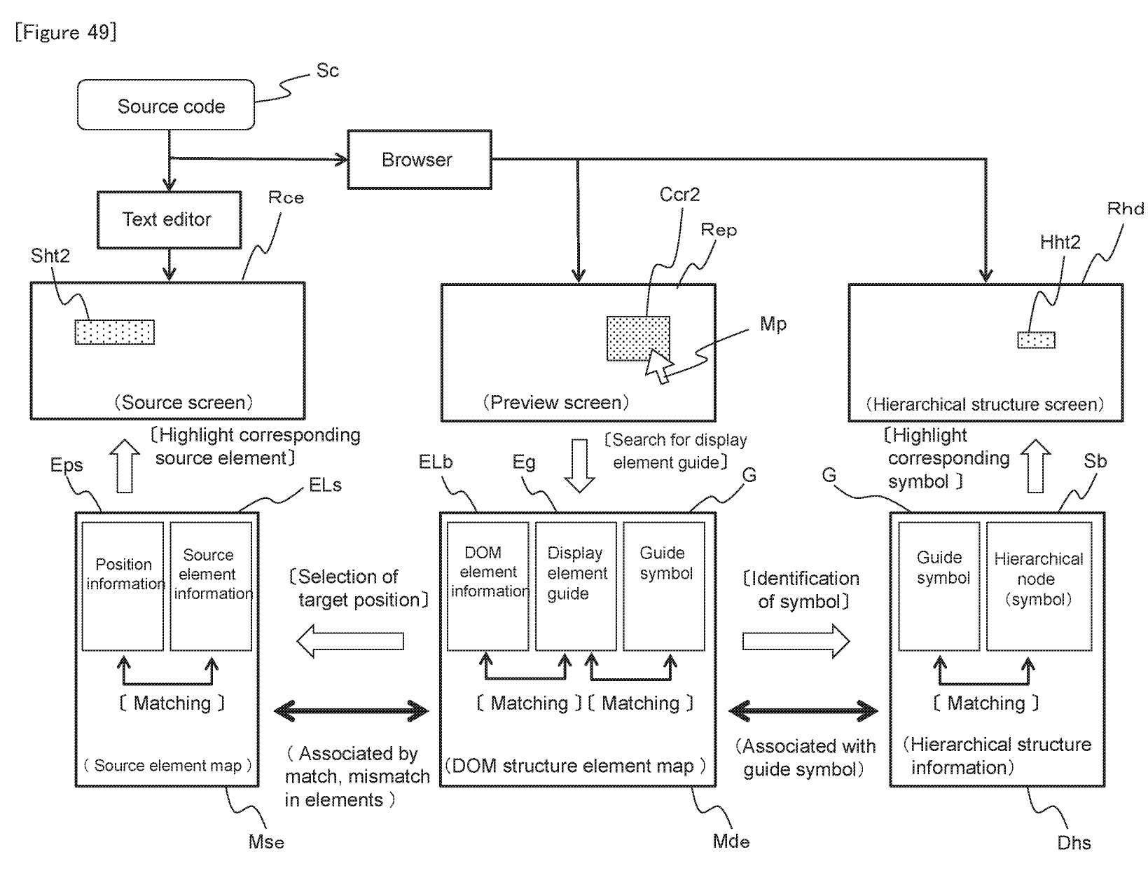

When a user clicks on a region Ccr2 occupied by a display element guide of a content on the preview screen Rep as shown in FIG. 49 with a mouse pointer Mp, a DOM element can be identified based on the DOM element map Mde shown in FIG. 35(b). For example, when a region occupied by the display element guide Eg3 is clicked, the DOM element Hm3 corresponding to the display element guide Eg3 is identified. Furthermore, the source element He3 matching the DOM element Hm3 is obtained based on the source element map Mse (FIG. 34), and a region Sht2 corresponding to the source element He3 is highlighted as shown in FIG. 49. A symbol [TBL] Sb3 assigned with the same guide symbol as the guide symbol [G3] assigned to the display element guide Eg3 in the DOM element map Mde is identified based on the hierarchical structure information Dhs, and a region Hht2 occupied by the symbol [TBL] Sb3 is highlighted.

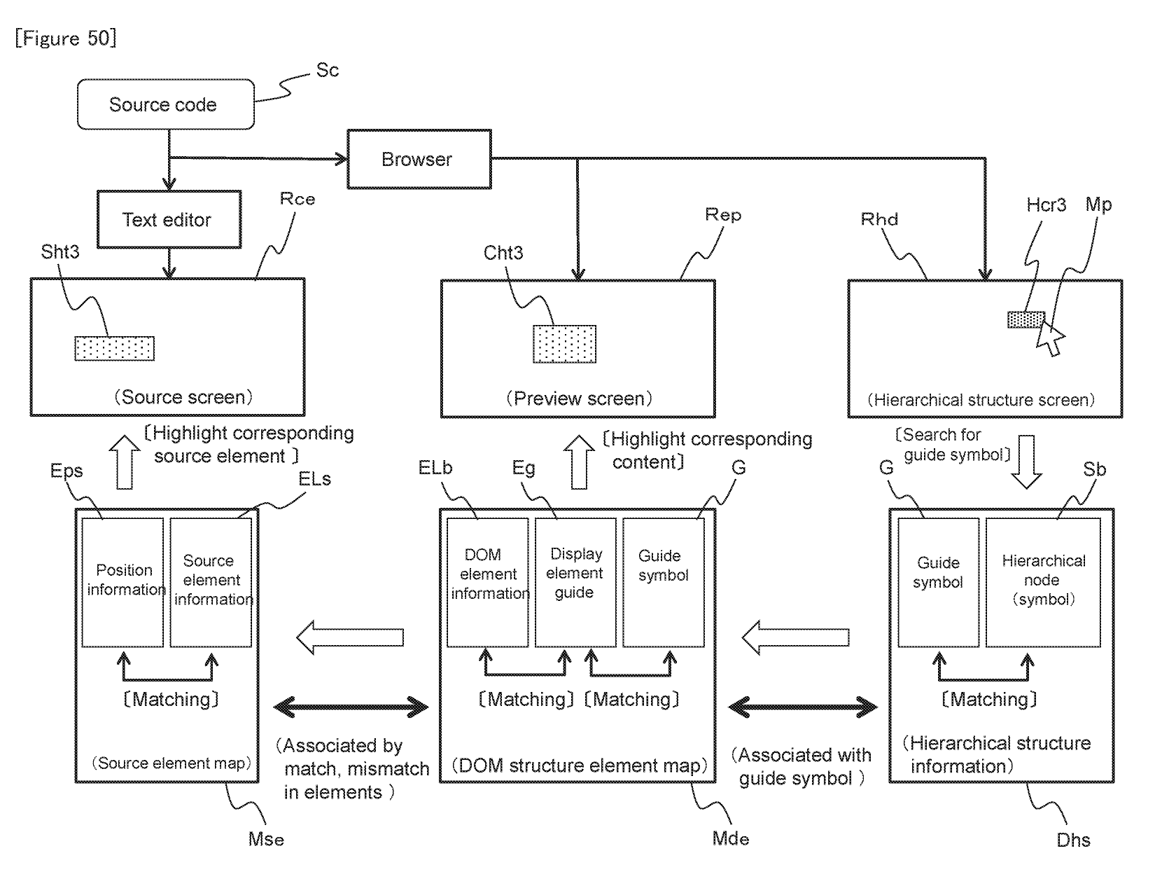

When a user clicks with a mouse pointer Mp on a region Hcr3 where one symbol constituting a hierarchical structure on the hierarchical structure screen Rhd is placed as shown in FIG. 50, a guide symbol corresponding to a symbol of the clicked region is identified based on the hierarchical structure information Dhs shown in FIG. 36(b). For example, when the placement region Hcr3 for the top symbol [TD] of the two symbols [TD] aligned to the top and bottom is clicked with the mouse pointer Mp, a guide symbol [G5] corresponding to the symbol [TD] Sb5 is identified. Furthermore, the display element guide Eg5 corresponding to the guide symbol [G5] is selected based on the DOM element map Mde (FIG. 35(b)), and a region Cht3 occupied by the display element guide Eg5 is highlighted as shown in FIG. 50. In this case, a region Sht3 corresponding to the source element Hey matching the element Hm5 of the DOM element is highlighted as shown in FIG. 50.

In this manner, in the HP creation assisting device 20 of embodiment 2, when a user clicks on any content on the preview screen Rep or clicks on a region corresponding to any HTML element on the source screen Rce or the hierarchical structure screen Rhd, the clicked content or a portion corresponding to a clicked element is highlighted on the screens other than the clicked screen. For this reason, for example, by a user simply clicking a specific HTML element displayed on the hierarchical structure screen Rhd, the user can readily find a corresponding HTML element contained in the source code Sc displayed on the source screen Roe and simultaneously find a content corresponding to a symbol clicked on the hierarchical structure screen Rhd on the preview screen Rep.

A case explained in Embodiment 2 is the case where, when a certain position is clicked on the source screen Roe, a region occupied by a display element guide corresponding to an HTML element at the clicked position on the preview screen Rep is highlighted and a region occupied by a symbol corresponding to an HTML element at the clicked position on the hierarchical structure screen Rhd is highlighted, but the display element guides Eg1 to Eg10 and the corresponding symbols Sb1 to Sb10 can be configured to be displayed with the same color so that the relationship between the display element guides Eg1 to Eg10 and the corresponding symbols Sb1 to Sb10 can always be recognized.

A case explained in Embodiment 2 is also the case where a program for assisting the creation of a home page is stored on a user side terminal, but such a program can be stored on a server on the Internet, and the user side terminal can transit an operation signal to the server to create a home page and assist the creation of the home page by a user on the server.

The home page creation process explained in embodiment 2 can be executed, in the same manner as embodiment 1, by a web application which operates by cooperation between a program installed on a web server and a program by a programming language that operates on a browser on the user side terminal instead of a stand-alone application that is operated by a program installed on the user side terminal as in embodiment 2.

In this case, a source code of a completed home page can be stored on the server side or provided to the user side terminal.

A case explained in Embodiment 2 is also the case where the following three first to third processes are performed, but the HP creation assisting device 20 can be configured to perform at least one of the following first to third processes.

The first process is the process where, when one of the contents is selected on the preview screen, a source element corresponding to a selected content is highlighted on the source screen Rce and a symbol corresponding to the selected content is highlighted on the hierarchical structure screen Rhd.

The second process is the process where, when one of the source elements is selected on the source screen Rce, a content corresponding to a selected source element is highlighted on the preview screen Rep and a symbol (hierarchical node) corresponding to the selected source element is highlighted on the hierarchical structure screen Rhd.

The third process is the process where, when one of the symbols is selected on the hierarchical structure screen Rhd, a content corresponding to a selected symbol is highlighted on the preview screen Rep and a source element corresponding to the selected symbol is highlighted on the source screen Roe.

### Embodiment 3

FIG. 51 is a diagram for explaining an HP creation assisting device 30 according to embodiment 3 of the present invention.

The HP creation assisting device 30 of embodiment 3 has a computer 30a for processing information, an input operation unit 13a, and a display unit 14a as in the HP creation assisting device 10 in embodiment 1. The computer 30a comprises a memory 32 instead of the memory 12 of the computer 10a in embodiment 1. A program for making the processor 11 execute a process that is different from that of the HP creation assisting device 10 in embodiment 1 as a process for assisting the creation of a home page is stored in the memory 32.

The configuration of the HP creation assisting device 30 in embodiment 3 is identical to the configuration of the HP creation assisting device 10 in embodiment 1 other than the memory 32 of the computer 30a.

A process of assisting the creation of a home page (hereinafter, the HP creation assisting process) performed by the HP creation assisting device 30 in embodiment 3 is specifically explained hereinafter.

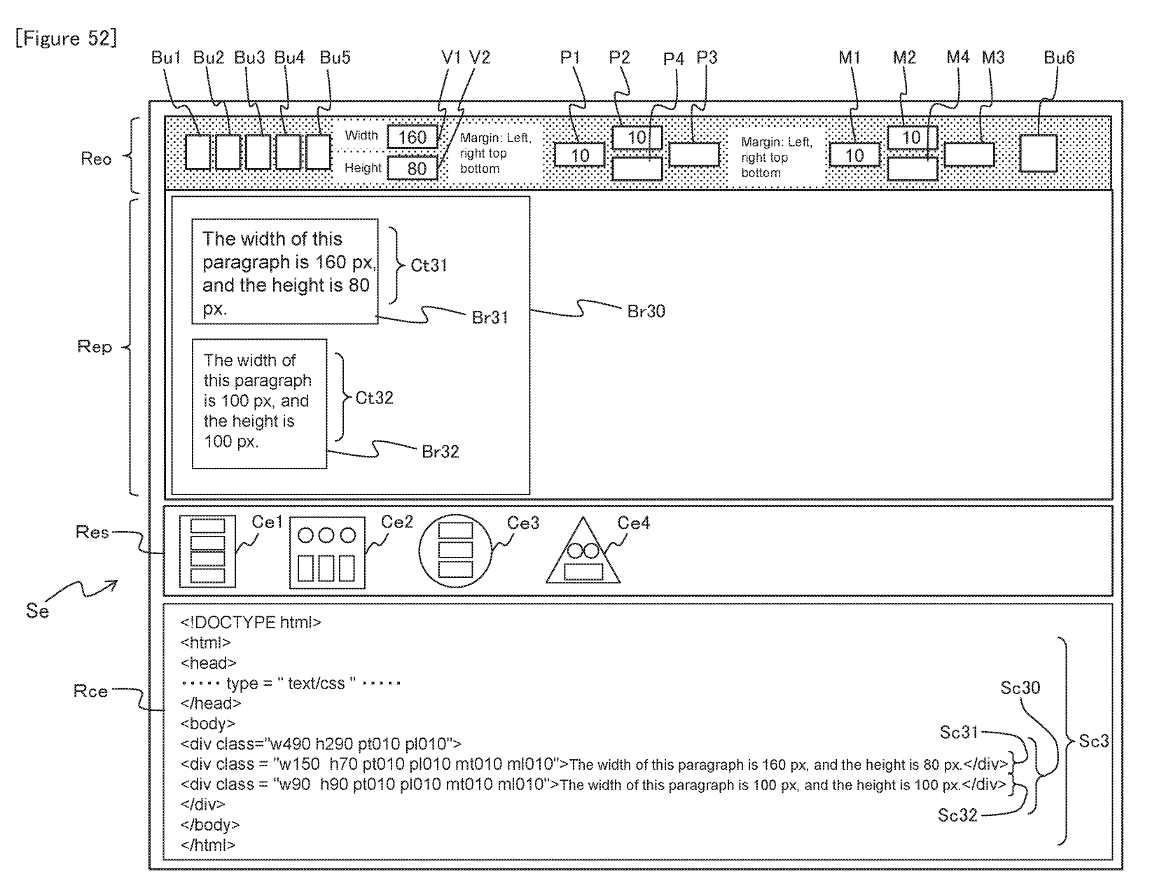

FIG. 52 is a diagram showing an editing screen Se that is displayed on the display unit 14a of the HP creation assisting device 30 in embodiment 3. Elements in FIG. 52 assigned with the same symbol as those in FIG. 15 are identical to those in the editing screen Se of embodiment 1.

The editing mode of a block comprising a block can be switched between a normal editing mode and a batch editing mode in the HP creation assisting process performed by the HP creation assisting device 30 in embodiment 3.

In the following explanation, when at least one block is contained in another block, a block obtained in another block is referred to as a child block, and the another block containing at least one block is referred to as the parent block.

Specifically, an HP creation assisting process performed by the HP creation assisting device 30 in embodiment 3 comprises the following three processes.

The first process is a process where a plurality of blocks for placing contents of a home page are displayed on an editing screen so that at least one block is contained in at least one other block (parent block) based on a user operation.

The second process is a process where the editing mode for a parent block is switched between a normal editing mode and a batch editing mode.

The third process is a process where, when the editing mode of the parent block targeted for editing is in a batch editing mode, individual editing operation for editing each block (child block) contained in a parent block is denied and a batch editing operation for editing the child block with the parent block in a batch is permitted, and when the editing mode of the parent is in a normal editing mode, both individual editing operation and a batch editing operation on the child block are permitted. The following explanation also refers to switching the editing mode to a batch editing mode as locking, and returning the editing mode to a normal editing mode as unlocking,

These processes are performed by the processor 11 executing a program stored on the memory 32. It is also understood that a common operation system for making the processor 11 function as a text editor or as a browser is stored in the memory 32. A program for performing a process of assisting the creation of a home page as in the HP creation assisting device 10 of embodiment 1 can be further stored in the memory 32. In this case, a content can be edited on the preview screen Rep, and a source code corresponding to one or more contents edited on the preview screen Rep would be displayed on the source screen Rae. A program for performing a process of assisting the creation of a home page as in the HP creation assisting device 20 of embodiment 2 can be further stored in the memory 32. In this case, a home page content, corresponding source element, and corresponding hierarchical node (symbol) can be simultaneously associated and displayed on the preview screen Rep, source screen Rae, and the hierarchical structure screen Rhd.

The HP creation assisting device 30 in embodiment 3 does not need to have a function of performing the HP creation assisting process of the HP creation assisting device 10 in embodiment 1, but is assumed hereinafter to have the function of the HP creation assisting device 10 in embodiment 1 for convenience of explanation.

A home page editing process using the HP creation assisting device 30 is explained in detail hereinafter.

For example in the editing screen Se shown in FIG. 52, a large block (same as the block box in embodiment 1) Br30 is created on the preview screen Rep, and two small blocks Br31 and Br32 are placed within the large block Br30, and contents Ct31 and Ct32 are placed within the small blocks Br31 and Br32, respectively. In this regard, the large block is a parent block and the small blocks are child blocks. An operation of placing the child blocks within the parent block is an operation of pressing the creation button Bu1 after selecting the parent block by clicking or the like. By such an operation, a new block is placed within an existing block (parent block) as a child block. In the editing screen Se shown in FIG. 52, the block Br31 is in a selected state.

An HTML element (div element) Sc30 corresponding to the large block Br30 and HTML elements (div elements) Sc31 and Sc32 corresponding to the small blocks Br31 and Br32 are displayed on the source screen Roe. An HTML element Sc3 is an html element corresponding to the entire home page.

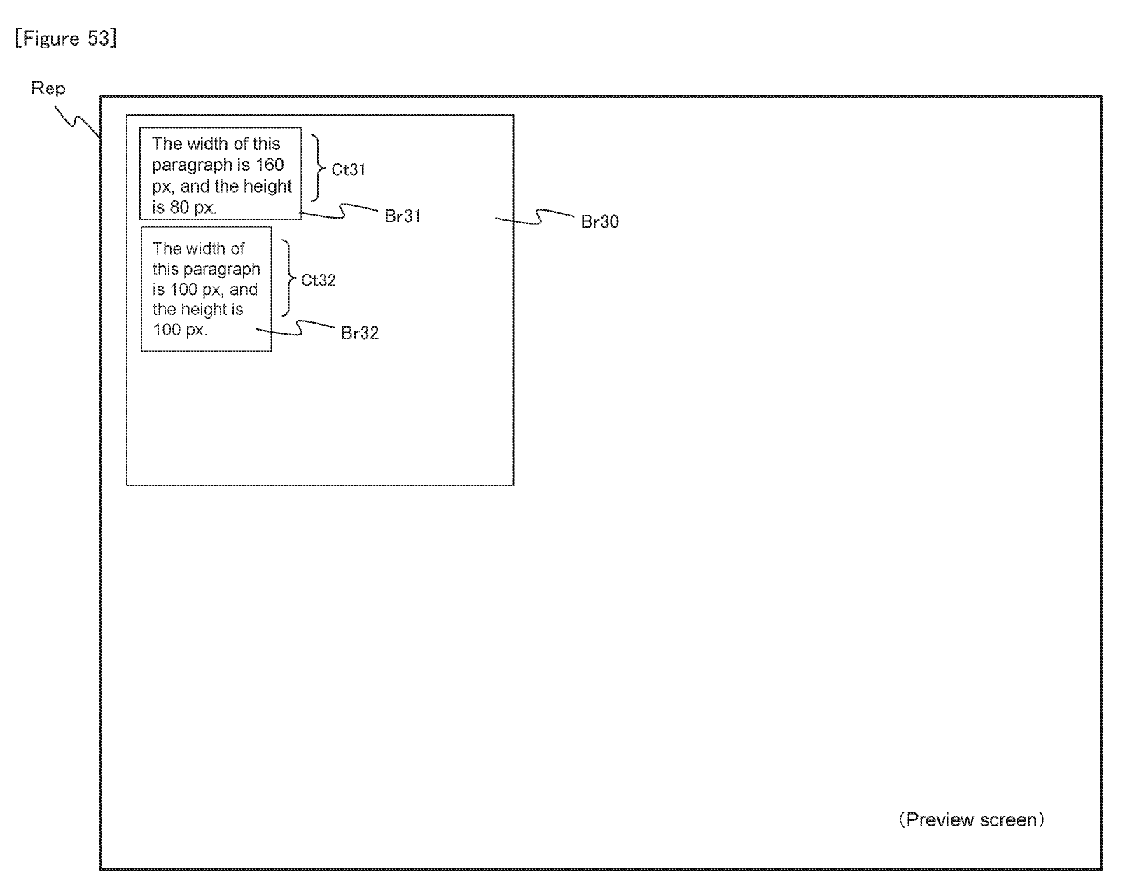

FIG. 53 is a diagram showing only an expanded preview screen Rep on the editing screen Se shown in FIG. 52.

In the editing state shown in FIG. 53, the large block Br30 is not locked, and the editing mode of the block is a normal editing mode, in which individual editing operation (operation such as copy, move, or delete) on the small blocks Br31 and Br32 within the block Br30 is enabled, and a batch editing operation (operation such as copy, move, or delete) for editing the small blocks Br31 and Br32 within the block Br30 with the large block is enabled.

Thus, in the normal editing mode, the outer line indicating the contour of each block displayed on the preview screen Rep is displayed.

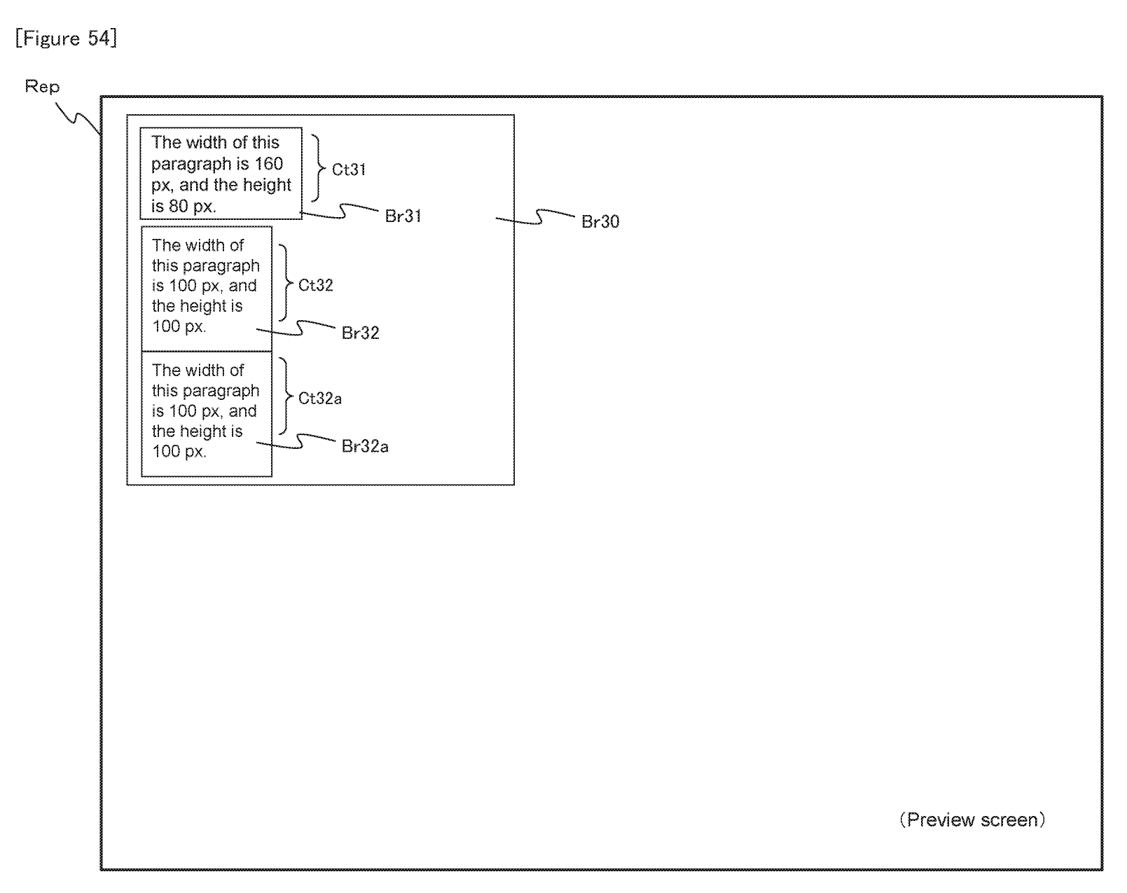

When a user selects for example the small block Br32 within the large block by clicking and then operates for example the copy button Bu3 in this state, the copy operation is reflected in the small block Br32. In other words, the small block Br32 is copied with the content Ct32 therein and the copied block Br32a is placed below the original block Br32 as shown in FIG. 54. The copied block Br32a contains the same content Ct32a as the content Ct32 in the original block Br32.

In a normal editing mode, when a large block is selected and then an operation such as copy is performed, the large block as well as the small block therein are both copied and placed below the original large block.

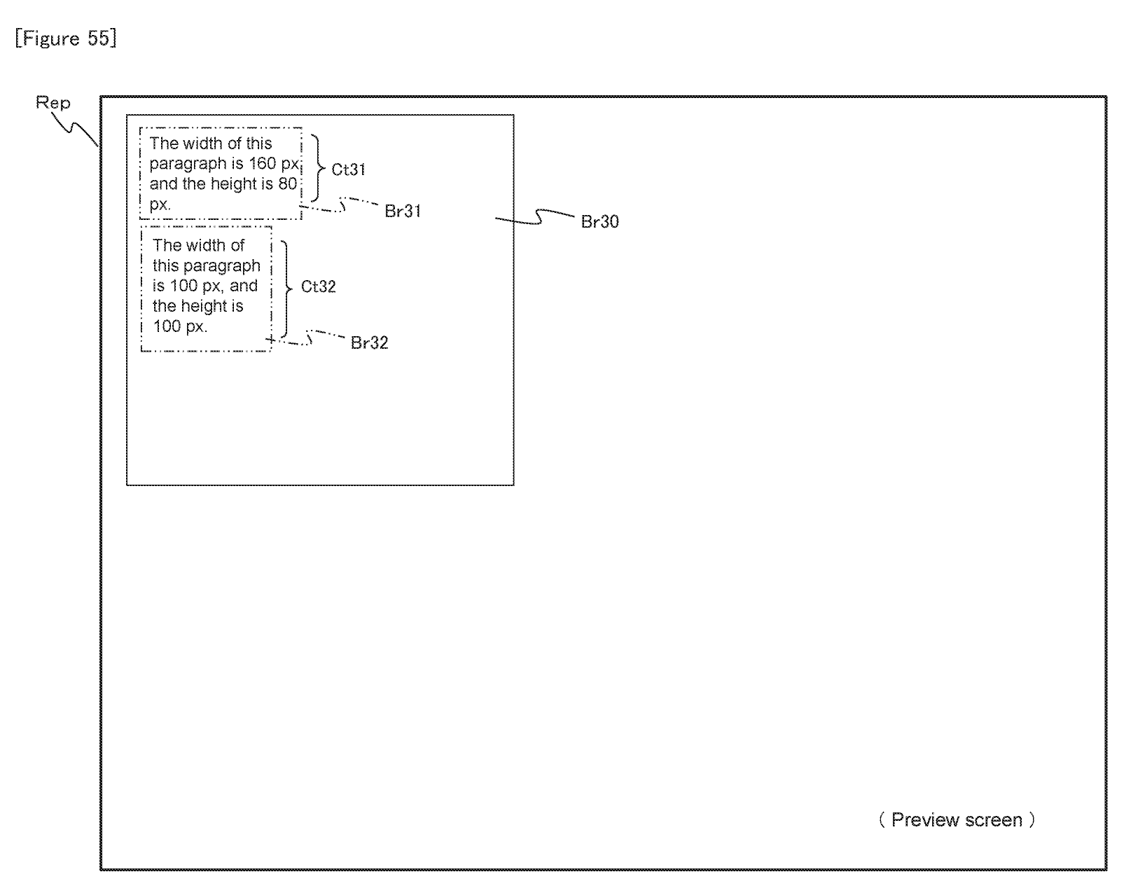

On the other hand, in the editing state shown in FIG. 53, when a user clicks on a region within the large block Br30 and then switches the editing mode of the large block Br30 from a normal editing mode to a batch editing mode by operating the lock button Bu5, the outline of the small blocks Br31 and Br32 placed within the large block Br30 disappears as shown in FIG. 55, denying individual operations on the blocks Br31 and Br32 placed within the large block Br30. FIG. 55 shows the outer line that in actuality disappears as a double dotted chain line for convenience of explanation. Thus, operations on the small blocks Br31 and Br32 are denied in a batch editing mode. The difference on a display screen between a normal editing mode and a batch editing mode is only an example, which is not limited to such a difference in display.

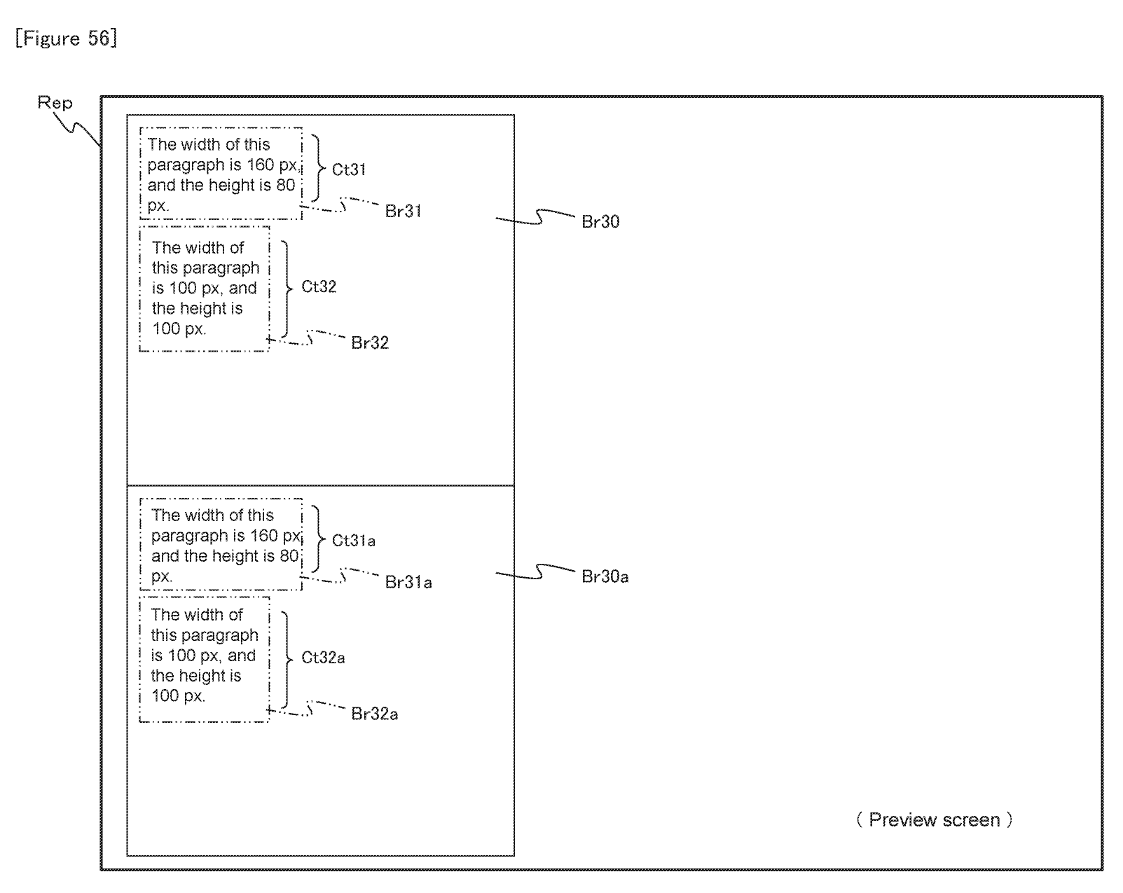

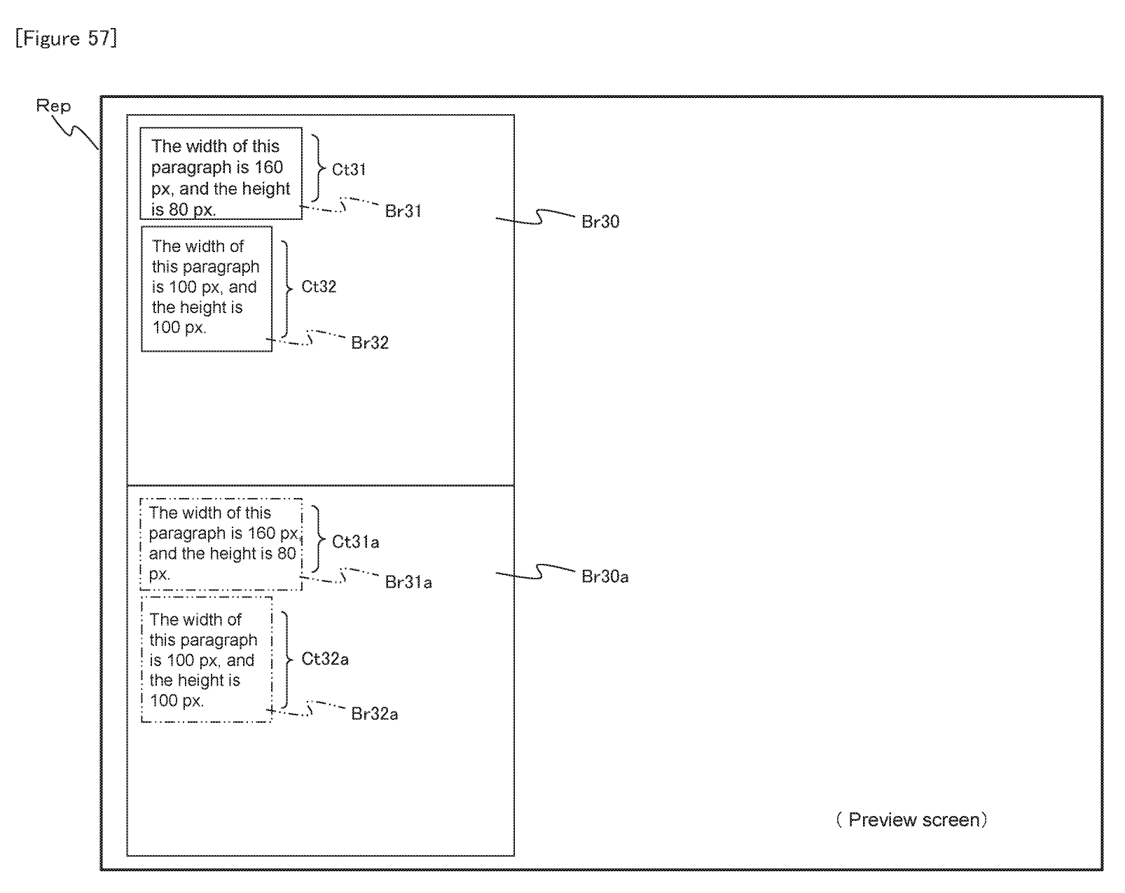

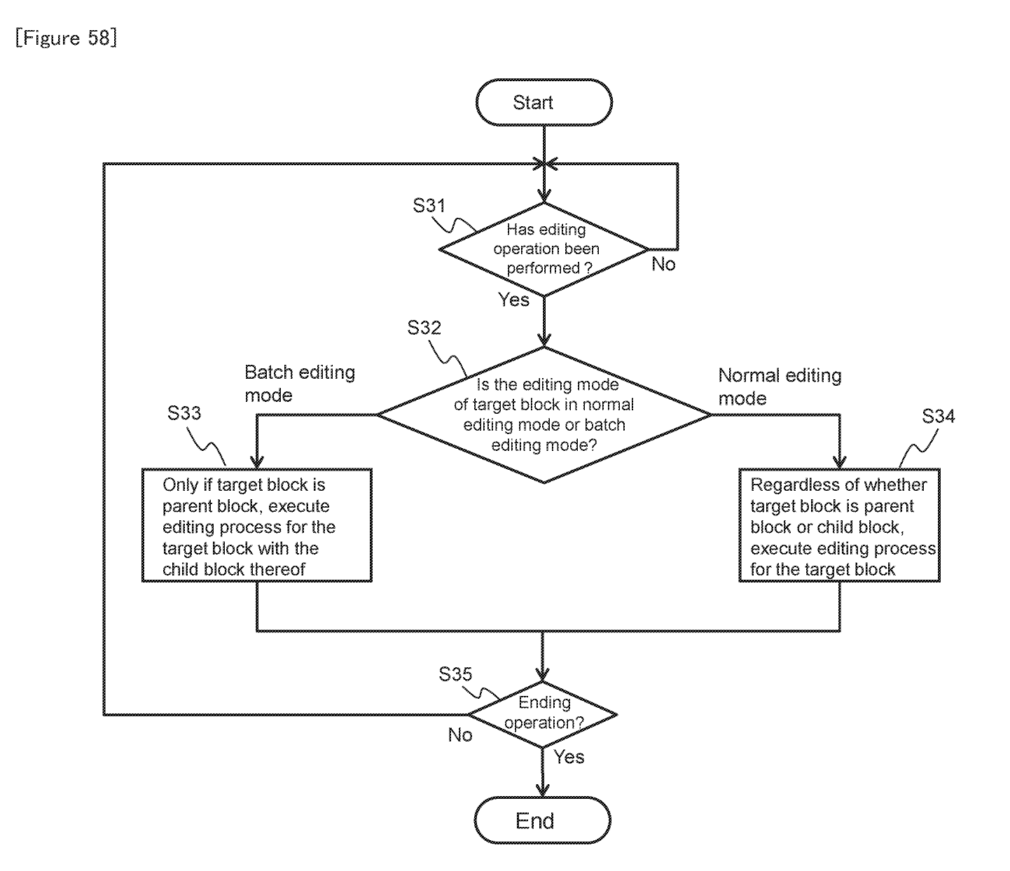

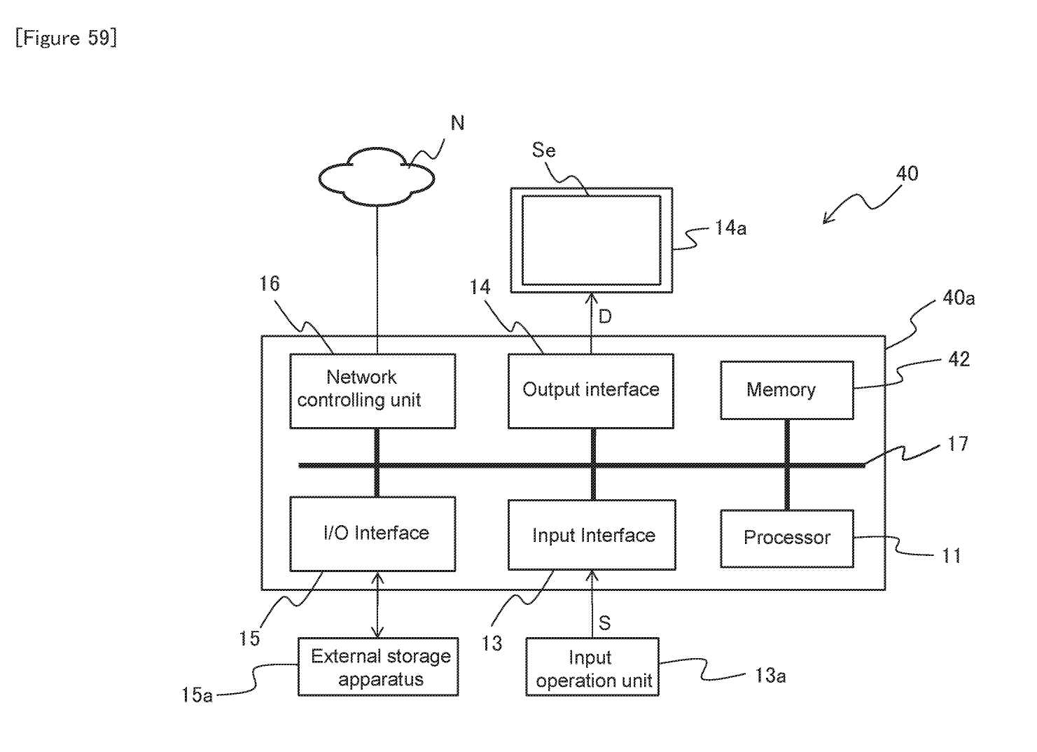

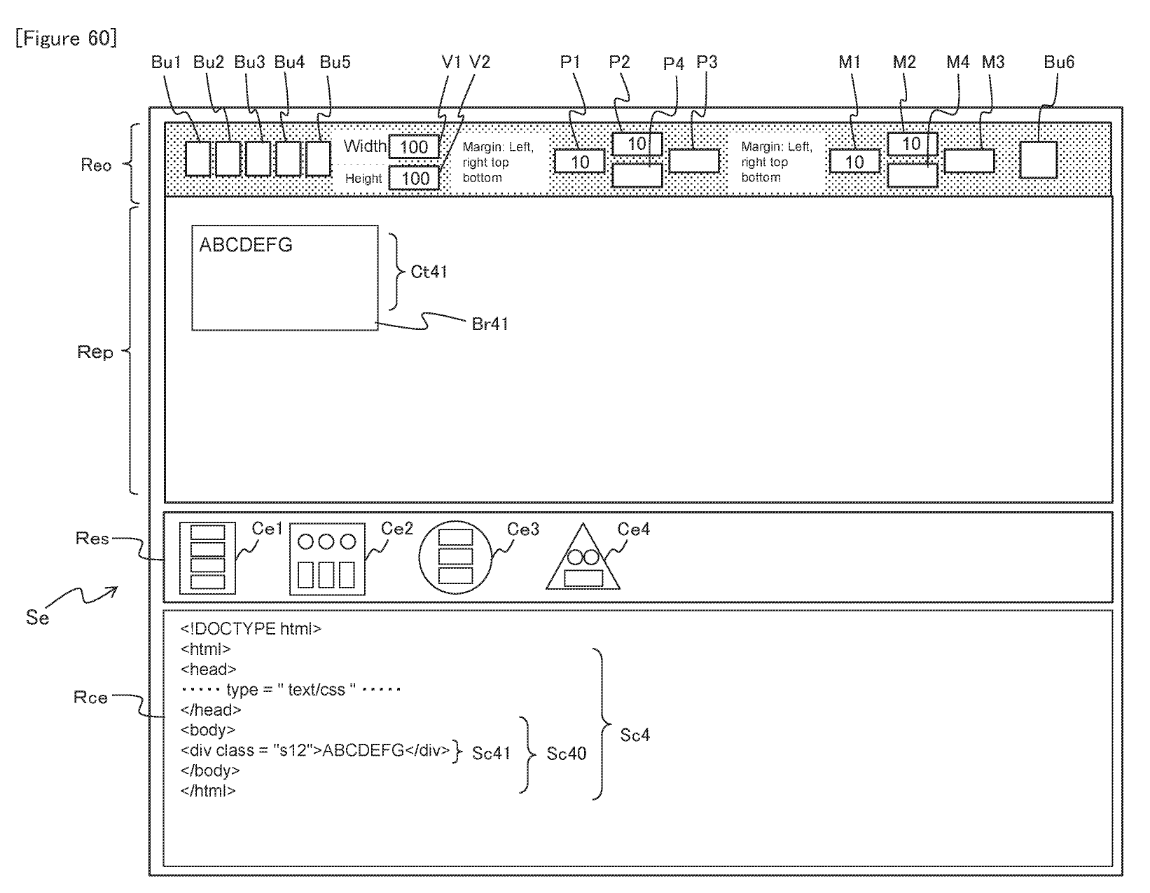

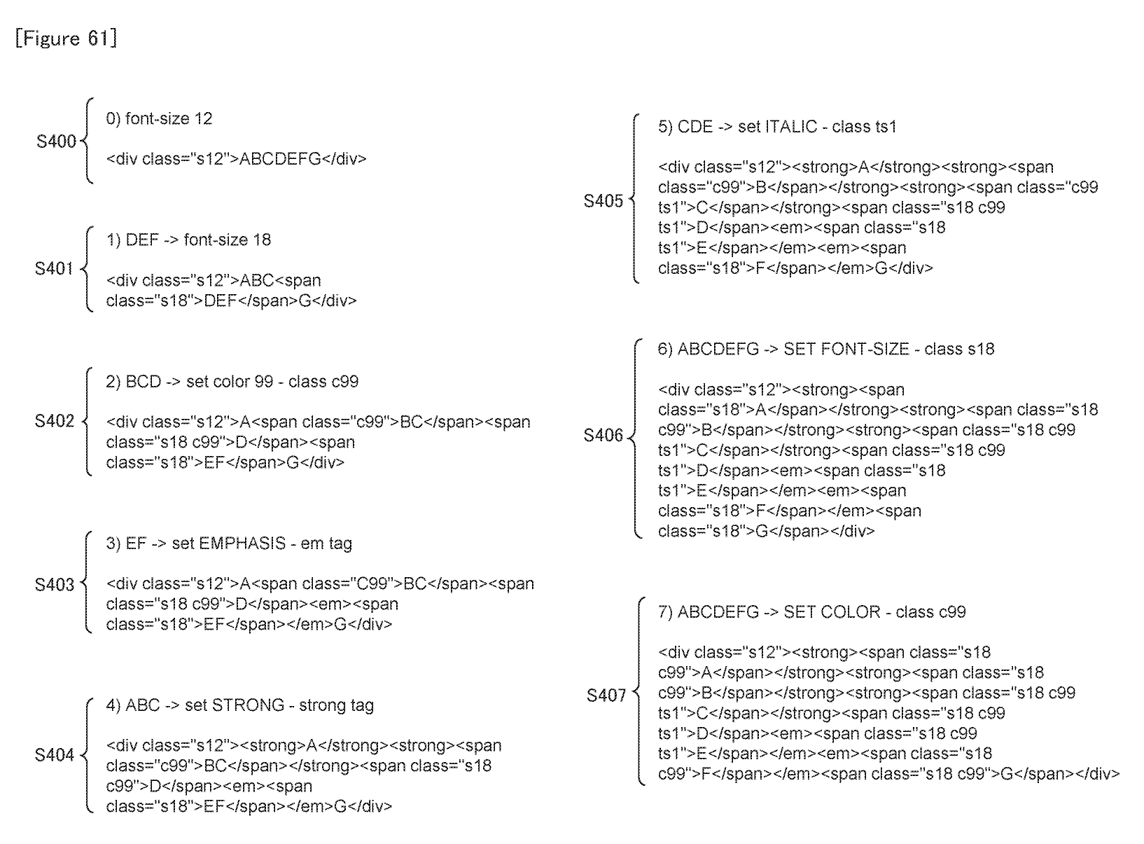

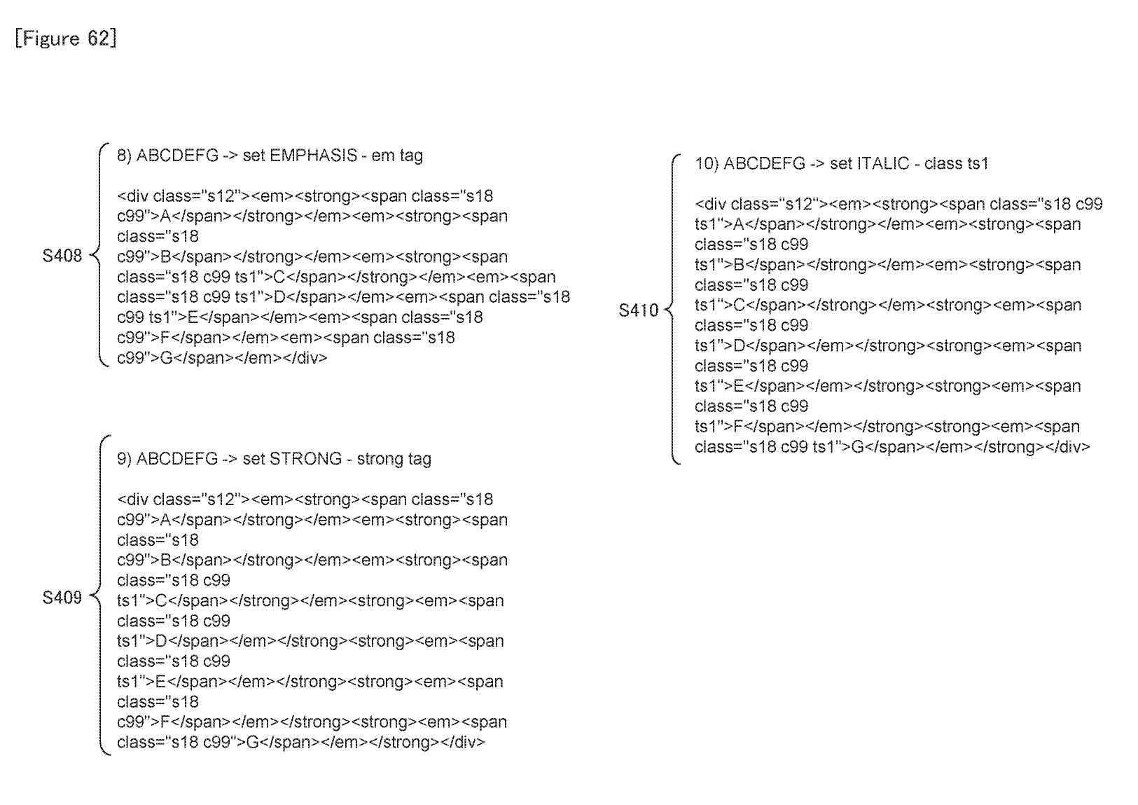

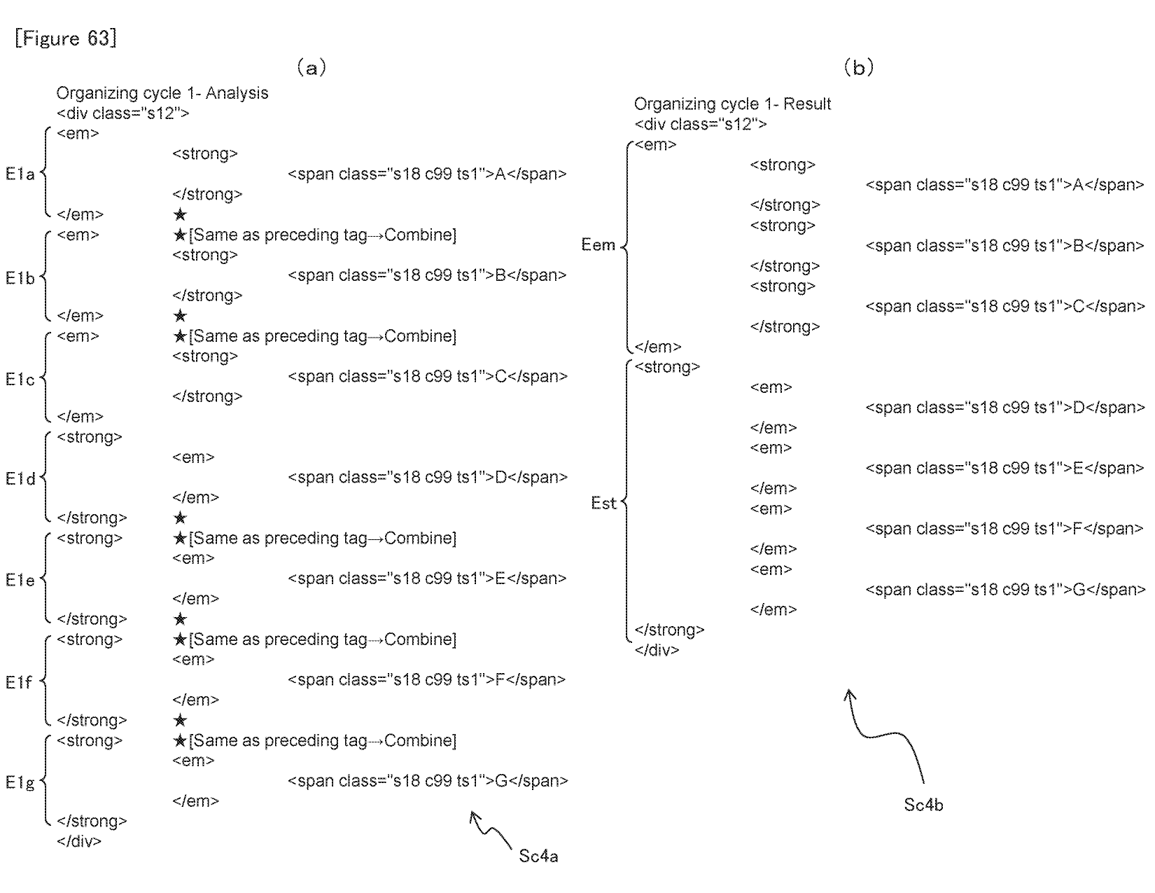

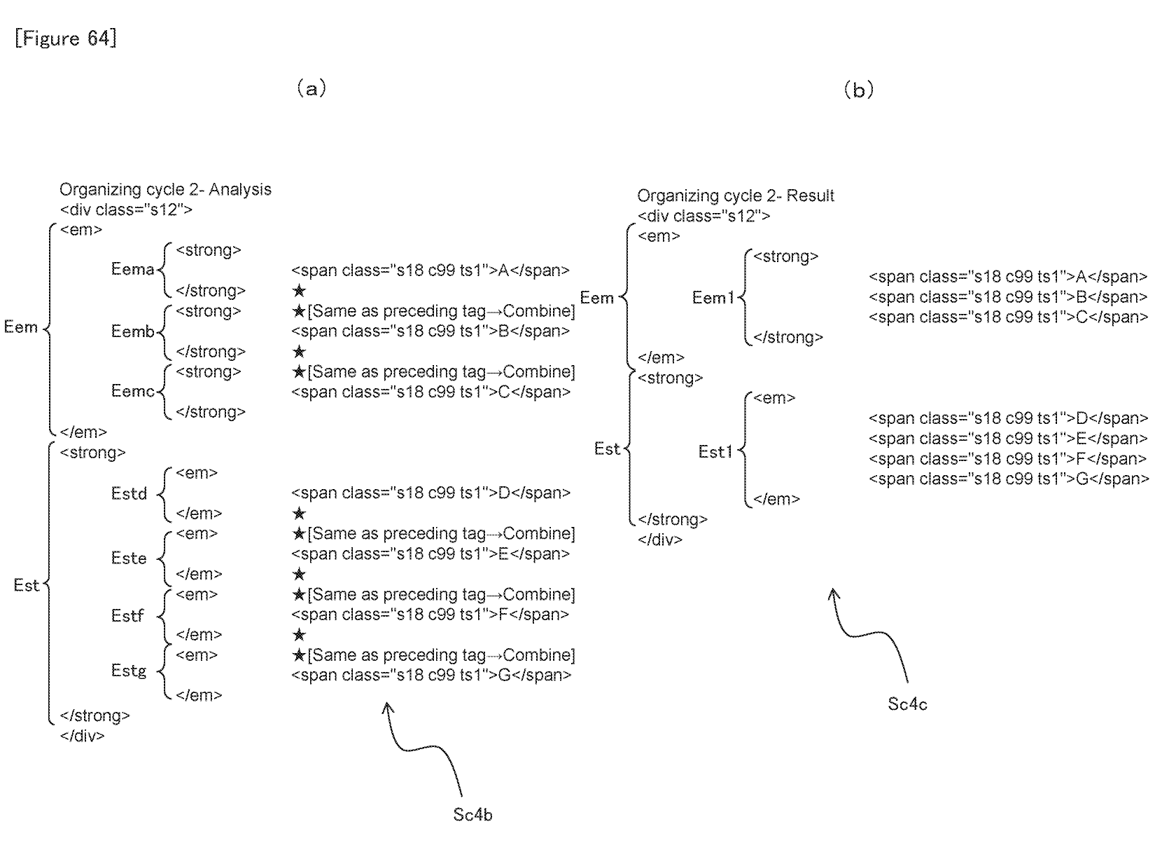

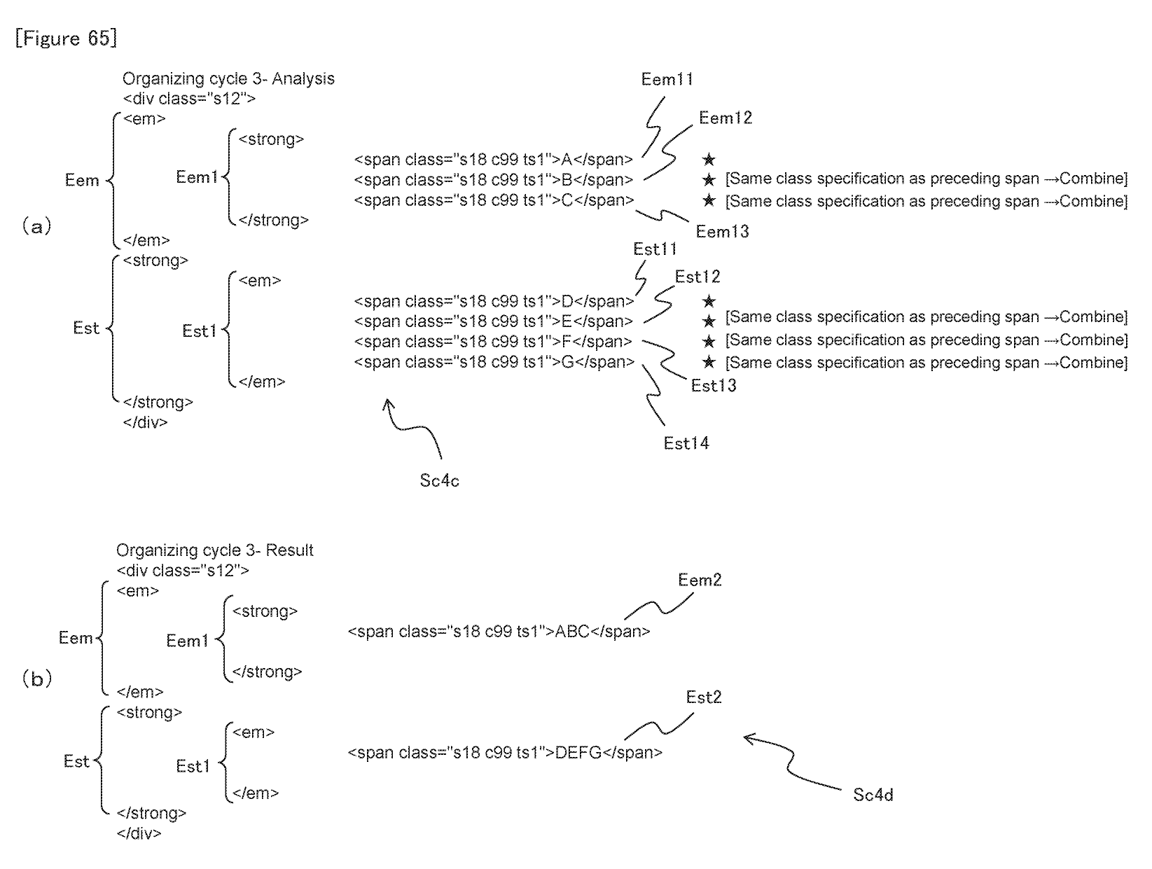

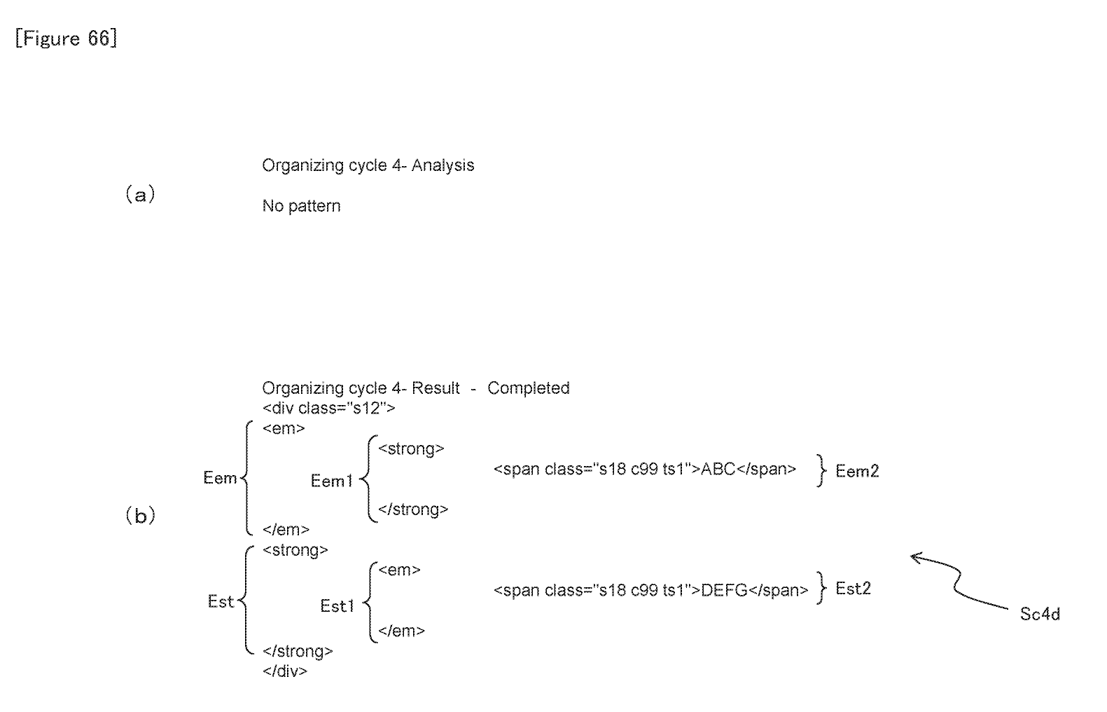

In this editing state, when a user clicks on a region within the large block Br30 to select the block Br30 and then operates for example the copy button Bu3, the large block Br30 is copied with the contents Ct31 and Ct32 contained within the small blocks Br31 and Br32 therein, and the copied large block Br30a is placed below the original large block Br30 as shown in FIG. 56. The copied large block Br30a contains contents Ct31a and Ct32a that are the same as the contents Ct31 and Ct32 of the small blocks Br31 and Br32 that were in the original block Br30.

In the editing state shown in FIG. 56, when the editing mode of the original large block Br30 is returned from a batch editing mode to a normal editing mode by an unlocking operation with the lock button Bu5, the outer lines of the small blocks Br31 and Br32 within the original large block Br30 appear as shown in FIG. 57. However, the outer lines of the small blocks Br31a and Br32a within the copied large block Br30a do not appear, where the block Br30a is still locked. Thus, in the editing state shown in FIG. 57, an editing operation targeting individual small blocks within the original large block Br30 is possible, but an editing operation on the small blocks Br31a and 32a within the copied large block Br30a is not possible.

FIG. 58 is a diagram for explaining the operation of the HP creation assisting device 20 shown in FIG. 51, and shows a process in a flow chart executing a process in accordance with an editing operation of a user according to the editing mode by a computer.

The processor 11 executes a process of displaying the home page editing screen Se on the display unit 14a based on a user operation of the input operation unit 13, and performs the following processes of steps S31 to 35.

The processor 11 determines whether a user has performed an editing operation targeting a given block (step S31), and repeats the determination process if an editing operation has not been performed. On the other hand, if an editing operation has been performed, the processor 11 determines whether the editing mode of a block targeted for editing is a normal editing mode or a batch editing mode (step S32).

For example, if the editing mode of a target block is a batch editing mode, the processor 11 executes a process in accordance with an editing operation on the target block and the child block thereof only if the target block is a parent block (step S33).

On the other hand, if the editing mode of a target block is a normal editing mode, the processor 11 executes a process in accordance with an editing operation on the target block, regardless of whether the target block is a parent block or a child block (step S34).

When the processor 11 performs an ending operation thereafter, the process is ended, and if an ending operation is not performed, the process returns to step S31.

In the HP creation assisting device 30 in embodiment 3, since a user can switch the editing mode of a parent block targeted to be operated between a batch editing mode and a normal editing mode with a lock button in this manner, only batch editing of the target block and a block contained therein is enabled when the parent block is the block targeted for editing, by locking the parent block, and individual editing on individual child blocks within the parent block is enabled, by unlocking the parent block.

The HP creation assisting process performed by the HP creation assisting device 30 in embodiment 3 can also be executed by a web application which operates by cooperation between a program installed on a web server and a program in a programming language that operates on a browser on the user side terminal as in embodiment 1 or 2 instead of a stand-alone application that is operated by a program installed on the user side terminal as in embodiment 3.

In this case, a source code of a completed home page can be stored on the server side or provided to the user side terminal.

### Embodiment 4

FIG. 59 is a diagram for explaining an HP creation assisting device 40 according to embodiment 4 of the present invention.

The HP creation assisting device 40 of embodiment 4 has a computer 40a for processing information, an input operation unit 13a, and a display unit 14a as in the HP creation assisting device 10 in embodiment 1. The computer 40a comprises a memory 42 instead of the memory 12 of the computer 10a in embodiment 1. A program for making the processor 11 execute a process that is different from that of the HP creation assisting device 10 in embodiment 1 as a process for assisting the creation of a home page is stored in the memory 42.

The configuration of the HP creation assisting device 40 in embodiment 4 is identical to the configuration of the HP creation assisting device 10 in embodiment 1, other than the memory 42 of the computer 40a.

A process of assisting the creation of a home page (hereinafter, the HP creation assisting process) performed by the HP creation assisting device 40 in embodiment 4 is specifically explained hereinafter,

FIG. 60 is a diagram showing an editing screen Se that is displayed on the display unit 14a of the HP creation assisting device 40 in embodiment 4. Elements in FIG. 60 assigned with the same symbol as those in FIG. 15 are identical to those in the editing screen Se of embodiment 1.

An HP creation assisting process performed by the HP creation assisting device 40 in embodiment 4 comprises a process of a computer determining a type of adjacent tags, an attribute contained in a tag, and an attribute value contained in a source code of a created home page, and a process of the computer organizing the source code by replacing the adjacent tags with one tag if a determination result meets a predetermined condition.

These processes are performed by the processor 11 executing a program stored in the memory 42. It is also understood that a common operation system for making the processor 11 function as a text editor or as a browser is stored in the memory 42. A program for performing a process of assisting the creation of a home page can be further stored in the memory 42 as in the HP creation assisting device 10, 20, or 30 of embodiment 1, 2, or 3. For example, when the program of embodiment 1 is stored in the memory 42, contents can be edited on the preview screen Rep, and a source code corresponding to one or more contents edited on the preview screen Rep would be displayed on the source screen Roe.

The HP creation assisting device 40 in embodiment 4 does not need to have a function of performing the HP creation assisting process of the HP creation assisting device 10 in embodiment 1, but is assumed hereinafter to have the function of the HP creation assisting device 10 in embodiment 1 for convenience of explanation.

A home page editing process using the HP creation assisting device 40 is explained in detail hereinafter.

For example, in the editing state shown in FIG. 60, a block box Br41 is created in the preview screen Rep, and content “ABCDEFG” Ct41 is placed within the block box Br41. A source code Sc4 corresponding to the entire page displayed on the preview screen Rep is displayed on the source screen Rce, and the source code Sc4 contains a body element Sc40, which contains a source element Sc41 corresponding to the block box Br41.

A user can set various styles for the content “ABCDEFG” Ct41 contained in a block box with the operation buttons Bu21 to Bu23 on the text editing screen TSe displayed on the editing screen Se.

In this regard, the style is set according to the following rules 1 to 3.

(Rule 1) When CSS is set for an HTML element, a span tag is used, and CSS is not set to a tag other than span tags. This is to increase the probability that the front and back tags match when organizing tags.

(Rule 2) A tag is not set to span contents divided by a tag.

This is because setting a tag to span contents divided by a tag produces a portion where only one of a start tag and an end tag of another tag is placed between a start tag and a corresponding end tag such that the hierarchical relationship of tags in HTML elements cannot be determined at this portion, resulting in combining the same type of end tags and start tags in accordance with the tag hierarchical relationship so that an optimal process for organizing a source code would no longer be possible.

(Rule 3) When CSS is set for a tag, CSS for a parent tag is not changed. This is because if CSS for the parent tag of tags is changed, the other child tags from the parent tag are affected.

FIG. 61 is a diagram for explaining the operation of the HP creation assisting device 40 shown in FIG. 59, and shows a change in the source code when various styles are set for contents in style setting processes S400 to S407. (Style setting process S400)

For example, the font size of the content “ABCDEFG” Ct41 shown in FIG. 60 is set to 12. Such a font size is set by adding the class attribute “class=“s12”” to a start tag <div> of a div element as shown in FIG. 61. (Style setting process S401)

When the part “DEF” of the content “ABCDEFG” is set to font size “18”, this is set by using a span tag and adding the class attribute “class=“s18”” to the start tag <span>. (Style setting process S402)

When the part “BCD” of the content “ABCDEFG” is set to “color 99”, this is set by adding the class attribute “class=“c99”” to the start tag <span> before “BC” and the start tag <span> before “D”.

### (Style Setting Process S403)

When the part “EF” of the content “ABCDEFG” is set to emphasis (EMPHASIS), this is set by placing <em> tag and </em> tag before and after a span element comprising the content “EF”,

### (Style Setting Process S404)

When the part “ABC” of the content “ABCDEFG” is set to another emphasis (STRONG), this is set by placing <strong> tag and </strong> tag before and after the content “A” and placing <strong> and tag</strong> tag before and after the content “BC”.

### (Style Setting Process S405)

When the part “CDE” of the content “ABCDEFG” is set to Italic, this is set by adding the class attribute value “ts1” to the <span> tag in front of the contents “C”, “D”, and “E”.

### (Style Setting Process S406)

When the part “ABCG” of the content “ABCDEFG” is set to font size “18”, this is set by adding the class attribute value “s18” to the <span> tag in front of each of the contents “A”, “B”, “C”, and “G” of the content “ABCDEFG”.

### (Style Setting Process S407)

When the part “AEFG” of the content “ABCDEFG” is set to “color 99”, this is set by adding the class attribute value “c99” to the <span> tag in front of each of the contents “A”, “E”, “F”, and “G” of the content “ABCDEFG”.

### (Style Setting Process S408)

When the part “ABCDG” of the content “ABCDEFG” is set to emphasis (EMPHASIS), this is set by placing an <em> tag immediately in front of the <strong> tag of “A”, “B”, and “C” of the content “ABCDEFG”, placing an </em> tag immediately after the </strong> tag of “A”, “B”, and “C” of the content “ABCDEFG”, placing a an <em> tag immediately in front of the <span> tag of “D” and “G” of the content “ABCDEFG”, and placing an </em> tag immediately after a </span> tag of “D” and “G”.

### (Style Setting Process S409)

When the part “DEFG” of the content “ABCDEFG” is set to emphasis (STRONG), this is set by placing a <strong> tag immediately in front of the <em> tag of “D” of the content “ABCDEFG”, and placing a </strong> tag immediately after the </em> tag of “G”.

### (Style Setting Process S410)

When the part “ABFG” of the content “ABCDEFG” is set to Italic, this is set by adding the class attribute value “ts1” to the <span> tag in front of the contents “A”, “B”, “F”, and “G”.

A process for organizing a source code obtained in this manner is now explained.

This process for organizing a source code basically recognizes two patterns and combines the tag content for optimization with the presence of the pattern.

The two patterns are the following pattern 1 and pattern 2.

(Pattern 1)

When the same tags (strong, em, or the like) are next to each other, the content is combined and a single tag is formed.

(Pattern 2)

If specific adjacent tags (e.g., span) have the same class specification, the contents thereof are combined, and a single specific tag (e.g., span) is formed.

First, the processor 11 analyzes an input source code Sc4a to analyze HTML elements in order from the top hierarchy of a hierarchical structure formed by the HTML elements constituting the source code Sc4a.

In this regard, organization of the source code Sc4a obtained in the style setting process S410 of FIG. 62 is used an example for explanation. The source code subjected to processing of the HP creation assisting device 40 in embodiment 4 is not limited thereto.

A source code is organized by the HP creation assisting device 40 in embodiment 4 in order from the top hierarchy for each hierarchy of a hierarchical structure of a plurality of elements constituting the source code.

In the first organizing process (organizing cycle 1), the processor 11 first divides the description in the source code contained between a start tag <div class “s12”> and art end tag </div> into HTML elements (first hierarchical elements) E1a to E1g belonging to a hierarchy that is one lower than the tag (first hierarchy) as shown in FIG. 63.

Next, the processor 11 detects a portion where the same tags are adjacent between adjacent first hierarchical elements and combines elements defined by the same tag.

For example, <em> tags are adjacent between <em> element E1a and <em> element E1b and between <em> element E1b and <em> element Etc in the example shown in FIG. 63(a). <strong> tags are adjacent between <strong> element E1d and <strong> element E1e, between <strong> element E1e and <strong> element E1f, and between <strong> element E1f and <strong> element E1g.

Thus, the processor 11 combines and converts <em> element E1a to <em> element E1c to a single <em> element Eem, and combines and converts <strong> element E1d to <strong> element E1g to a single <strong> element Est as shown in FIG. 63(b). An organized source code Sc4b is thereby obtained.

Next in the second organizing process (organizing cycle 2), the processor 11 analyzes a code of a source code contained in the <em> element Eem and a code of the source code contained in the <strong> element Est, and divides the code of the source code contained in the <em> element Eem into HTML elements (second hierarchical elements) Eema to Eemc belonging to a hierarchy that is one lower than the <em> element Eem (second hierarchy), and divides the code of the source code contained in the <strong> element Est into HTML elements (second hierarchical elements) Estd to Estg belong to a hierarchy that is one lower than the <strong> element Est (second hierarchy).

Next, the processor 11 detects a portion where the same tags are adjacent between adjacent second hierarchical elements and combines elements defined by the same tag.

For example, <strong> tags are adjacent between the <strong> element Eema and <strong> element Eemb and between the <strong> element Eemb and <strong> element Eemc as shown in FIG. 64(a).

<em> tags are adjacent between the <em> element Estd and <em> element Este, between the <em> element Este and <em> element Estf, and between the <em> element Estf and <em> element Estg.

Thus, the processor 11 combines and converts <strong> element Eema to <strong> element Eemc into a single <strong> element Eem1, and combines and converts <em> element Estd to <em> element Estg into a single <em> element Est1 as shown in FIG. 64(b). A further organized source code Sc4c is thereby obtained.

Subsequently in the third organizing process (organizing cycle 3), the processor 11 analyzes a description of a source code contained in the <strong> element Eem1 and a description of the source code contained in the <em> element Est1, and divides the description of the source code contained in the <strong> element Eem1 into HTML elements (third hierarchical elements) Eem11 to Eem13 belonging to a hierarchy that is one lower than the <strong> element Eem1 (third hierarchy), and divides the description of the source code contained in the <em> element Est1 into HTML elements (third hierarchical elements) Est11 to Est14 belong to a hierarchy (third hierarchy) that is one lower than the <em> element Est1.

Next, the processor 11 detects a portion where specific tags are adjacent and tag class specification (attribute value of class attribute) is the same between adjacent third hierarchical elements and combines elements defined by the same tag with the same class specification.

For example, in <strong> element Eem1, as shown in FIG. 65(a), <span> element Eem12 and the preceding <span> element Eem11 have the same tag of the same class specification, and <span> element Eem13 and the preceding <span> element Eem12 have the same tag of the same class specification.

In <em> element Est1, <span> element Est12 and the preceding <span> element Est11 have the same tag of the same class specification, and <span> element Est13d and the preceding <span> element Est12 have the same tag of the same class specification, and <span> element Est14 and the preceding <span> element Est13 have the same tag of the same class specification.

Thus, the processor 11 combines and converts <span> element Eem11 to <span> element Eem13 into a single <span> element Eem2, and combines and converts <span> element Est11 to <span> element Est14 into a single <em> element Est2 as shown in FIG. 65(b). A further organized source code Sc4d is thereby obtained.

In the fourth organizing process (organizing cycle 4), the processor 11 analyzes a description of a source code contained in <span> element Eem2 and a description of a source code contained in <span> element Est2. Since these elements do not contain an element to be divided, the processor determines that there is no HTML element with a combinable description pattern as shown in FIG. 66(a), and determines the organization result obtained in the third organizing process (organizing cycle 4) as the fourth organizing result (FIG. 66(b)) to complete the organizing of the source code.

In this manner, in embodiment 4, a type of adjacent tags, an attribute contained in a tag, and an attribute value contained in a source code of a created home page are determined, and a source code is organized by replacing adjacent tags to a single tag if a determination result meets a predetermined condition. Thus, a source code of a mechanically created home page can be converted to a simple code without redundancy. And thereby, a load from data processing with a browser or the like that displays the home page based on the source code can be reduced. As a result, the browser responsiveness, search speed and the like can be improved.

In embodiment 4, a source code optimization process for organizing a source code has been explained by using an exemplary source code without a portion with a tag set to span contents divided with a tag. Meanwhile, the source code optimization process can be used for a source code comprising a portion with a tag set to span contents divided with a tag.

For example, in the first HTME element “<div><em>ABC</em><strong>DEFG</strong></div>”, the content “ABCDEFG” is divided into a content “ABC” and content “DEFG” with an em tag and a strong tag.

Meanwhile in the second HTME element “<div><em>AB<span>C</em><strong>DE</span>FG</strong></div>”, the span element is set so that the span element spans the content “ABC” and content “DEFG”.

The second HTME element with such a configuration can be optimized by adding a new tag to the portion “C</em><strong>DE” within the span tag of the content “ABCDEFG” and the portions “<em>AB” and FG</strong> outside the span tag.

Specifically, the portion “C</em><strong>DE” inside the span tag is changed to “<em>C</em><strong>DE</strong>” by adding an em start tag <em> and strong end tag </strong>. The portion “<em>AB” outside the span tag is changed to “<em>AB</em>” by adding an em end tag “</em>”. The portion “FG</strong>” outside the span tag is changed to “<strong>FG</strong>” by adding a strong start tag “<strong>”.

As a result, the second HTME element “<div><em>AB<span>C</em><strong>DE</span>FG</strong></div>” is changed to a third HTME element “<div><em>AB</em><span><em>C</em><strong>DE</strong></span><strong>FG</strong></div>”.

The second HTME element thereby becomes a source code (third HTME element) without a portion where a tag is set to span contents divided by a tag.

An HP creation assisting process performed by the HP creation assisting device 40 in embodiment 4 can also be executed by a web application which operates by cooperation between a program installed on a web server and a program in a programming language that operates on a browser on the user side terminal as in embodiment 1 to 3 instead of a stand-alone application that is operated by a program installed on the user side terminal as in embodiment 4.

In this case, the optimized source code can be stored on the server side or provided to the user side terminal.

The present invention has been exemplified with preferred embodiments of the present invention, but the present invention should not be interpreted to be limited to the embodiments. It is understood that the scope of the present invention should be interpreted based solely on the Claims. It is understood that those skilled in the art can implement an equivalent scope from the descriptions of the specific preferred embodiments of the invention based on the description of the present invention and common general knowledge.

### INDUSTRIAL APPLICABILITY

The present invention is useful as an invention with which a general user can create an intended home page by a simple operation on a home page editing screen in the field of methods, programs, recording media and devices for assisting the creation of a home page.

### REFERENCE SIGNS LIST

1 Element “text”
2 Content
3 Start tag
4 End tag
10, 20 HP creation assisting device
10a, 20a Computer
11, 21 Processor
12, 22 Memory
13 Input interface
13a Input operation unit
14 Output interface
14a Display unit
15 I/O interface
15a External storage device
16 Network controlling unit
17 Data bus
31 style attribute
B, B1-B4 Box
Ba, Bda, Bdb1-Bdb2, Bdc1-Bdc2, Bdd, Bde1-Bde2, Bdf1-Bdf2 E1,
Srb0 body element
Br1a-Br1d, Br2a-Br2d, Bx1a-Bx1c, Bx2a-Bx2c Block box
Br3, Br3a-Br3b, Bx1d-Bx1f, Bx2d-Bx2f Inline box
Bu1-Bu6, Bu21-Bu24 Operation button
C1-C4 Content (1) to content (4)
C1a-C1f, C2a-C2f, Cn, Cn1-Cn6, Cr1-Cr3, Cr3a, Cr3b Content
Cht1, Cht3, Eht1, Eht2, Sht2, Sht3 Highlighted region
Ccr2, Hcr3, Scr1 Clicked region
D Display data
Dc Attribute information
Dcp Property
Dcv Value
De Declaration element
Dh Description
Dm Width of margin region
Dhs Hierarchical structure information
Dp Width of padding region
Ds Selector
Ds1b, Ds1c test 1 attribute
Ds2b, Ds2c test 2 attribute
Dse, Dsf test attribute
Dtx Text input region
E2, Er1a-Er1e, Er2a-Er2d, Er3, Er30-Er32 div element
E3 p element
E4 u element
Eg, Eg1-Eg6 Display element guide
Eh Hierarchical structure of DOM structure
Eh1 Hierarchical structure of browser DOM
ELd DOM structure element (identifier)
ELs Source element (identifier)
Em1a-Em1a, Em1a-Em2c, En1b-En1c, En1e-En1f, En2b-En2c,
En2e-En2f Block element
Em1d-Em1f, Em2d-Em2f, Er3a-Er3d Inline element
Eps Position information
Es Code for setting a style
Eta Tag type information
G Guide symbol
Rg1-Rg6 Display element guide
Ha, Hd, Hda, Hdb1-Hdb2, Hdc1-Hdc2, Hdd, Hde1-Hde2, Hdf1-Hdf2, Srh0 head element
He, He1-He6, Hm1-Hm6 HTML element
Hpa-Hpf, Sd Display screen
M1-M4, P1-P4, V1-V2 Value inputting region
Mde DOM structure element map
Mp Mouse pointer
Mse Source element map
N Network
Nd Node information
Ne1-Ne6 Node
Rb Box border
Rbu button placement region
Rc Content region (displayed portion)
Rce Source screen
Reo Operation screen
Rep Preview screen
Res Material selection screen
Rhd Hierarchical structure screen
Rm Margin region
Rp Padding region
S Operation signal
S1, Sc, Sca, Scb1-Scb2, Scc1-Scc2, Scd, Sce1-Sce2, Scf1-Scf2, Sr0, Sr1a-Sr1h, Sr3, Sr30-Sr32 Source code
Sb, Sb1-Sb6 Symbol
Se, Se2 Editing screen
Sec Selector
Tt title element
TSe Text editing screen

1. A method for assisting the creation of a home page with a computer, comprising:
the computer creating a box on an editing screen based on a user operation, the box being a rectangular frame for placing a content of the home page;
the computer determining a positional relationship between a target box, which is a target of creation, and an existing box adjacent to the target box; and
the computer editing at least a description for the target box between the target box and the existing box in the source code so that the description is in accordance with a layout rule matching the positional relationship among a plurality of layout rules specifying the placement of the box.

2. A program for executing a method for assisting the creation of a home page with a computer, wherein the program is configured to make the computer execute:
creating a box on an editing screen based on a user operation, the box being a rectangular frame for placing a content of the home page;
determining a positional relationship between a target box, which is a target of creation, and an existing box adjacent to the target box; and
editing at least a description for the target box between the target box and the existing box in the source code so that the description is in accordance with a layout rule matching the positional relationship among a plurality of layout rules specifying the placement of the box.

3. A computer readable recording medium with the program of claim 2 recorded thereon.

4. An device for assisting the creation of a home page, wherein the device has:
means for creating a box on an editing screen based on a user operation, the box being a rectangular frame for placing a content of the home page;
means for determining a positional relationship between a target box, which is a target of creation, and an existing box adjacent to the target box; and
means for editing at least a description for the target box between the target box and the existing box in the source code so that the description is in accordance with a layout rule matching the positional relationship among a plurality of layout rules specifying the placement of the box.

5. A method for assisting the creation of a home page with a computer, comprising:
the computer displaying an editing screen for the home page, the editing screen comprising a preview screen, a source screen, and a hierarchical structure screen, one or more contents constituting the home page being displayed in the preview screen, one or more elements constituting a source code of the home page being displayed in the source screen, and a hierarchical structure comprising one or more hierarchical nodes corresponding to each of the one or more contents being displayed in the hierarchical structure screen; and
the computer executing at least one of the following display processes:
a first display process in which, when one of the one or more contents is selected on the preview screen, an element corresponding to the selected content among the one or more elements is highlighted and displayed on the source screen and a hierarchical node corresponding to the selected content among the one or more hierarchical nodes is highlighted and displayed on the hierarchical structure screen by the computer;
a second display process in which, when one of the one or more elements is selected on the source screen, a content corresponding to a selected element among the one or more contents is highlighted and displayed on the preview screen and a hierarchical node corresponding to the selected element among the one or more hierarchical nodes is highlighted and displayed on the hierarchical structure screen by the computer; and
a third display process in which, when one of the one or more hierarchical nodes is selected on the hierarchical structure screen, a content corresponding to the selected hierarchical node among the one or more contents is highlighted and displayed on the preview screen and an element corresponding to the selected hierarchical node among the one or more elements is highlighted and displayed on the source screen by the computer.

6. A program for making a computer perform a process for assisting the creation of a home page, wherein the program makes the computer:
display an editing screen for the home page, the editing screen comprising a preview screen, a source screen, and a hierarchical structure screen, one or more contents constituting the home page being displayed in the preview screen, one or more elements constituting a source code of the home page being displayed in the source screen, and a hierarchical structure comprising one or more hierarchical nodes corresponding to each of the one or more contents being displayed in the hierarchical structure screen; and
execute at least one of the following display processes:
a first display process in which, when one of the one or more contents is selected on the preview screen, an element corresponding to the selected content among the one or more elements is highlighted and displayed on the source screen and a hierarchical node corresponding to the selected content among the one or more hierarchical nodes is highlighted and displayed on the hierarchical structure screen:
a second display process in which, when one of the one or more elements is selected on the source screen, a content corresponding to a selected element among the one or more contents is highlighted and displayed on the preview screen and a hierarchical node corresponding to the selected element among the one or more hierarchical nodes is highlighted and displayed on the hierarchical structure screen; and
a third display process in which, when one of the one or more hierarchical nodes is selected on the hierarchical structure screen, a content corresponding to the selected hierarchical node among the one or more contents is highlighted and displayed on the preview screen and an element corresponding to the selected hierarchical node among the one or more elements is highlighted and displayed on the source screen.

7. A computer readable recording medium with the program of claim 6 recorded thereon.

8. An device for assisting the creation of a home page, comprising:
displaying means for displaying an editing screen for the home page, the editing screen comprising a preview screen, a source screen, and a hierarchical structure screen, one or more contents constituting the home page being displayed in the preview screen, one or more elements constituting a source code of the home page being displayed in the source screen, and a hierarchical structure comprising hierarchical nodes corresponding to each of the one or more contents being displayed in the hierarchical structure screen, and
controlling means for controlling the display means to perform at least one of the following display processes:
a first display process in which, when one of the one or more contents is selected on the preview screen, the displaying means highlights and displays an element corresponding to the selected content among the one or more elements on the source screen and highlights and displays a hierarchical node corresponding to the selected content among the one or more hierarchical nodes on the hierarchical structure screen;
a second display process in which, when one of the one or more elements is selected on the source screen, the displaying means highlights and displays a content corresponding to a selected element among the one or more contents on the preview screen and highlights and displays a hierarchical node corresponding to the selected element among the one or more hierarchical nodes on the hierarchical structure screen; and
a third display process in which, when one of the one or more hierarchical nodes is selected on the hierarchical structure screen, the displaying means highlights and displays a content corresponding to the selected hierarchical node among the one or more contents on the preview screen and highlights and displays an element corresponding to the selected hierarchical node among the one or more elements on the source screen.

9. A method for assisting the creation of a home page with a computer, wherein the method comprises:
the computer displaying a plurality of blocks for placing a content of the home page so that at least one block is contained within at least one other block on an editing screen based on an editing operation of a user;
the computer switching an editing mode for a parent block comprising at least one block between a normal editing mode and a batch editing mode based on a user operation; and
when the editing mode for the parent block is in the batch editing mode, denying an individual editing operation on a block contained in the parent block and batch editing the block contained in the parent block with the parent block in accordance with an editing operation of a user on the parent block, and when the editing mode for the parent block is in the normal editing mode, the computer executing an editing process of the block contained in the patent block in accordance with an editing operation of a user on the block contained in the parent block.

10. A program for executing a method for assisting the creation of a home page with a computer, wherein the program is configured to:
switch an editing mode for a parent block comprising at least one block between a normal editing mode and a batch editing mode based on a user editing operation; and
when the editing mode for the parent block is in the batch editing mode, deny an individual editing operation on a block contained in the parent block and batch edit the block contained in the parent block with the parent block in accordance with an editing operation on the parent block, and when the editing mode for the parent block is in the normal editing mode, execute an editing process of the block contained in the patent block in accordance with an editing operation on the block contained in the parent block with the computer.

11. A computer readable recording medium with the program of claim 10 recorded thereon.

12. A device for assisting the creation of a home page, wherein the device comprises:
means for displaying a plurality of blocks for placing a content of the home page so that at least one block is contained within at least one other block on an editing screen based on an editing operation of a user;
means for switching an editing mode of a parent block comprising at least one block between a normal editing mode and a batch editing mode based on a user operation; and
means for, when the editing mode for the parent block is in the batch editing mode, denying an individual editing operation on a block contained in the parent block and batch editing the block contained in the parent block with the parent block in accordance with an editing operation of a user on the parent block, and, when the editing mode for the parent block is in the normal editing mode, editing the block contained in the patent block in accordance with an editing operation of a user on the block contained in the parent block.

13. A method for assisting the creation of a home page with a computer, wherein the method comprises:
the computer determining a type of adjacent tags, an attribute contained in a tag, and an attribute value contained in a source code of a created home page; and
the computer organizing the source code by replacing the adjacent tags with one tag if a result of the determination meets a predetermined condition.

14. A program for executing a method for assisting the creation of a home page with a computer, wherein the program is configured to make the computer execute:
determining a type of adjacent tags, an attribute contained in a tag, and an attribute value contained in a source code of a created home page; and
organizing the source code by replacing the adjacent tags with one tag if a result of the determination meets a predetermined condition.

15. A computer readable recording medium with the program of claim 14 recorded thereon.

16. A device for assisting the creation of a home page, wherein the device comprises:
means for determining a type of adjacent tags, an attribute contained in a tag, and an attribute value contained in a source code of a created home page; and
means for organizing the source code by replacing the adjacent tags with one tag if a result of the determination meets a predetermined condition.
